(19) United States
(12) Patent Application Publication
(10) Pub. No.: US 2003/0009742 A1
(43) Pub. Date: Jan. 9, 2003

(54) Automated job training and performance tool

(76) Inventors: Michael D. Bass, Potomac, MD (US); Donna S. Sullivan Bass, Potomac, MD (US)

Correspondence Address: Richard C. Litman, LITMAN LAW OFFICES, LTD., P.O. Box 15035, Arlington, VA, 22215, US

(21) Appl. No.: 10/004,295

(22) Filed: Dec. 6, 2001

Related U.S. Application Data
(60) Provisional application No. 60/251,426, filed on Dec. 6, 2000.

(51) Int. Cl. G06F 9/44

(52) U.S. Cl. 717/104

(57) ABSTRACT

The automated job training and performance tool is a suite of computer software applications for enabling an organization to develop a program for the instruction and training of members of the organization. The tool enables those charged with developing instruction and training to develop a web-based training course without having any formal acquaintance with computer programming languages, either individually or jointly in synchronous or asynchronous modes. The suite includes a guidelines application describing the procedures for developing a job training program, a design application which uses analysis and design template to guide the user in course development, and a Web Author application for automating the process of generating an HTML document implementing the course. The three applications may be used individually, but are seamlessly integrated through object-oriented programming techniques so that data entered in the templates and forms is carried over to the Web Author application.

### CROSS-REFERENCE TO RELATED APPLICATION

This application claims the benefit of U.S. Provisional Patent Application Serial No. 60/251,426, filed Dec. 6, 2000.

### BACKGROUND OF THE INVENTION

1. Field of the Invention

The present invention relates to the field of knowledge engineering and an automated job training and performance tool, and particularly to a computer software program which provides an architecture and an infrastructure/framework for enabling organizations to design, develop, implement, evaluate and administer Web based instructional and training aids for members of their organization. The program creates a development environment which employs systems and methods that utilize rule-based systems, case libraries based on neural networks, software tools, applications, and rich knowledge bases that are integrated seamlessly. It also creates an environment for individuals to collaborate in synchronous and asynchronous modes.

2. Description of Related Art

In today's economy and global marketplace, there is an increased demand for workers to access training to remain current and keep their organizations on the competitive edge. The opportunities opened up by the Internet allow organizations to provide collaborative working and learning environments to keep their workers knowledgeable, faster. Organizations are turning to the Web (Internet, Intranet, and Extranet) as a way to enable the lifelong working and learning habits required by a “high tech” economy. Analysts believe that those companies that are able to leverage the Internet's capabilities to provide collaboration capabilities, to deliver information, and to provide solutions at a lower cost will be the winners in today's economy. At the same time, organizations in the public and private sectors demand more training for more employees in more locations without a proportional increase in budget. A primary way to reduce the cost of working collaboratively, and developing and delivering training to employees, is to eliminate the travel expenses associated with transporting, housing, and feeding subject matter experts, designers and developers, instructors, and learners. Organizations are looking to the Web as a way of reducing such costs. Delivering collaborative work environments and learning and training environments over the Web is now viewed as the primary and best solution for accomplishing these goals.

There are many problems facing those who use the Web as an environment for working in problem-solving teams, designing and developing training, and learning. Many organizations have developed tools and applications to accommodate individual activities to improve performance on both work and learning. However, none of these tools or applications provides a seamless, open, scalable and expandable environment for working and learning and which allows organizations to “plug-in” tools and applications that they have already invested in as well as to produce new tools and applications they will use in the future.

U.S. Pat. No. 5,829,983, issued Nov. 3, 1998 to Koyama et al., describes a computerized system which may be used by a company to educate employees, which involves inputting a skill specification for each of the employee's job duties into a first processing device as an objective reference and communicating a list of objectives to a second processing device used by the employee, developing a plan for meeting the objectives, and evaluating compliance with the plan. U.S. Pat. No. 5,822,745, issued Oct. 13, 1998 to A. Hekmatpour, teaches an expert system for use in training operators of computer assisted manufacturing machines which uses multimedia on a workstation for the training of employees.

U.S. Pat. No. 5,823,781, issued Oct. 20, 1998 to Hitchcock et al., discloses a system for training a user to operate a computer software application which uses a series of test questions to determine the user's level of skill, then provides for prescription of a program for improving skills which includes additional computer training packages. The system uses a mentor which may reside on a web server and can be electronically updated, and includes an evaluation program to grade the user's progress in learning the application. U.S. Pat. No. 5,727,950, issued Mar. 17, 1998 to Cook et al. describes a web-based software program used to teach students at home through a network using a virtual tutor acting under instructions from a teacher, the system including artificial intelligence for grading the student and adapting the course to each individual student.

U.S. Pat. No. 5,295,230, issued Mar. 15, 1994 to C. Y. Kung, teaches a system for assisting a computer network operator in locating network problems which uses artificial intelligence. U.S. Pat. No. 5,306,154 shows an educational computer system which offers subject matter teaching and simulation teaching, and determines a re-education program based on a comparison of the results. U.S. Pat. No. 5,387,104, issued Feb. 7, 1995 to P. R. Corder, discloses a computer program for teaching children communication skills by repetition, evaluating each individual's responses so they may be reviewed by a teacher to prepare an individualized learning program.

U.S. Pat. No. 5,590,360, issued Dec. 31, 1996 to G. E. Edwards, describes a software system operating on a local area network to gather information from multiple users which is edited by an analyst and formatted to fit into a bridge program which prepares a process model that can be used as a basis for writing a software program. U.S. Pat. No. 5,904,485, issued May 8, 1999 to D. M. Siefert, discloses a software device for computer-assisted education which stores curriculum and a learning profile for each student, selects materials for a learning session and assesses whether the material has been learned. If the material has not been learned, it sets up an alternate presentation of the material or sets up a video conference with a subject matter expert.

U.S. Pat. No. 5,934,910, issued Aug. 10, 1999 to Ho et al., discloses a computer network system which presents subject matter materials to a student, then permits the user to present questions to the computer in a parseable language. If the questions indicate the user is weak in the subject matter area, the system presents more in-depth material. U.S. Pat. No. 5,974,443, issued Oct. 26, 1999 to C. E. Jeske, shows a method and system for retrieving non-HTML files on request of an HTTP server through an agent platform which spawns an application to retrieve the information.

U.S. Pat. No. 5,978,648, issued Nov. 2, 1999 to George et al., describes a multimedia system in which teachers can assign a task to students and the students can then create and open a work folder with multimedia tools to perform the task, the system also having software to perform administrative functions for teachers to evaluate performance and provide feedback to students. U.S. Pat. No. 6,014,134, issued Jan. 11, 2000 to Bell et al., discloses a technique for presenting a software tutorial over the Internet which allows the user to create, delete or modify graphical objects and which also grades the user's performance.

U.S. Pat. No. 6,024,577, issued Feb. 15, 2000 to Wadahama et al., teaches a computer network system which allows an instructor to deliver a lecture to a plurality of students at the same time, sends questionnaires to each student, receives responses from each student, and evaluates student comprehension of the lecture. U.S. Pat. No. 6, 029,156, issued Feb. 22, 2000 to Lannert et al., and U.S. Pat. No. 6,032,141, issued Feb. 29, 2000 to O'Connor et al., both describe a goal based learning system using a rule based expert training system which provides users with a simulated business environment that presents a business opportunity to understand and solve. Mistakes are noted and remedial material is presented. The system features artificial intelligence to provide individual and dynamic feedback, and synchronized video and graphics to simulate the real world. U.S. Pat. No. 6,077,085, issued Jun. 20, 2000 to Parry et al., teaches a computerized system which accommodates students with different languages, and is particularly suited to language training. The system uses multimedia aids and a template approach.

None of the above inventions and patents, taken either singly or in combination, is seen to describe the instant invention as claimed. In particular, none of the above patents is seen to describe a comprehensive software package which analyzes an organization's training needs, recommends a training program, provides guidance and tools for preparing a training program using platform independent programming objects, with the ability to formulate stand-alone programs or plug-in modules for existing programs, and particularly web applications, which provides student tools for both synchronous and asynchronous learning environments, and which provides automated rule-based expert systems for evaluating and modifying the training program, and tools for analyzing the effectiveness of the training program and automatically updating the program.

### SUMMARY OF THE INVENTION

The automated job training and performance tool is a suite of computer software applications for enabling an organization to develop a program for the instruction and training of members of the organization. The tool enables those charged with developing instruction and training to develop a web-based training course without having any formal acquaintance with computer programming languages, either individually or jointly in synchronous or asynchronous modes. The suite includes a guidelines application describing the procedures for developing a job training program, a design application which uses analysis and design template to guide the user in course development, and a Web Author application for automating the process of generating an HTML document implementing the course. The three applications may be used individually, but are seamlessly integrated through object-oriented programming techniques so that each application may access the other, and so that data entered in the templates and forms is carried over to the Web Author application.

The suite is designed to be used in a computer software system providing an environment having an architecture, framework, and tools for enabling an organization to develop a program for the instruction and training of members of the organization, including the capacity to develop and implement a Web application. The software package uses a browser for the user interface and is written in platform independent language utilizing object-oriented programming. The architecture includes designer and developer tools, student tools and administrative tools. The designer and developer tools use templates and forms to assess the organization's environment and training needs, recommend a training approach, and implement the recommendations with appropriate software.

The automated job training and performance tool provides a computerized environment for collaborative working, learning and problem solving. The architecture enables an organization to develop training programs, as well as learning and collaborative work environments. The template and forms approach is used to assess and analyze the organization's environment and training needs, available instructional strategies, and delivery mechanisms to meet those needs, and then matches the appropriate and best instructional strategies and delivery options. The administrative tools in such an architecture provide several functions, including registration, tracking, assessing, scoring, and scheduling functions. The administrative tools also provide for system administration in the collaboration areas and include tools for other system administration functions. The suite of applications of the present invention is designed to be integrated into such an architecture, including any conventionally known learning management systems.

The system operates in a neural network mode. The key element of the paradigm is the novel structure of the information processing system. In this invention, the neural network adaptive capability exhibits itself in the adaptive environment for working and learning collaboratively, as well as in the use and implementation of the designer and developer tools.

The architecture is designed to work in a distributed, client-server environment, which may be the Internet, and Intranet, or an Extranet. The distributed environment uses learning objects, instructional objects, audio objects, video objects, and other objects and components to make the learning and working environment accessible, interoperable, reusable, adaptable, and affordable. The object technology renders the tools, applications, and courses a component based functionality so that the objects may be reused and seamlessly integrated appropriately for collaborative working, learning and problem solving. The distributed environment constantly monitors new technologies to offer enhancements and new opportunities to users. The expandability of the architecture resulting from Java and XML programming techniques provides sufficient flexibility to add new components for advanced distributed learning, learning portals, streaming media, wireless application protocol (WAP), and 2-D collaborative environments.

The architecture uses collaboration as a tool to achieve learning success. The distributed collaborative environment allows users to access data, objects, and other tools, and to interact with each other. It presents an opportunity to generate and capture new knowledge, solve problems, and innovate. Individuals can work on the same or different tasks at the same location, or at remote locations, at any time. This fosters communication, problem solving, collaboration and teamwork. Towards this end the architecture supports both synchronous and asynchronous collaboration, and offers the ability to add live voice to the collaboration area.

Accordingly, it is a principal object of the invention to provide an automated job training and performance tool which provides a software package including software tools and applications which enable organizations to capture corporate knowledge, assess their environment and training needs, to assess their available instructional strategies and delivery mechanisms to meet those needs, to recommend a training approach, to match the appropriate and best instructional strategies and delivery options, to implement training programs, to provide a distributed environment for carrying out training programs, and to provide automated means for assessing the effectiveness of training and for adapting the training to an individual's needs and expertise.

It is another object of the invention to provide an automated job training and performance tool which utilizes templates and forms for ease of operation in developing an organization's training program.

It is a further object of the invention to provide an automated job training and performance tool which uses object technology for platform independence and to provide components that may be integrated seamlessly to implement an organization's training program.

Still another object of the invention is to provide an automated job training and performance tool which has the capability of implementing a Web-based application in order to provide a distributed learning environment that offers both synchronous and asynchronous modes of working and learning.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a block diagram showing the architecture of an automated job training and performance system and the place of the tool according to the present invention in that system.

FIG. 1B is a block diagram showing the features of the designer/developer tools of the architecture of the automated job training and performance tool according to the present invention.

FIG. 1C is a block diagram showing a general overview of the architecture of the automated job training and performance tool according to the present invention.

FIG. 2 is a detailed diagram of the components of the designer/developer tools according to the present invention.

FIGS. 3A and 3B is a chart showing the interaction between the user interface and Guidelines data structure of the automated job training and performance tool according to the present invention.

FIG. 3C is a chart showing the contents of the Guidelines database.

FIG. 4A is a schematic representation of the overall flow through the guidelines of the designer/developer tool of the present invention.

FIGS. 4B, 4C and 4D is a schematic representation of the flow through the analysis guidelines of the designer/developer tool of the present invention.

FIGS. 5A, 5B, and 5C is a schematic representation of the flow through the design guidelines of the designer/developer tool of the present invention.

FIGS. 6A, 6B, and 6C is a schematic representation of the flow through the development guidelines of the designer/developer tool of the present invention.

FIGS. 7A and 7B is a schematic representation of the flow through the implementation guidelines of the designer/developer tool of the present invention.

FIGS. 8A and 8B is a schematic representation of the flow through the evaluation guidelines of the designer/developer tool of the present invention.

FIGS. 9A, 9B, 9C, 9D, 9E, 9F, 9G, 9H and 9I is a flow chart of the analysis templates of the designer/developer tool of the present invention.

FIGS. 10A, 10B, 10C, 10D, 10E, 10F, 10G, 10H, 10I, 10J, and 10K is a flow chart of the design templates of the designer/developer tool of the present invention.

FIG. 11 is a block diagram showing the interrelationship of the suite of software applications of the present invention.

FIGS. 12A, 12B, 12C, 12D, and 12E is a flow chart of the relationship of analysis and design templates of the present invention.

FIGS. 13A, 13B, 13C, 13D, 13E, 13F, 13G, 13H, 13I, 13J, 13K, 13L, 13M, and 13N are screen shots illustrating various features of the guidelines application of the present invention.

FIGS. 14A, 14B, 14C and 14D are screen shots illustrating various features of the analysis templates of the present invention.

FIGS. 15A, 15B, 15C, 15D, 15E, 15F, 15G, 15H and 15I are screen shots illustrating various features of the design templates of the present invention.

FIGS. 16A, 16B, 16C, 16D, 16E, 16F, 16G, 16H, 16I, 16J, 16K, 16L, 16M, and 16N are screen shots illustrating various features of the web author application of the present invention.

FIGS. 17A, 17B, 17C, and 17D are screen shots illustrating various features of a course developed by the web author application of the present invention.

FIG. 18 is a diagrammatic view of the Courseplayer output of the web author application of the present invention.

FIG. 19 is a block diagram of the collaboration and presentation areas of the architecture of the automated job training and performance tool according to the present invention.

FIG. 20 is a block diagram of both the synchronous and asynchronous work areas of the automated job training and performance tool according to the present invention.

FIG. 21 is a block diagram showing the key items in the synchronous collaboration area of the automated job training and performance tool according to the present invention from the users' point of view.

FIG. 22 is a block diagram of the Room Information Area of the automated job training and performance tool according to the present invention.

FIG. 23 is a block diagram showing a representative computer system on which the automated job training and performance tool according to the present invention may operate.

Similar reference characters denote corresponding features consistently throughout the attached drawings.

### DETAILED DESCRIPTION OF THE PREFERRED EMBODIMENTS

The present invention is an automated job training and performance tool which may be used by public (including the military) private, and nonprofit organizations to design, develop, implement, evaluate, and update job training for members of the organization. The automated job training and performance tool is a software package which is designed to run in a distributed environment using a deployment and communication model.

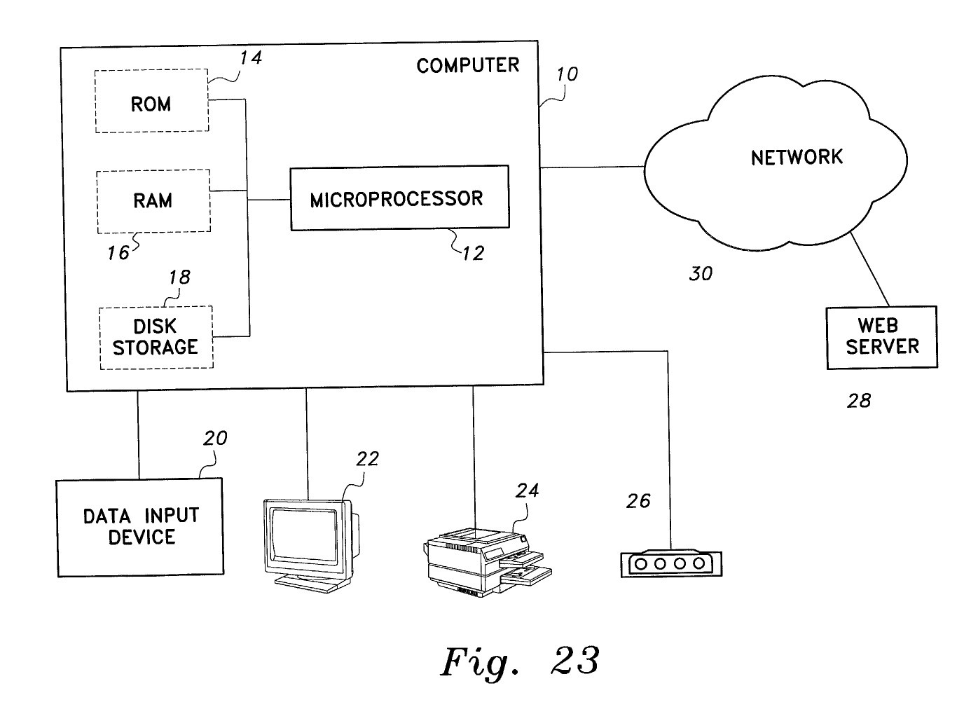

FIG. 23 shows a typical hardware system required to design and develop a training program using the automated job training and performance tool of the present invention. The hardware system preferably includes a personal computer 10 having a microprocessor 12 connected by a bus to read only memory (ROM) 14, random access memory (RAM) 16, and disk storage 18 having means for reading a coded set of program instructions on a computer readable medium which may be loaded into RAM 16 and executed by the microprocessor 12. The computer 10 has one or more data input devices 20, such as a mouse, keyboard, joystick, etc., a monitor 22 for video display, a printer 24, and a modem 26 for serial communications through an ISP, DSL, Ethernet, or other communications link. Although the automated job training and performance tool may theoretically be operated on a standalone workstation, the computer 10 is preferably connected to a web server 28 through a network 30. The network 30 may be on one or more networks, including the Internet, an Intranet or Local Area Network (LAN), or an Extranet. The web server 28 signifies that communications through the network 30 is generally through the HyperText Transfer Protocol (HTTP). The web server 28 will typically have a database, or access to a database, on which the templates described below are stored.

The computer 10 has a software application of the type known as a browser operable thereon. The browser may be Netscape Navigator, Internet Explorer, or any other commercially available browser. The browser serves as the user interface for the designer/developer guideline tool described below. The organization's network will typically comprise a plurality of workstations having the same configuration as computer 10 which are also connected to the network 30.

The automated job training and performance tool is a software package stored on a computer readable medium and executable on the computer 10 when loaded into RAM 16. As used in the present application, the term “computer readable medium” refers to a hard disk drive, a floppy diskette, a ZIP disk, any other magnetic storage media capable of storing coded program instructions, an optical or laser storage device, such as a compact disk or laser disk, paper tape, punch cards, or any other media for the storage of program instructions readable by a disk storage device or reader.

The automated job training and performance tool is written in an object-oriented language, such as JAVA (Java is a trademark of Sun Microsystems). Java has the capability of programming objects, which makes the programming code portable across platforms in accordance with Sun Microsystems' dictum to “Write once, run anywhere™” (also a Sun Microsystems trademark). Advantageously, the JavaBeans specification permits rapid development of software applications by using a visual builder to assemble the objects or components. The automated job training and performance tool also uses Extended Markup Language (XML) in combination with Java developed templates and forms for flexibility, and for data storage and retrieval. HyperText Markup Language (HTML) is used to enhance speed and navigation flexibility in connection with the guidelines described below, and to resolve security issues.

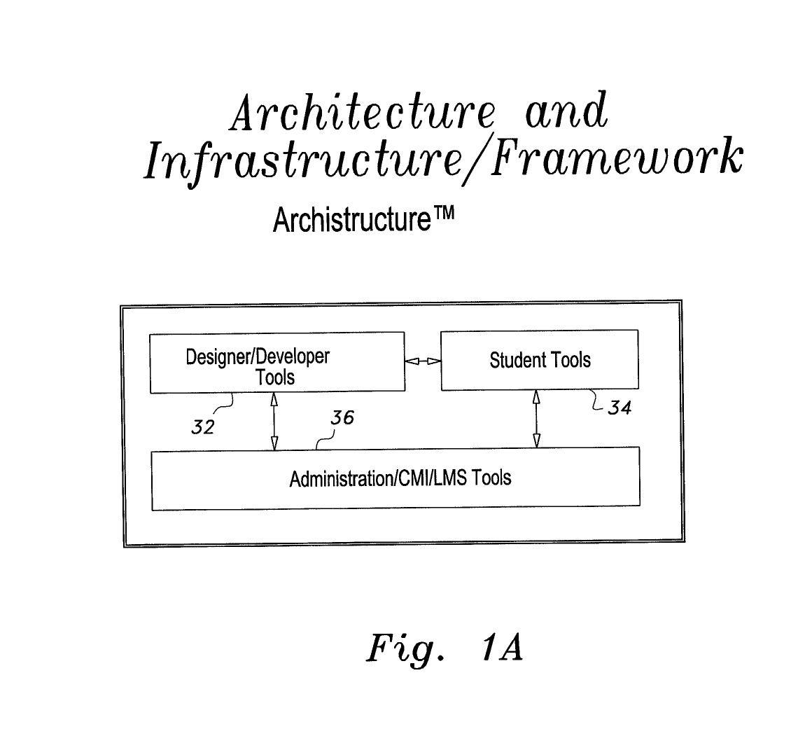

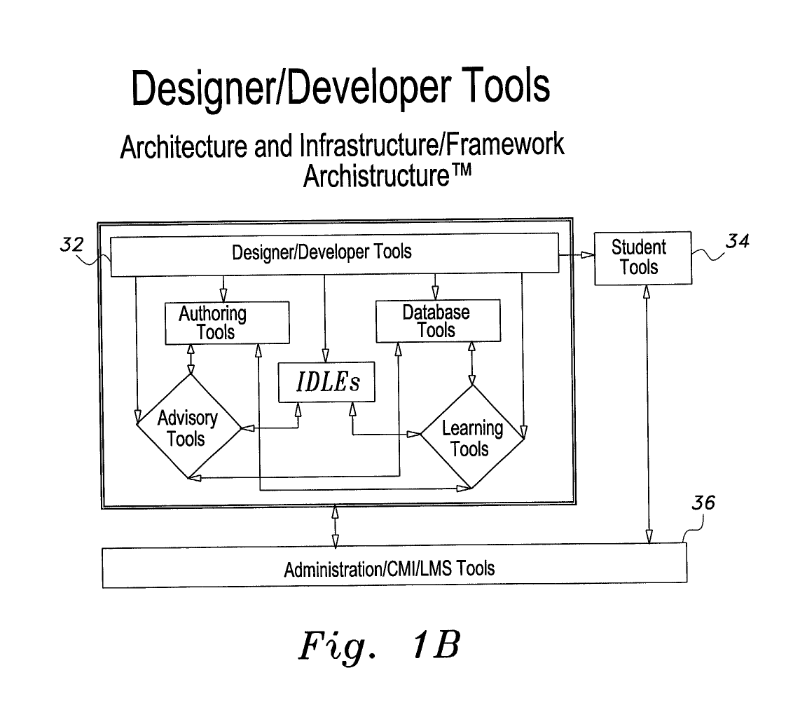

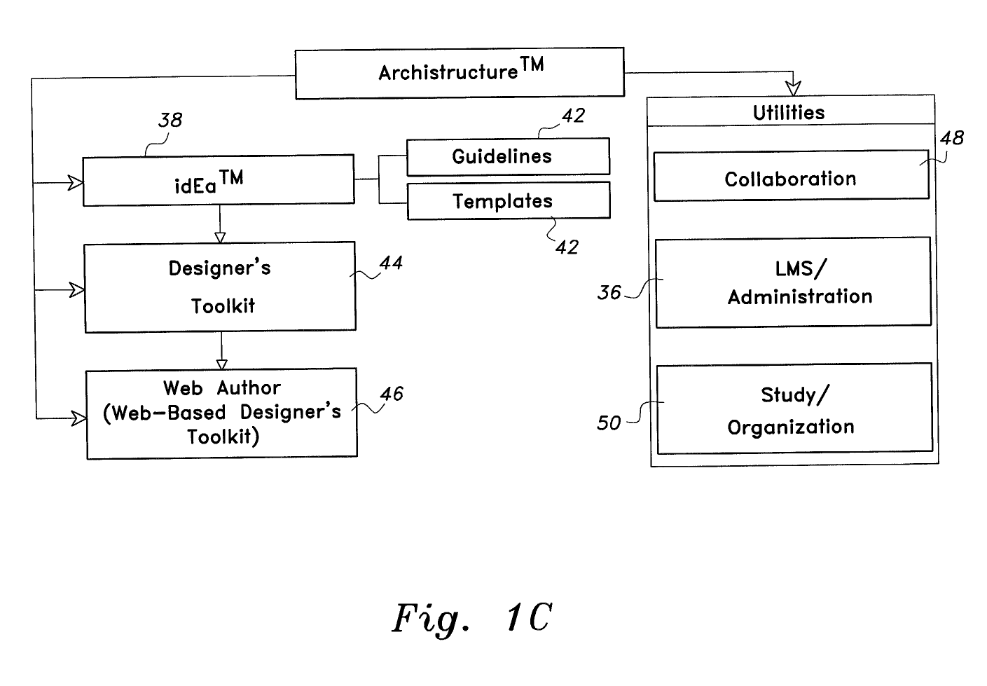

As shown in FIG. 1A, the architecture and infrastructure/framework (referred to as Archistructure™, a trademark of PLS Global) includes three main components, viz., designer/developer tools 32, student tools 34 (exported courses from the Web-based Designer ToolKit), and administration/CMI/LMS tools 36, (state-of the-art tools that launch designer/developer tools and Web Author exported courses). As shown in FIG. 1B, the designer/developer tools 32 include an assortment of objects, such as authoring tools, database tools, advisory tools, learning tools, etc. Student tools 34 comprise courses exported from Web Author, etc. Administration/CMI/LMS tools 36 include registration tools, tracking tools, assessment tools, scoring tools, reporting tools and scheduling tools that launch designer/developer tools and Web Author exported courses. As shown in FIG. 1C, the architecture may be broadly divided into a set of tools and a set of utilities. The tools include the idEa™ (a trademark of PLS Global) tools 38 which include guidelines 40 and templates 42, a designer's toolkit 44, and authoring templates 46 from Web Author (the Web-based Designer ToolKit). The utilities include collaboration vehicles 48, access to administration tools 36, and access to study/organization tools 50, including student tools 34, e.g., exported courses from Web Author 46.

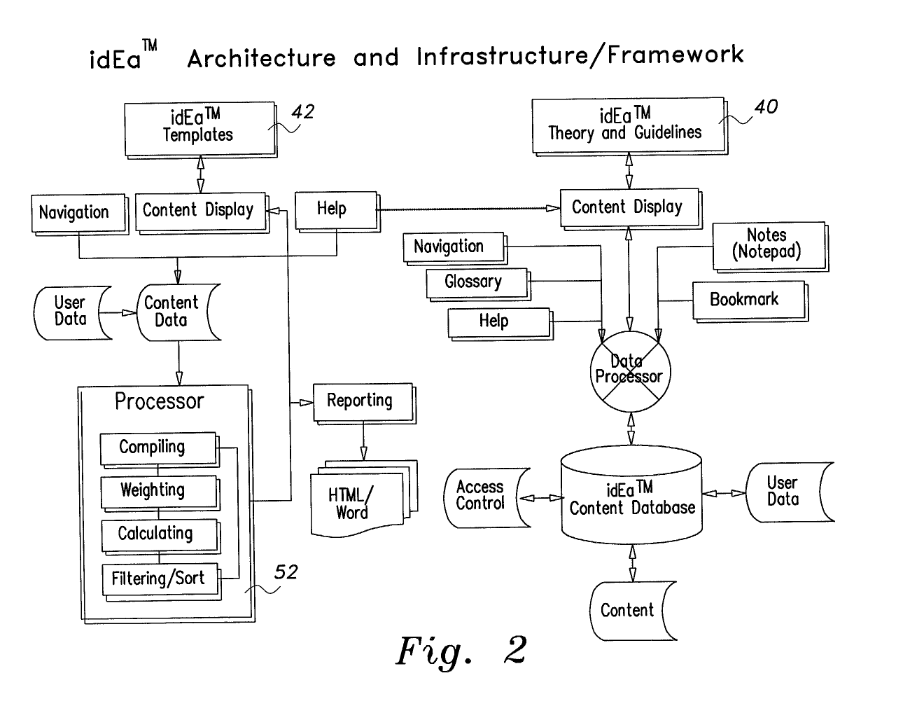

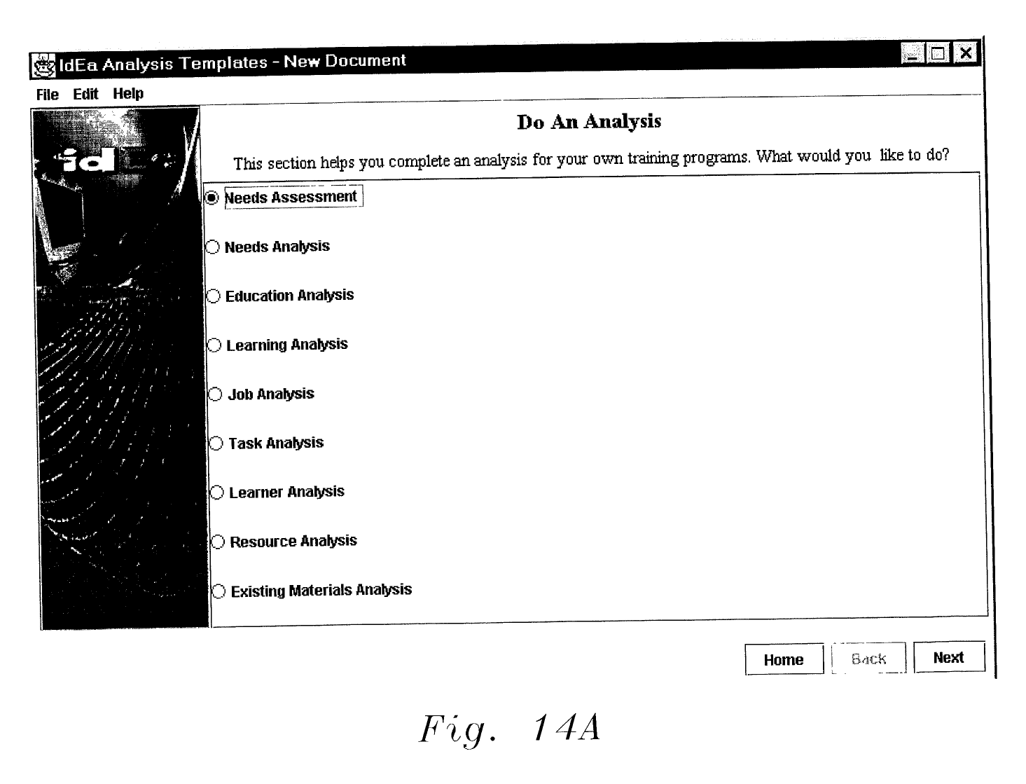

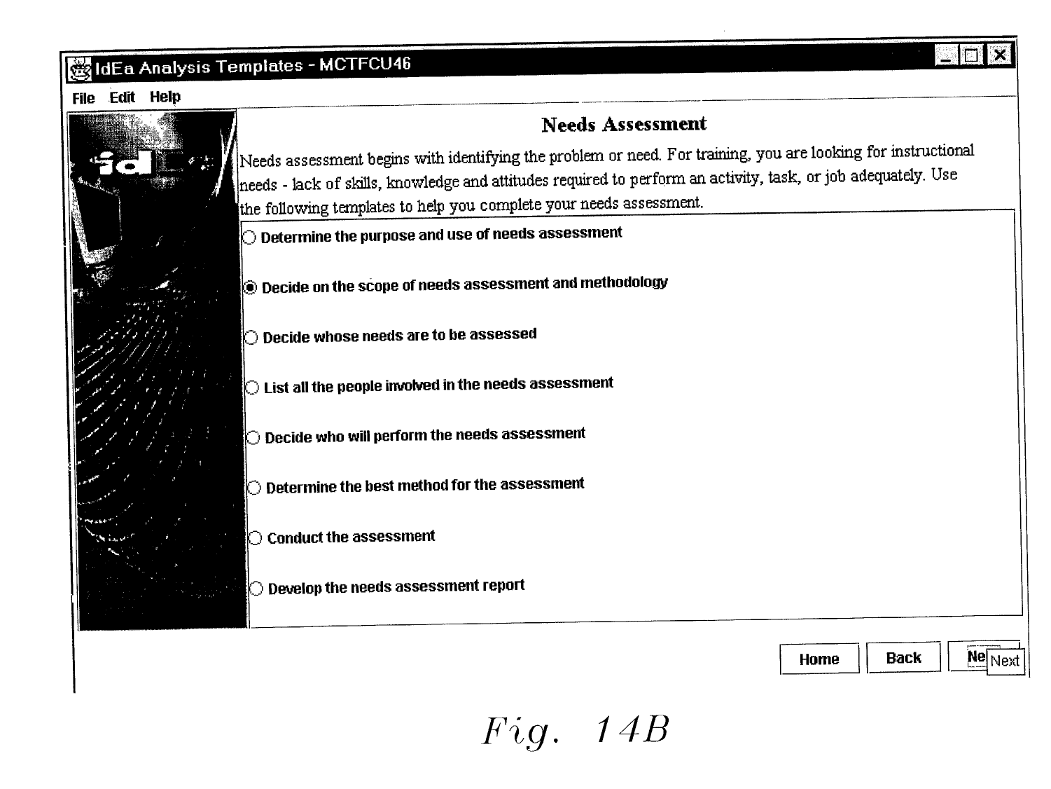

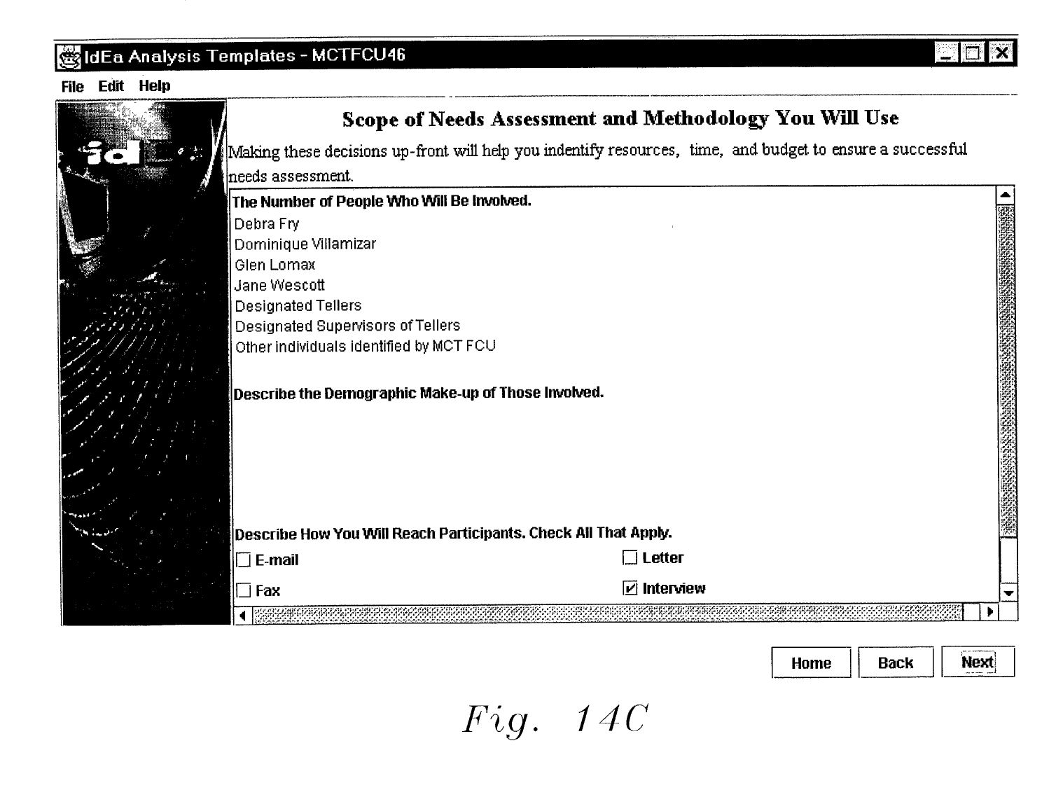

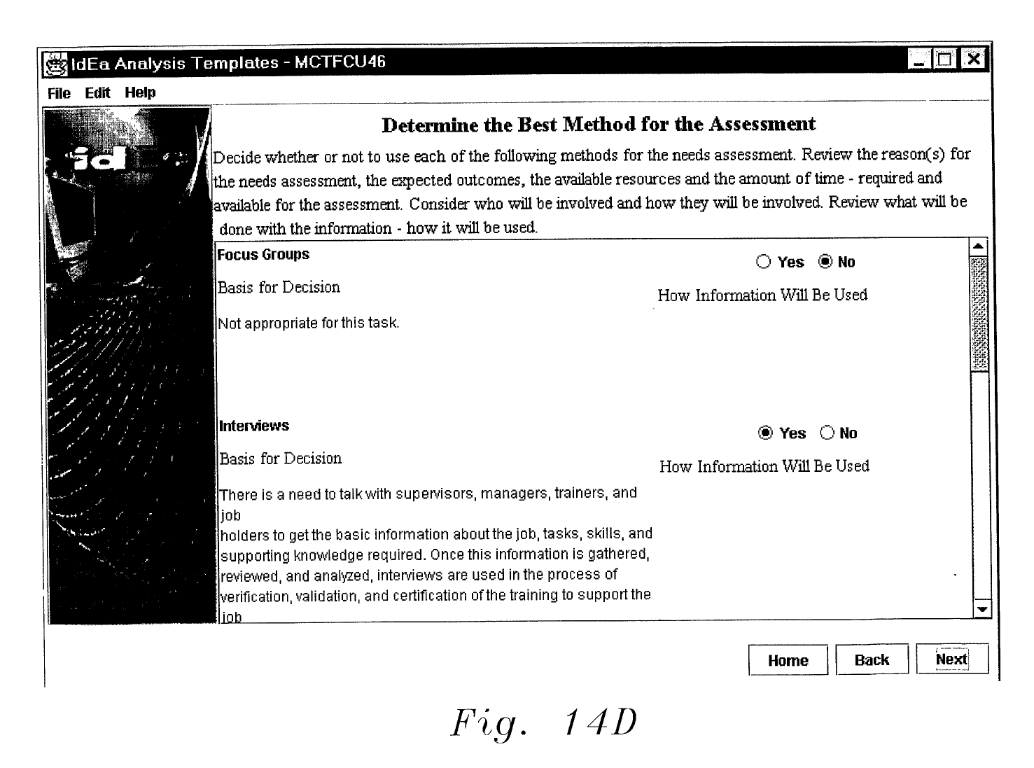

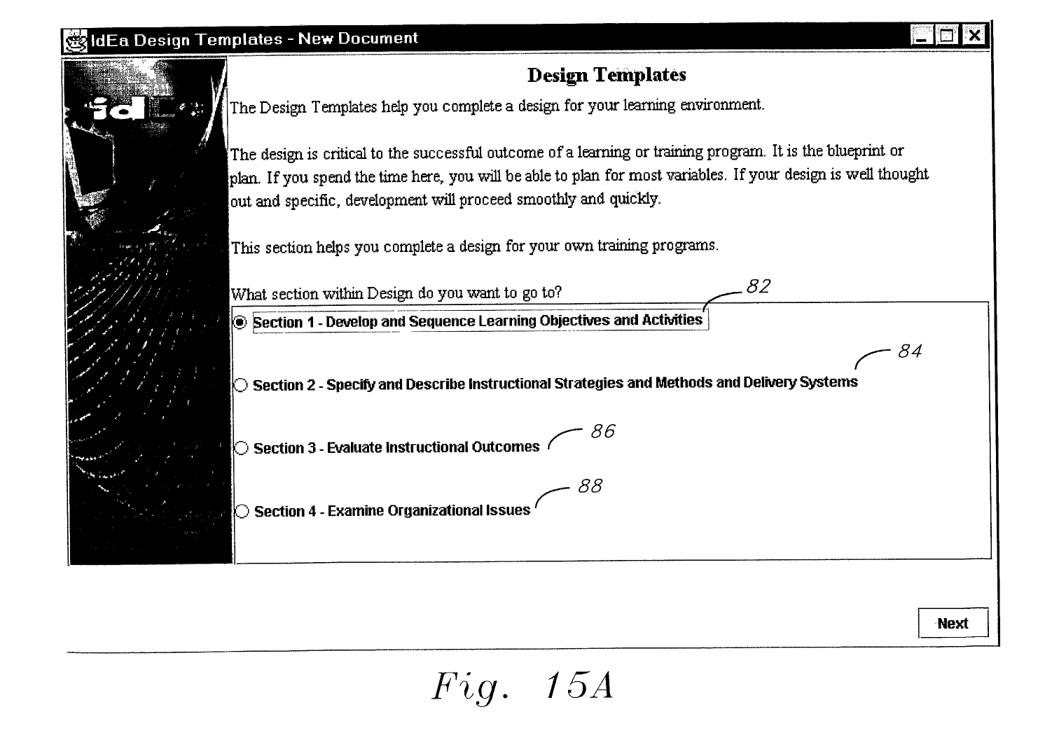

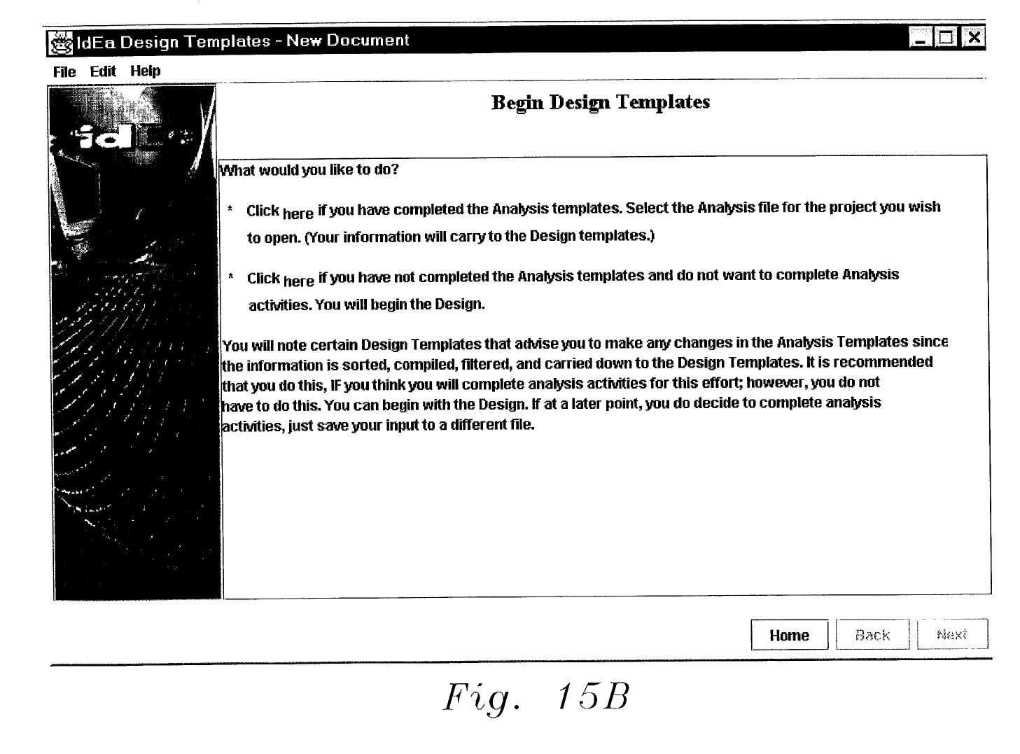

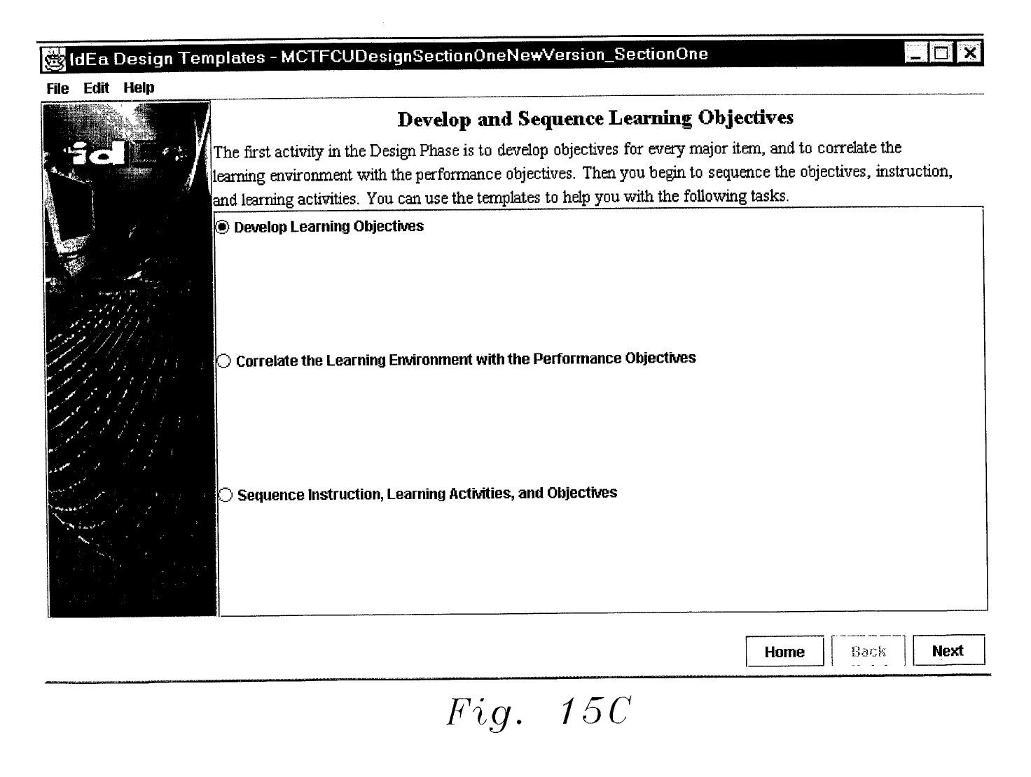

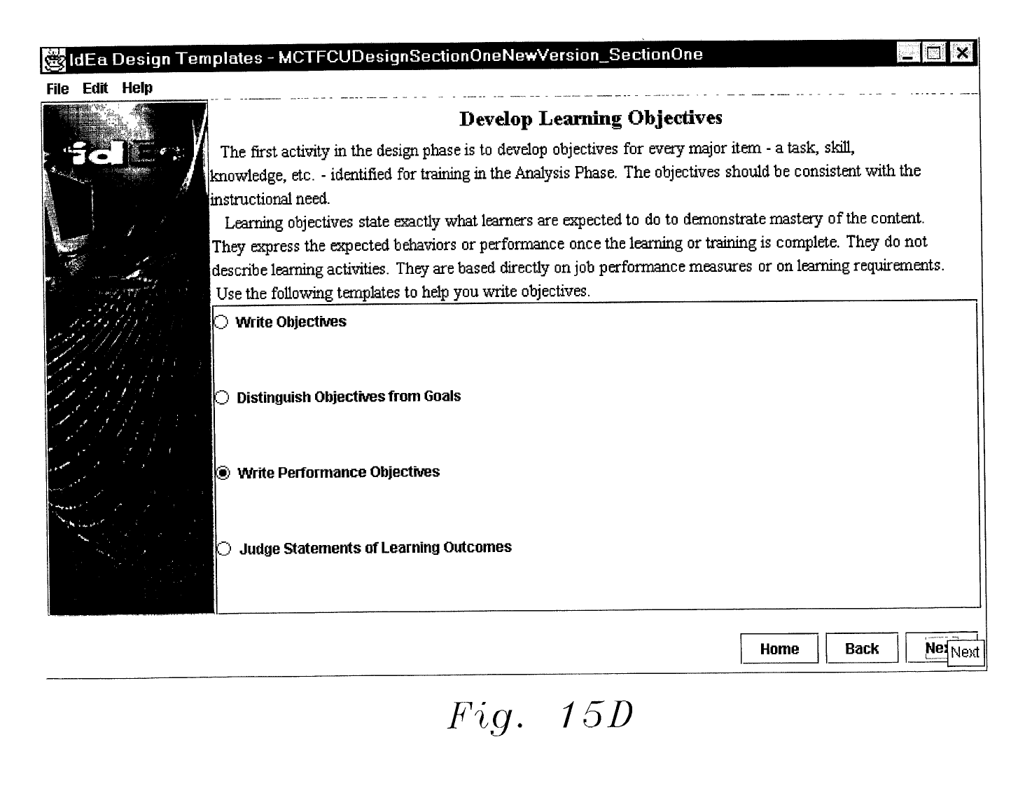

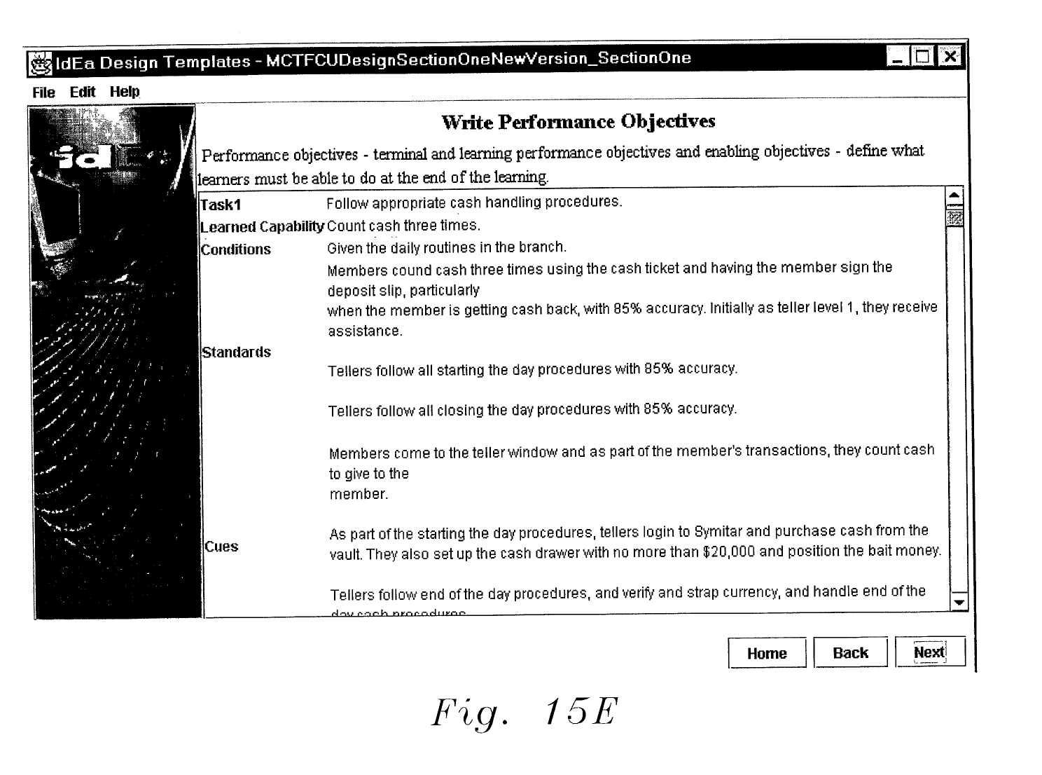

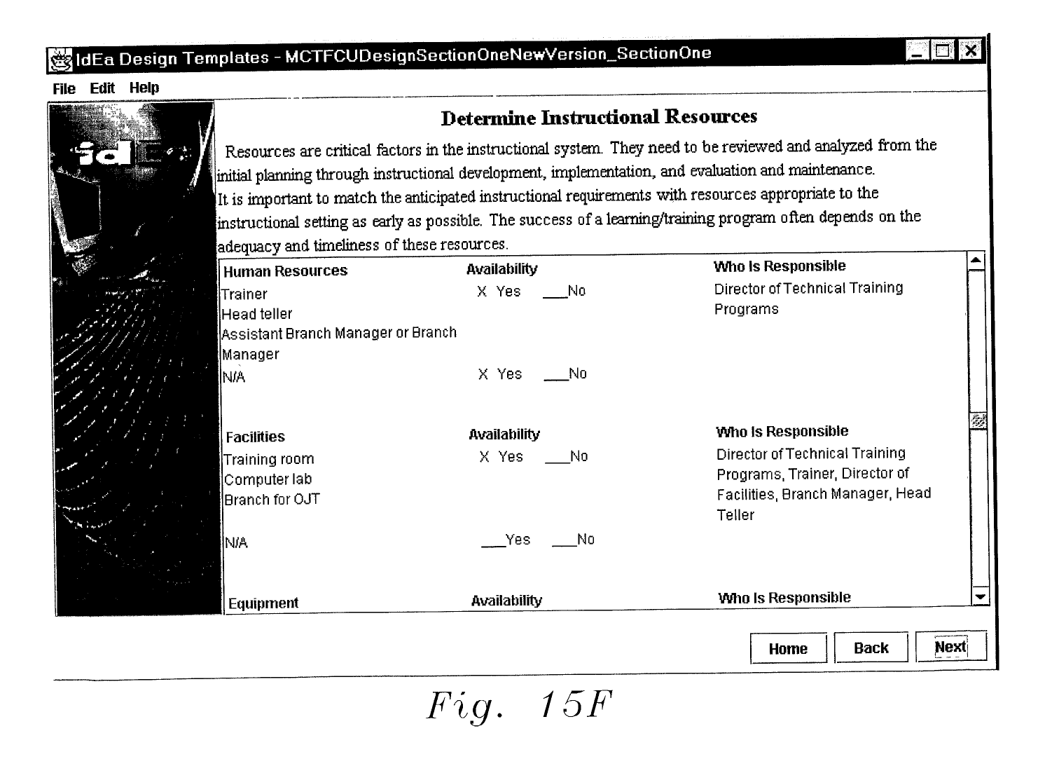

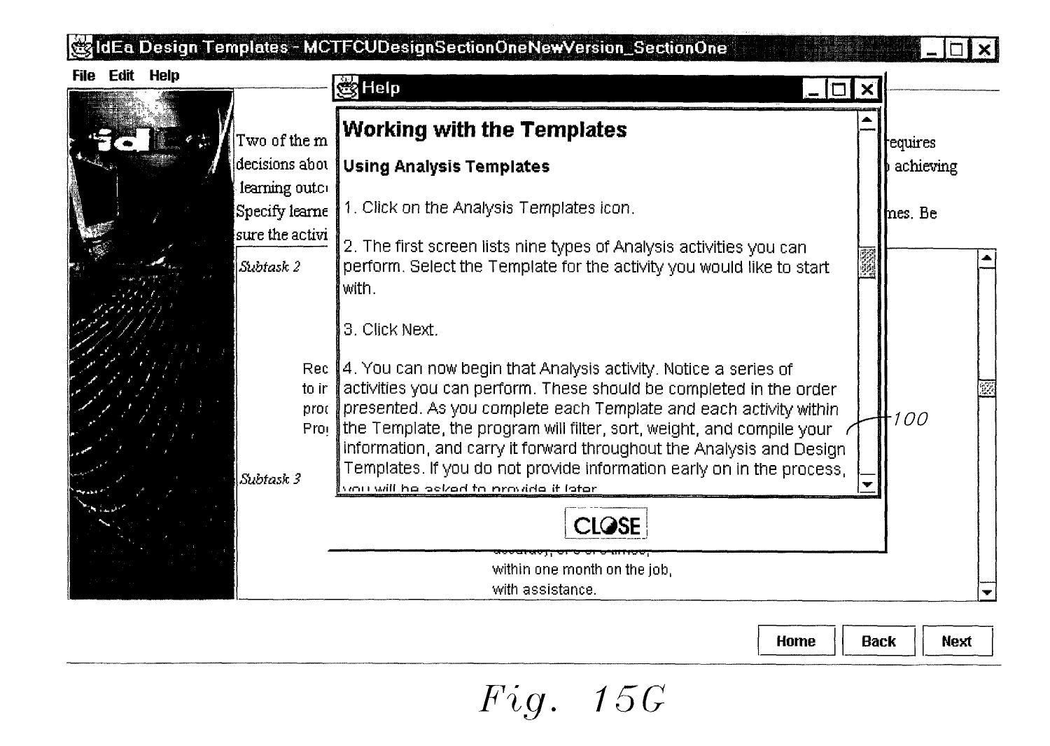

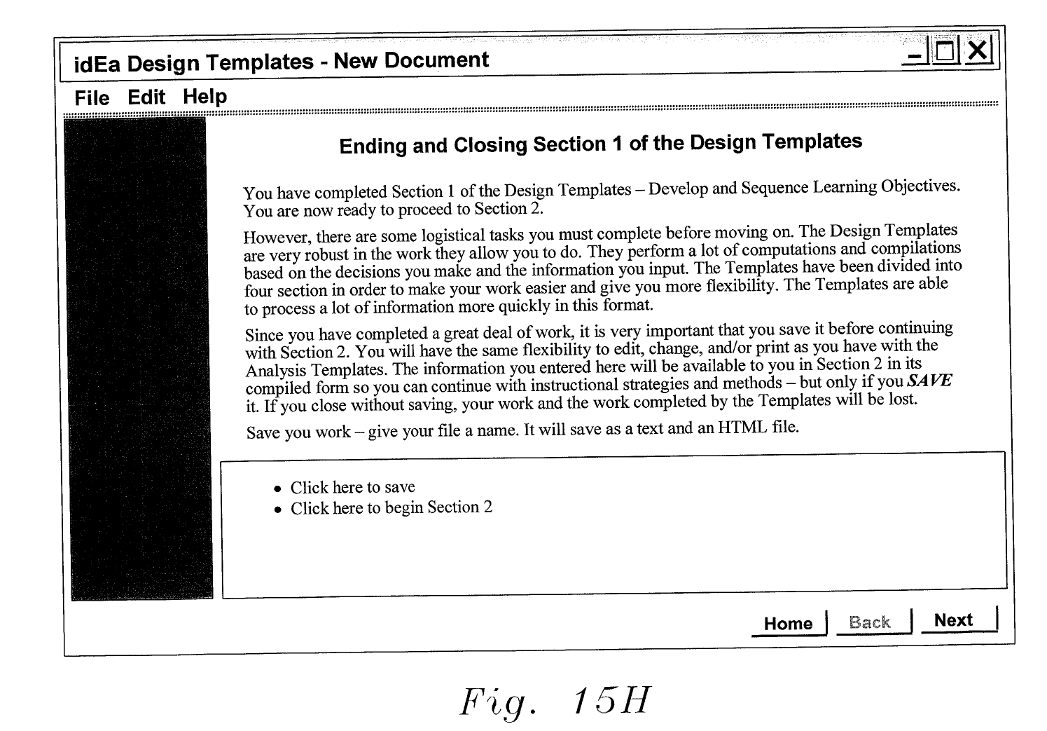

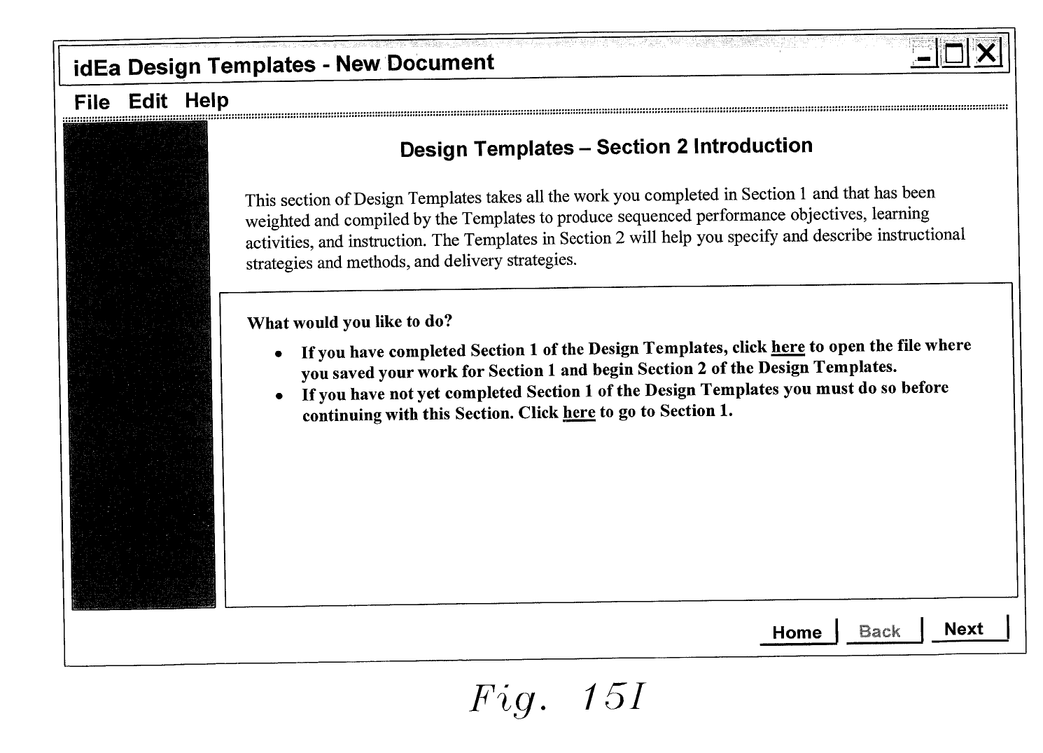

The idEa tool 38 is broadly divided into the guidelines 40 and templates 42, as shown in FIG. 2. The guidelines is a rich knowledge base based on the Instructional Systems Design (ISD) Model. The browser-based guidelines 40 provide the organization with principles, a tutorial, and guidelines for designing and developing instructionally sound training programs. Structurally the guidelines include content display, navigation means, a glossary, help including the tutorial, a notepad and bookmark tool, all deriving their content from a content database via a data processor. The idEa templates 42 are Java-based and allow users to complete analysis and design tasks and activities online. The templates 42 are either downloaded from the web server 28 or accessed through a browser using the Java Web Start plug-in so that the organization may input information to design their job training program. The templates 42—and their contents—are structured as objects so that course designers/developers and subject matter experts can reuse them. The templates 42 behave like wizards to guide the user in completing the template 42. A wizard is an interactive utility that guides a user through a process step by step. Templates are presented to users for their input of data specific to a task or activity. Pop-up windows appear at certain places to offer suggestions, tips, and the opportunity to seek help. Each template has a toolbar offering users several functions, e.g., file options, help function, etc. Users may save templates in a file, to their desktop, to their LAN, to disk, to export to HTML, etc. Users can reuse templates. A data processor 52 performs one or more of the following processes, depending on the particular task represented by the template, using a rule-based processing engine: (1) compiles the information; (2) weights the information based on a rule-based process; (3) calculates based on a rule-based process; and (4) filters/sorts the information based on a rule-based process. Once the processing is complete, the processor 52 outputs recommendations as process objects. The objects can be different forms depending on their intent and the type of business. The templates themselves are objects, as well as the fields and the information contained in the fields. Depending on the template and its purpose, the template references needed objects and displays them in a structured format, outputting desired information as well as allowing users to insert or change information, as shown below in FIGS. 14A-14D and FIGS. 15A-15I. It will be noted that users may begin with the guidelines 40 for advice and tutorial assistance, or they can go directly to the templates 42 to complete the work, accessing the guidelines 40 as needed through the Help function. The templates 42 correspond to the first two phases of the ISD process: (1) analysis; and (2) design.

Referring back to FIG. 1C, the designer's toolkit 44 is a Web-based designer's toolkit which enables users to design, develop, deliver, and evaluate training (Web-based, video-based, distance learning, interactive courseware, job performance aids, simulation-based, multimedia, virtual reality, and instructor-led training).

The information needed by Web Author 46 is received from the idEa templates 42 and designer's toolkit 44, and Web Author takes the users through the process of authoring a Web application (defined herein as any application that uses HTTP as its transfer protocol).

The collaboration utility 48 allows users (job holders, learners, etc.) to collaborate and interact with each other. Collaboration may be performed with synchronous tools in real-time, or in asynchronous mode which allows collaboration anytime, anywhere.

The administration/CMI/LMS utility 36 is a set of state-of the-art tools which provides for all course administration and course management functions, including registration, tracking, assessment, scoring, reporting, and scheduling. The set also provides for system administration in the collaboration areas for designer/developers, subject matter experts, graphic designers, programmers, engineers, etc. The set includes tools for individuals who are responsible for system administration, scheduling and/or registering people or groups for collaborative work or learning sessions. Designer/developer tools and exported courses from Web Author (the Web-based Designer ToolKit) can be launched from the utility 36.

The study/organization tools 50 is a set of tools that supports both synchronous and asynchronous work areas. This set of tools includes: (1) state-of-the-art calendar/scheduling tools similar to a day planner that allows users to schedule synchronous conferences, meetings, and learning and project activities; (2) state-of-the-art presentation areas where teams, learners, subject matter experts, and job holders can complete assignments and projects and upload them to a designated area for the publication of team projects (team presentation areas are access-controlled and can be edited by team members only); and (3) exported courses from Web Author.

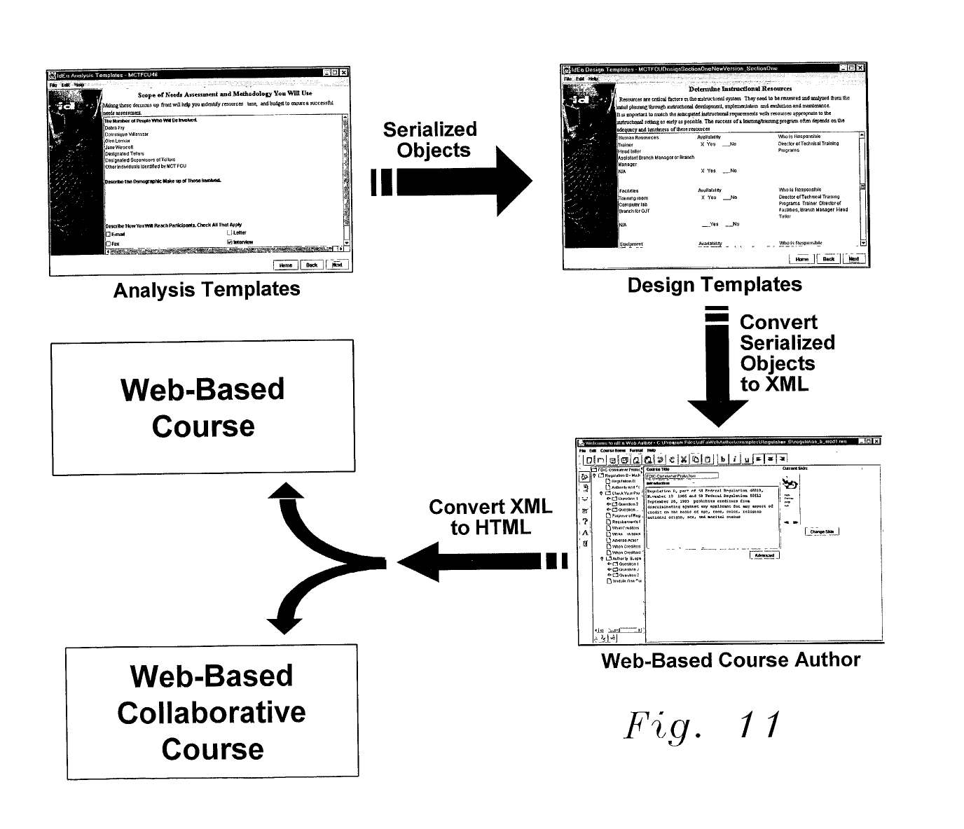

As shown in FIG. 11, the suite of software applications is generally used by starting with the analysis templates. Output from the analysis templates is carried over as serialized objects to the design templates. Output from the design templates is in the form of serialized objects which may be parsed and converted to extended markup language (XML) for processing by the Web Author. The Web Author then converts the user input to an HTML based course of either individual or collaborative instruction.

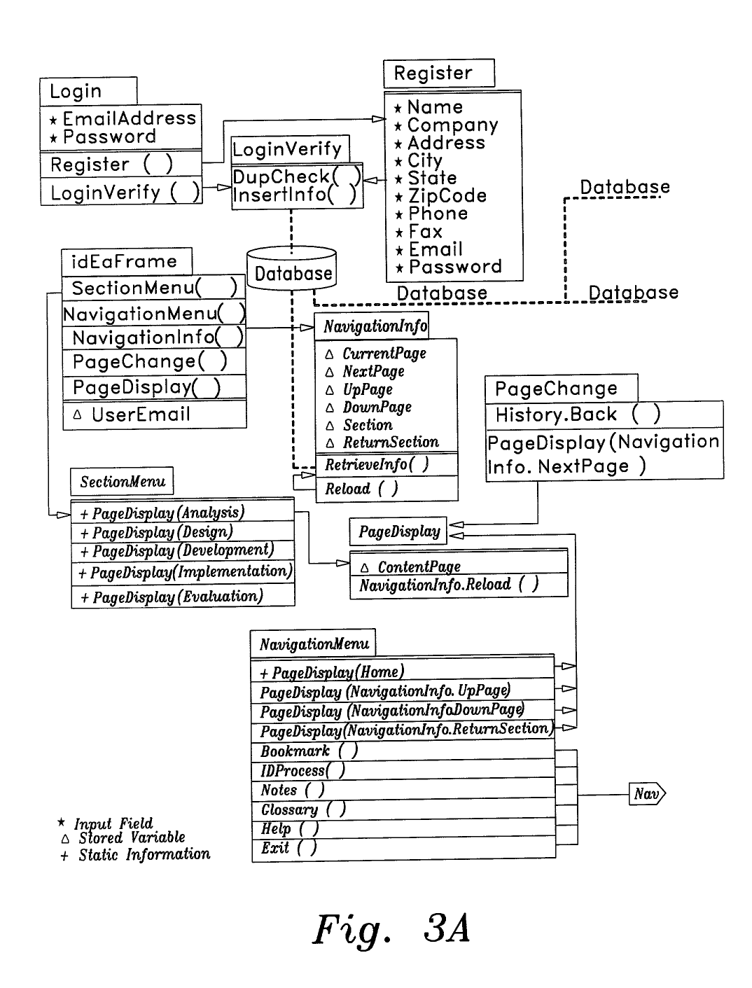

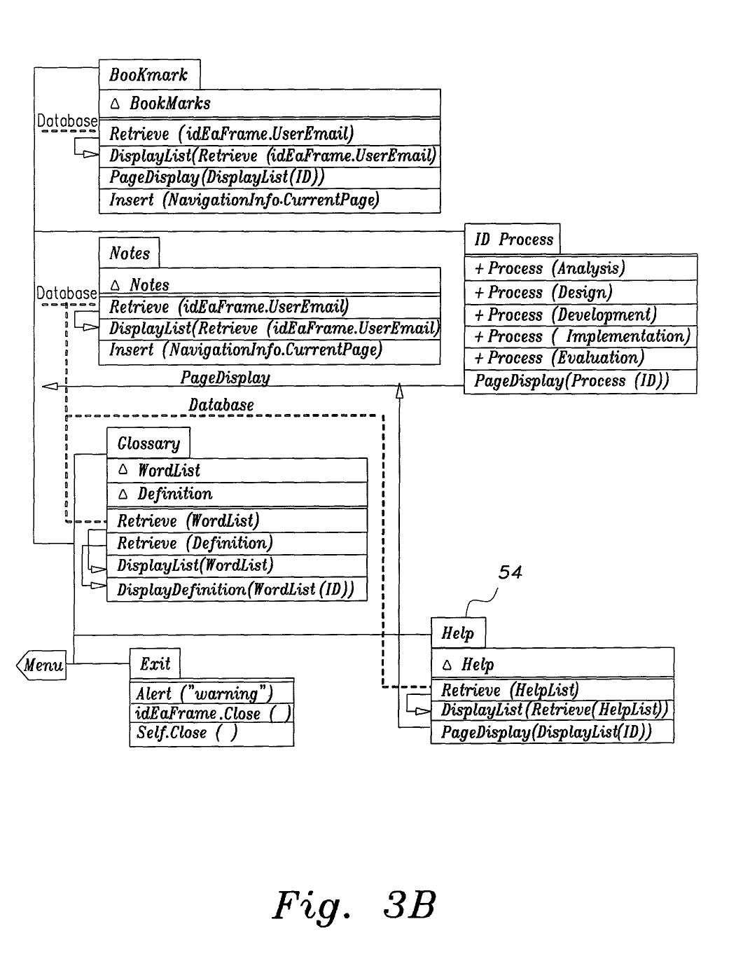

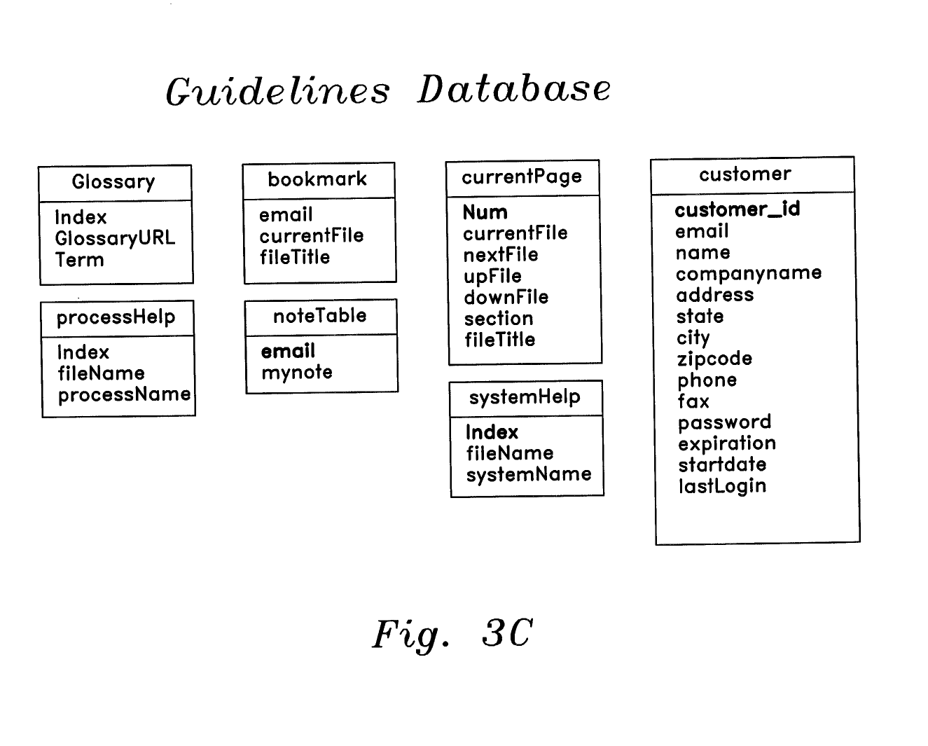

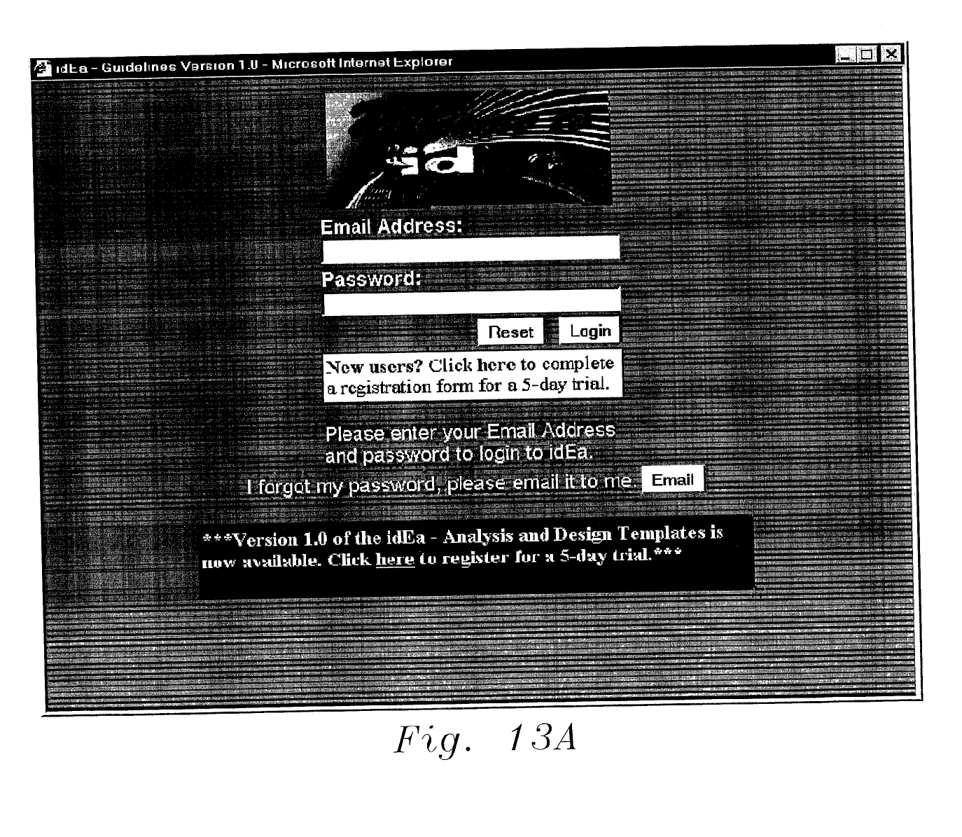

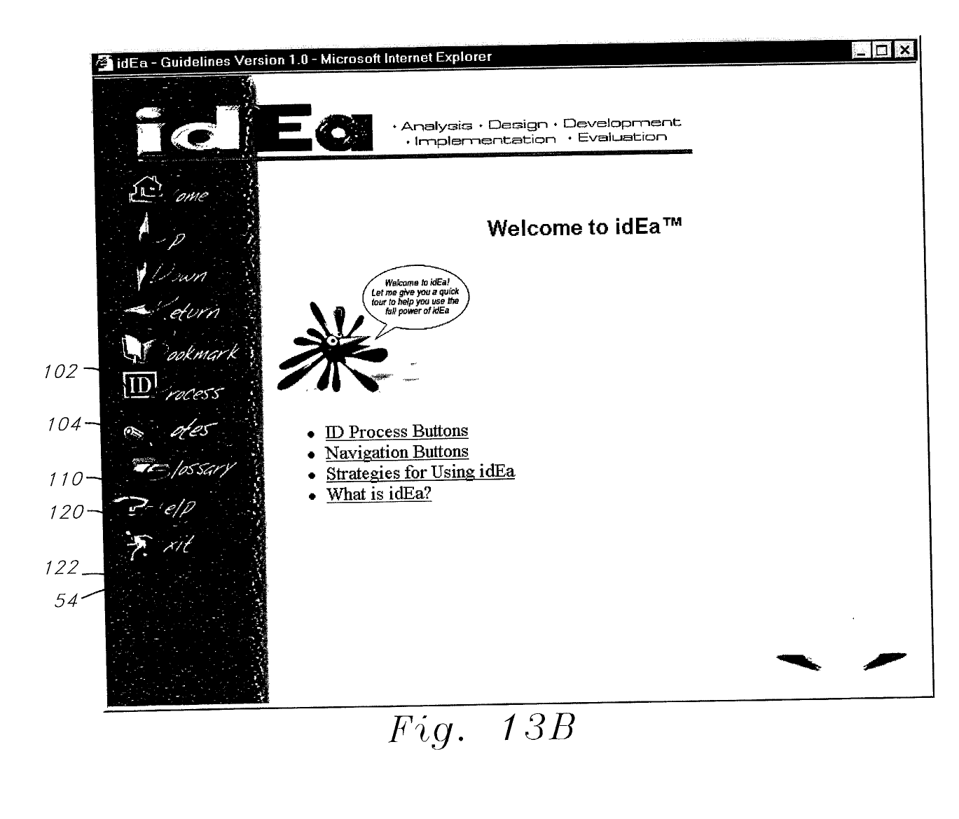

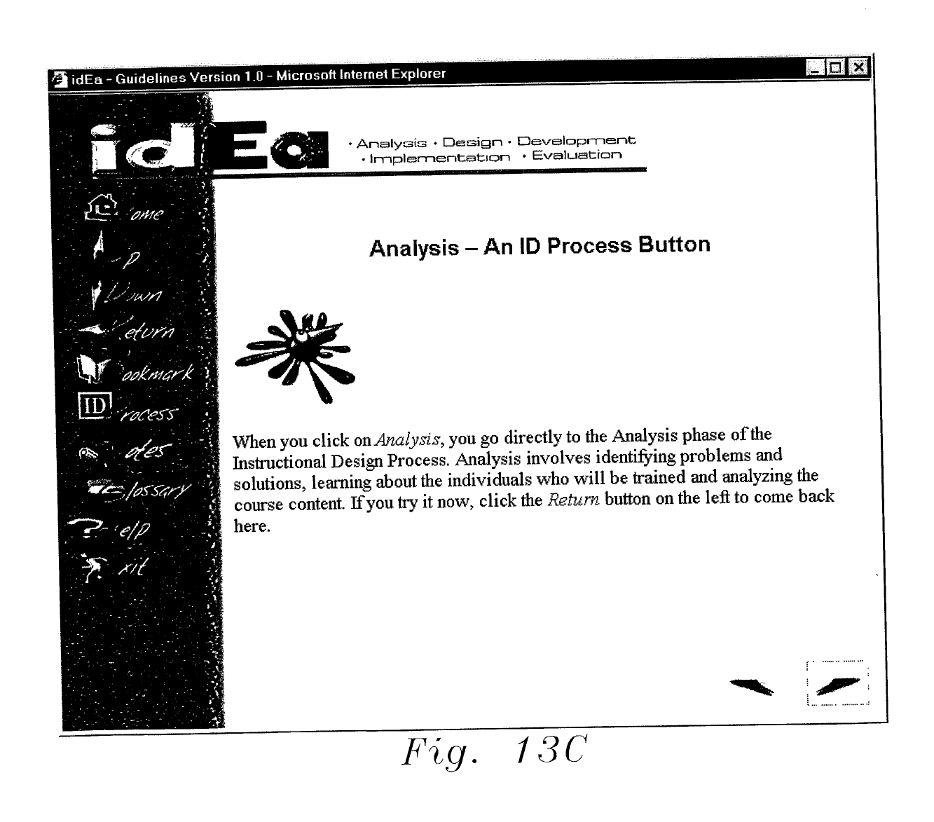

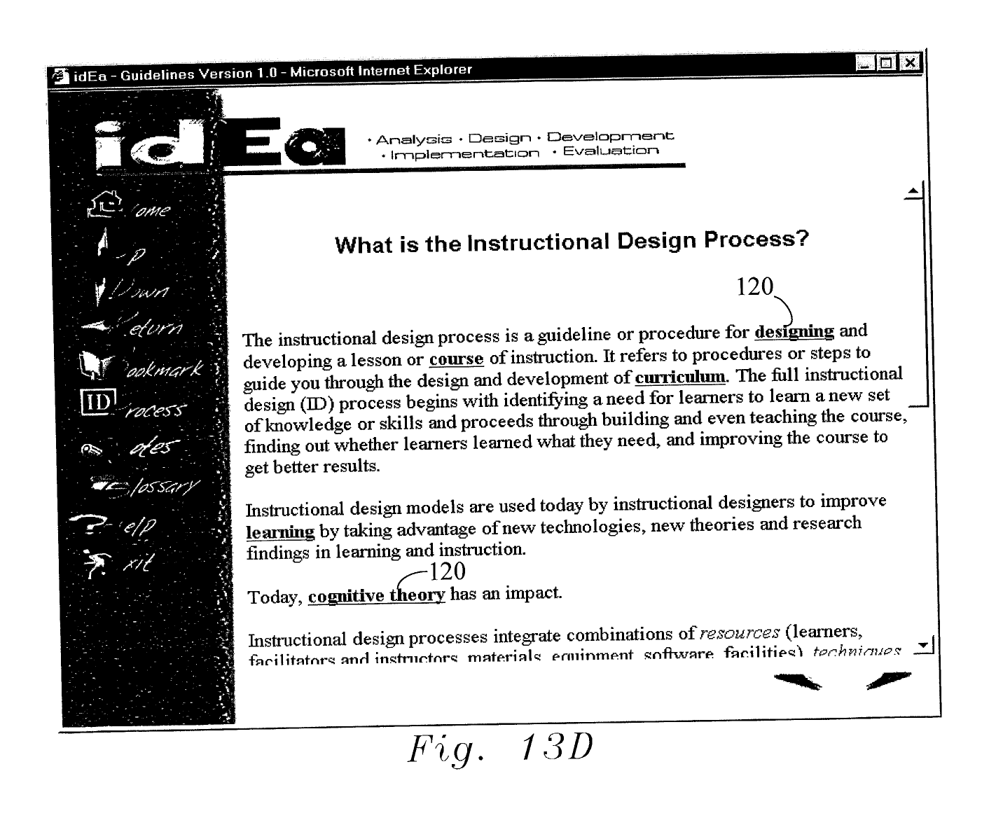

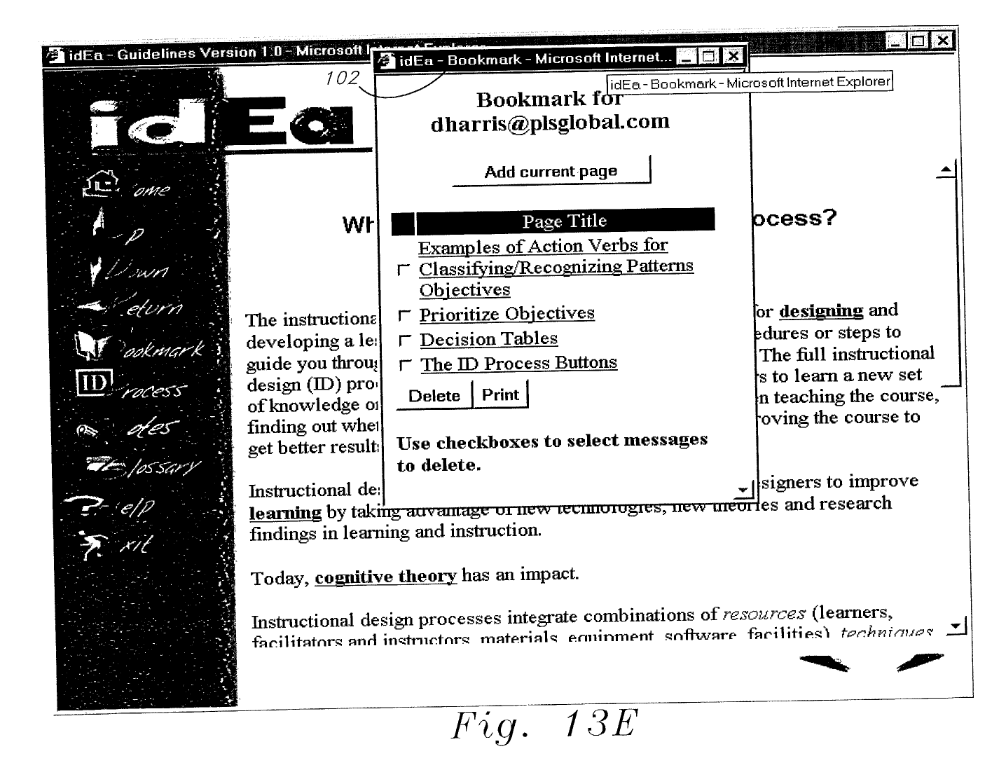

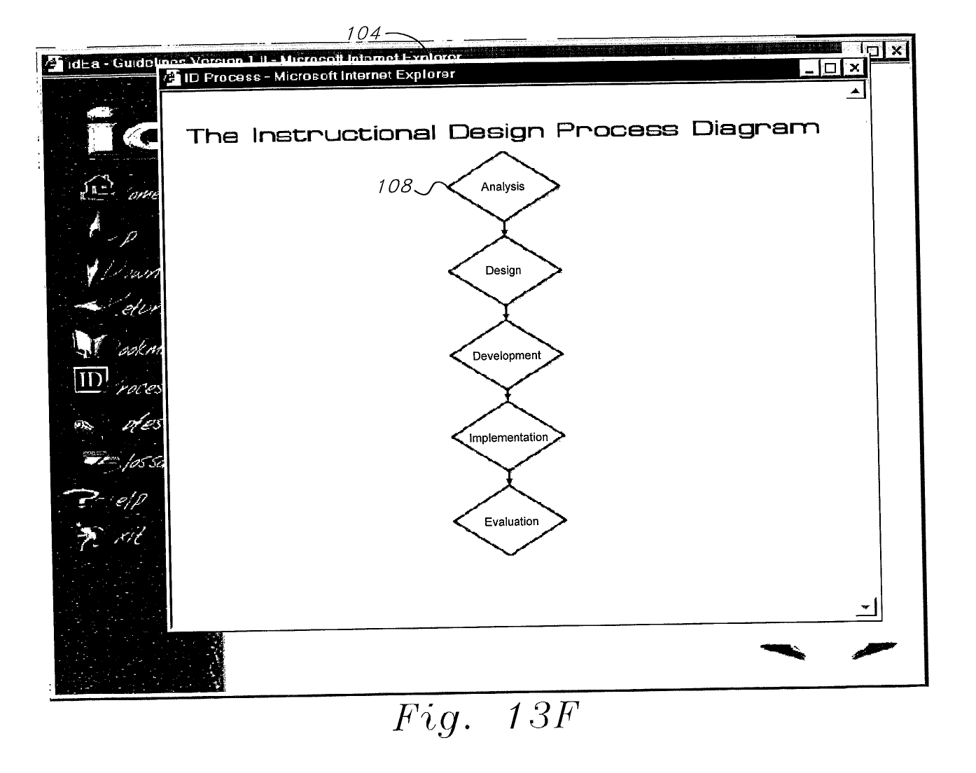

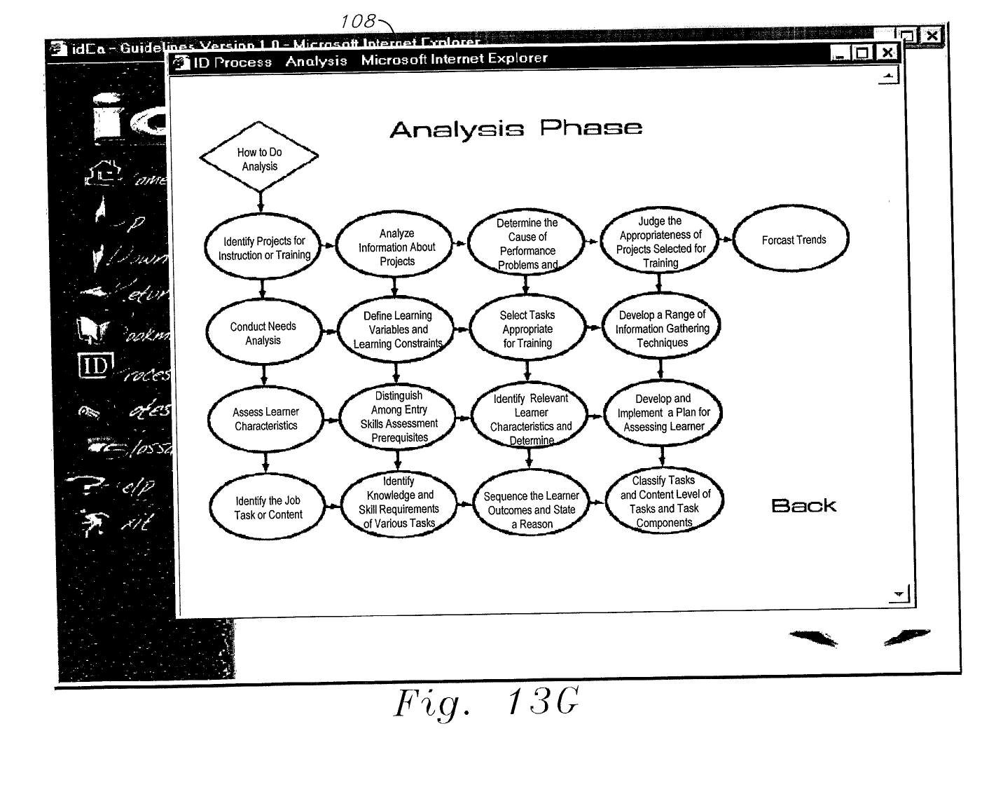

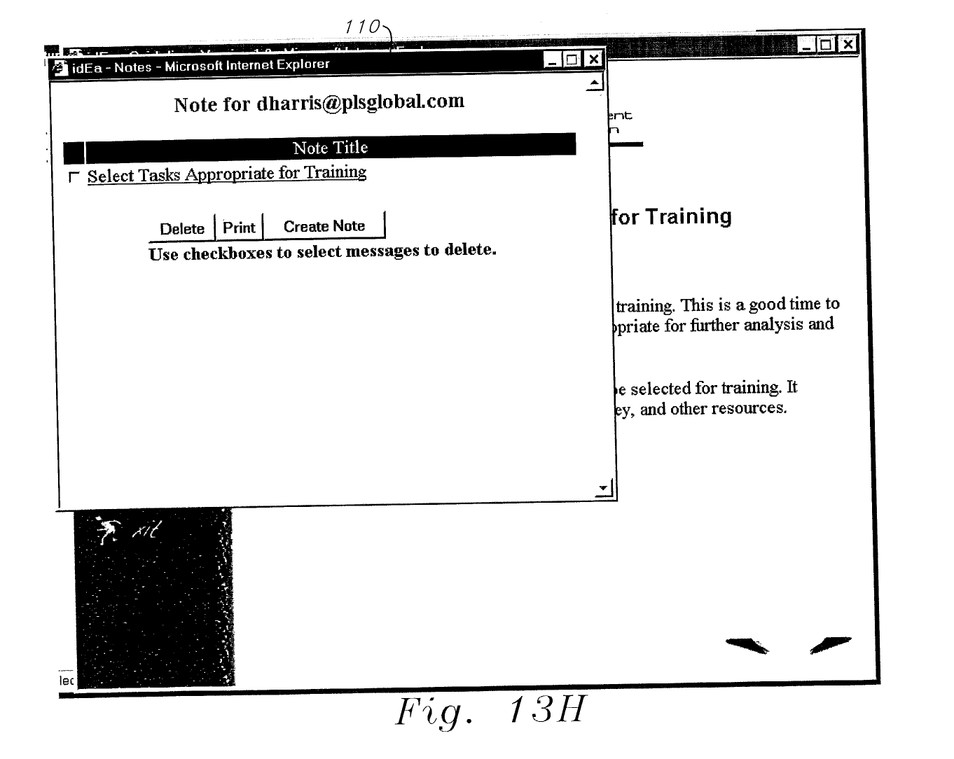

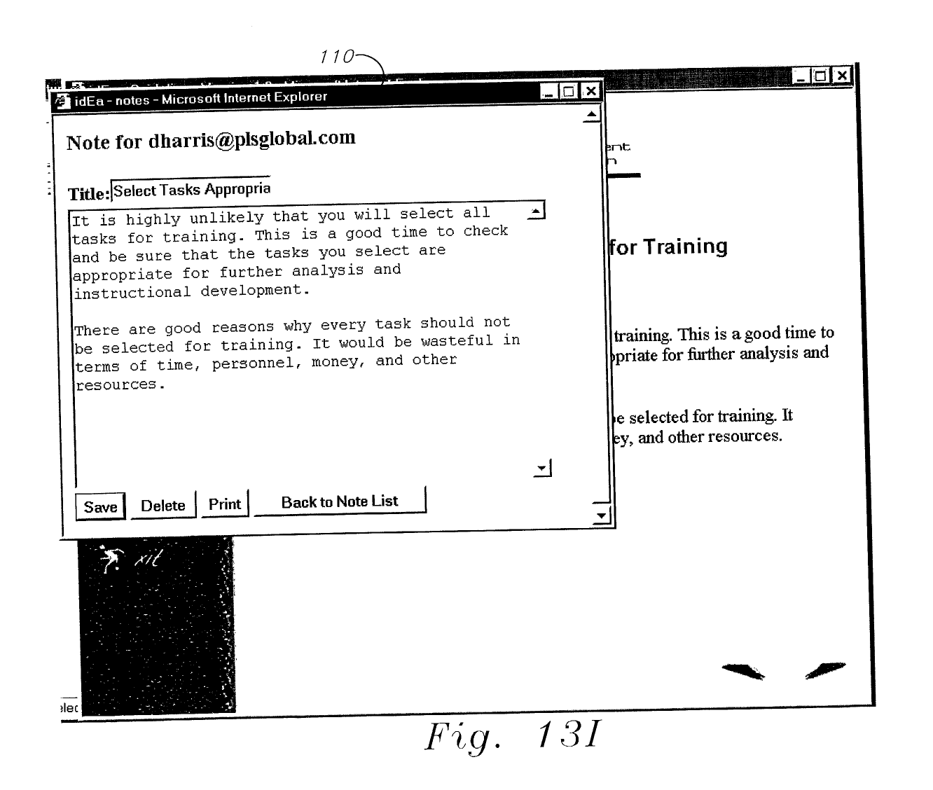

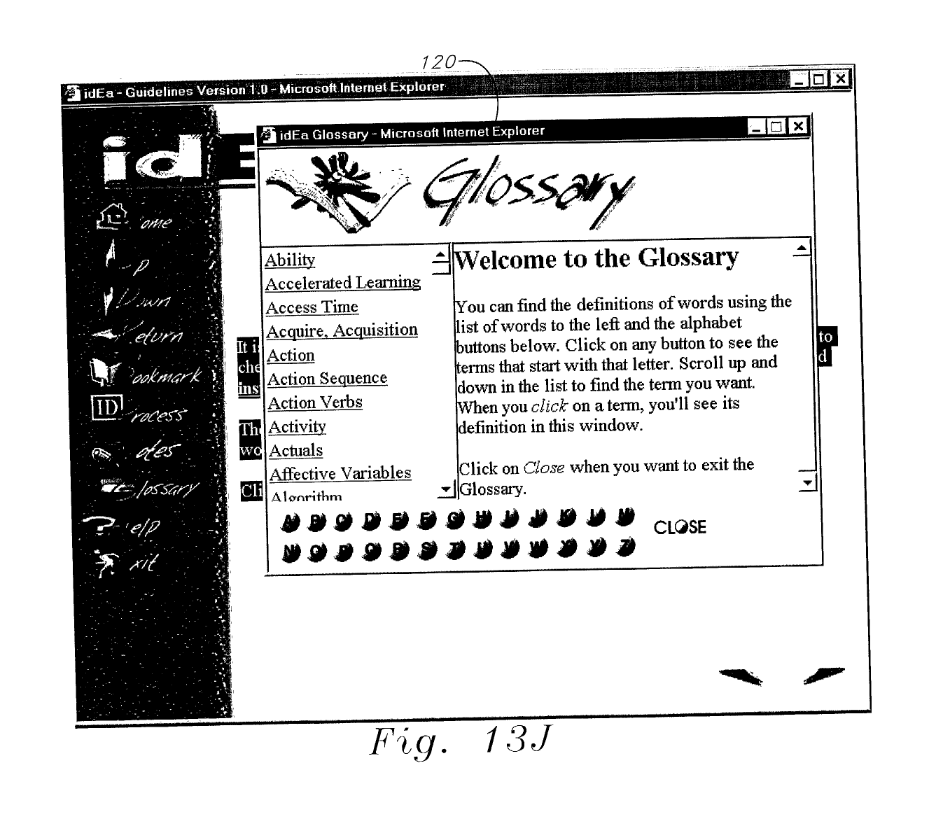

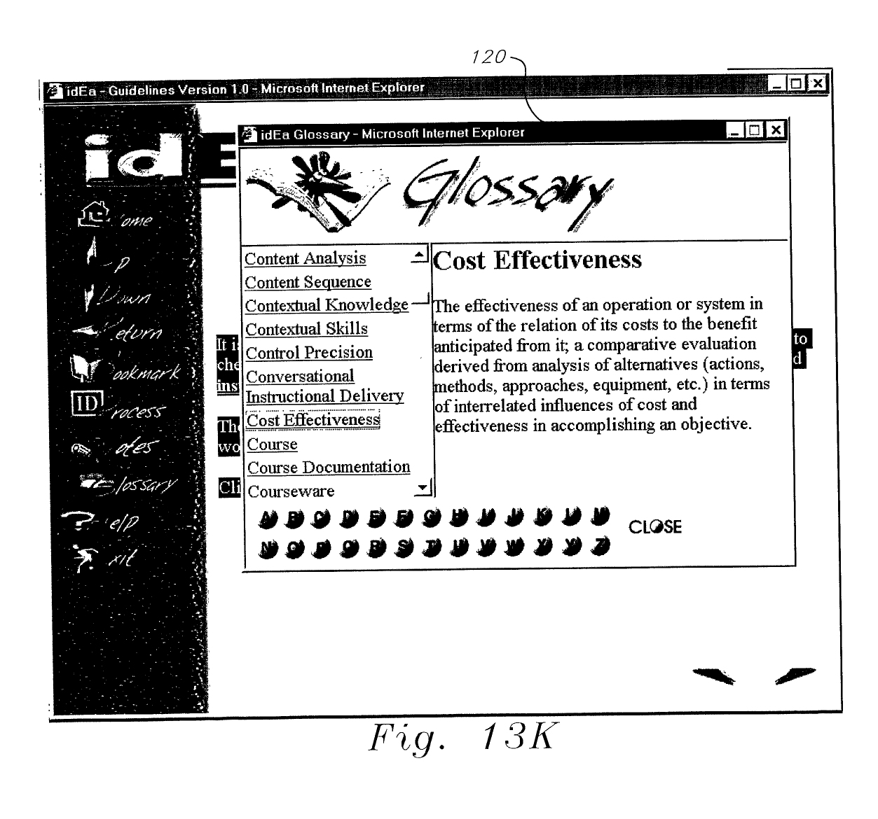

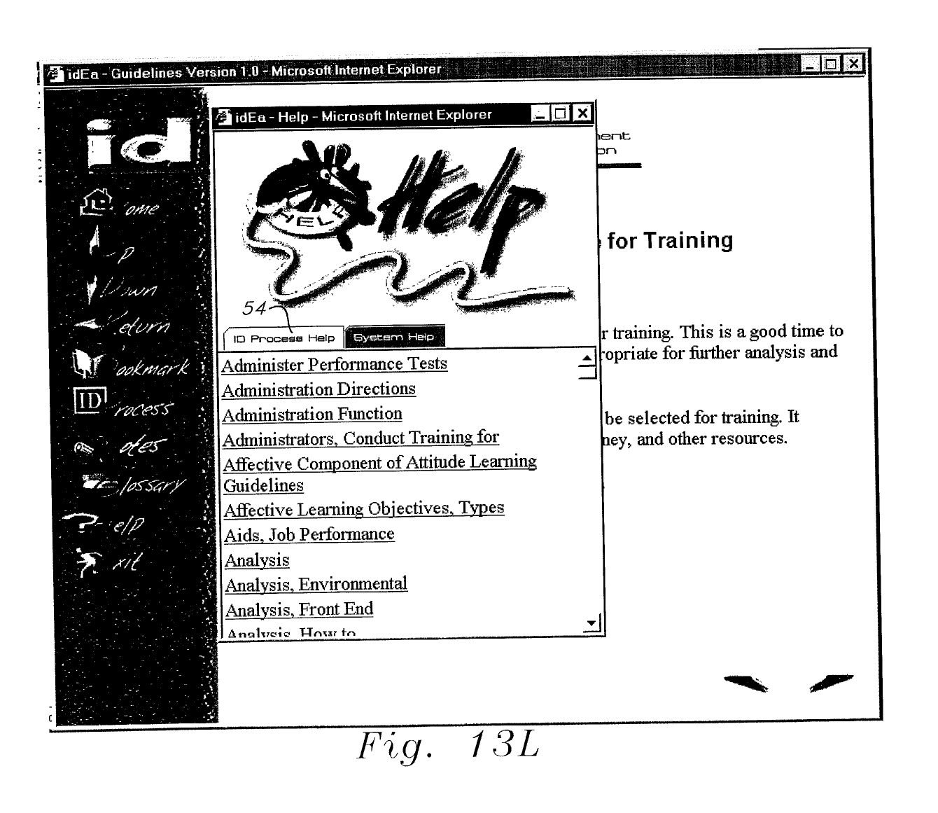

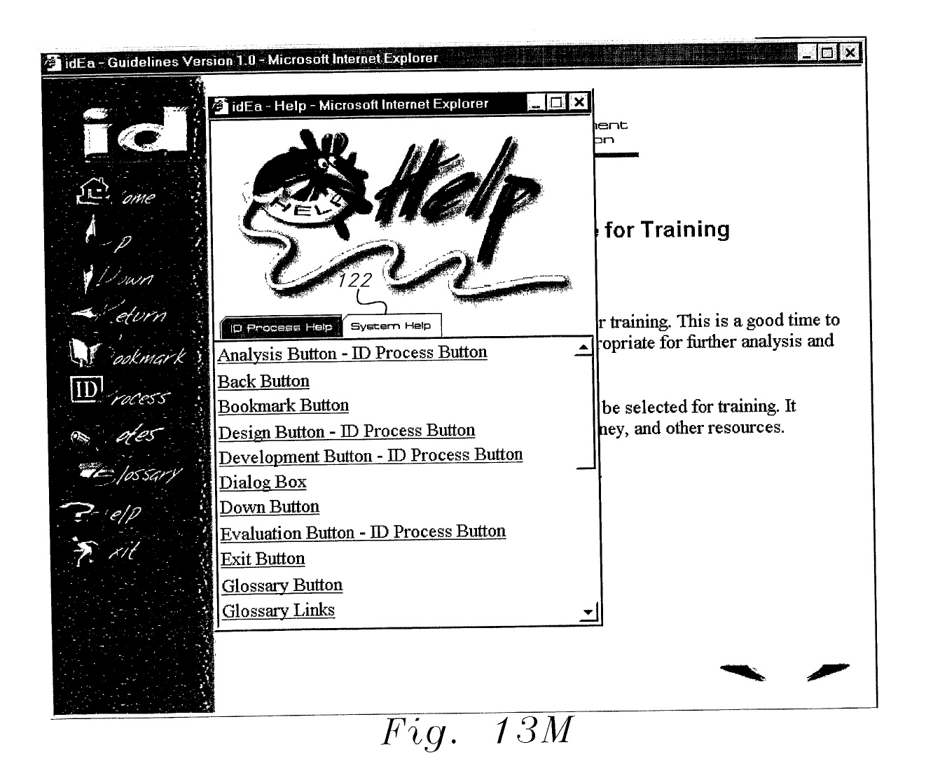

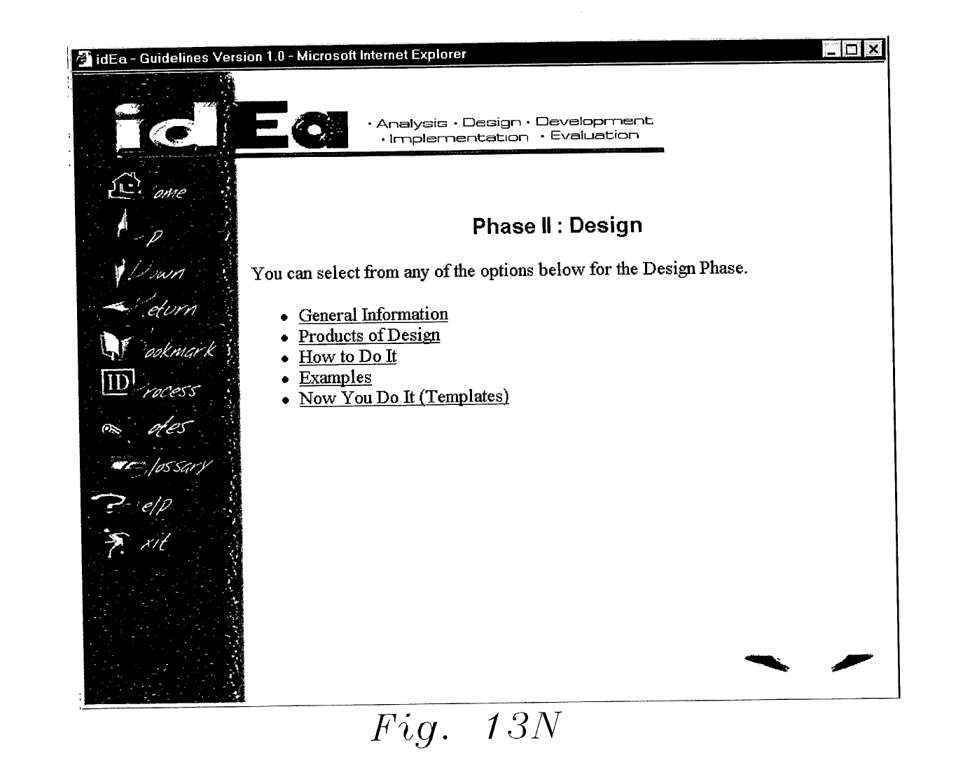

FIGS. 3A, 3B, and 3C show the menu and database structure of the guidelines 40. Users register and log in to the guidelines 40. The user interface for the log-in screen is shown in FIG. 13A as viewed with Microsoft's Internet Explorer browser. Users may work through the guidelines 40 one section at a time, e.g., the analysis section. Those who are new to instructional design can start at the beginning and work through the entire program in a tutorial mode to the point where they can build their own program. They can view the entire contents of each section by clicking on every link on a screen. If there are no links on a screen, they click “next” and navigate through the next section. These aspects of the user interface are shown in the guidelines welcome screen in FIG. 13B, along with user selectable buttons on the side of the screen which offer access to such additional features as bookmarks 102 (illustrated more fully in FIG. 13E), ID Process Diagrams 104 (e.g., FIG. 13F; each block in the diagram is linked to the first page of the section, so that clicking on the analysis block takes the user to the first analysis screen (FIG. 13G), etc.), Notes 110 (e.g., FIGS. 13H and 13I), a glossary 120 (e.g., FIGS. 13J and 13K) and ID Process Help 54 for help on guideline content (e.g., as seen in FIG. 13L) or system help 122 for help on navigating features (e.g., as seen in FIG. 13M). Users can bookmark their place before exiting the program. Users can also bookmark an unlimited number of screens throughout their viewing of guidelines. Bookmarks can be easily added, printed, or deleted. Users can create, save, print, and delete notes. The glossary displays a list of glossary terms along with a frame to display the glossary definition of the selected term. It allows users to jump to the first letter of a word using the alphabet buttons. Users can select words in the glossary by scrolling in the “terms” frame. Users also access the glossary from the guidelines by clicking on bold, underscored words 120, as shown in FIG. 13D. Experienced instructional designers who want to know about a specific topic, e.g., how to design and develop Web-based training or job aids that are Web-based, will use ID Help 54, select the topic, and go directly to that section of the guidelines 40.

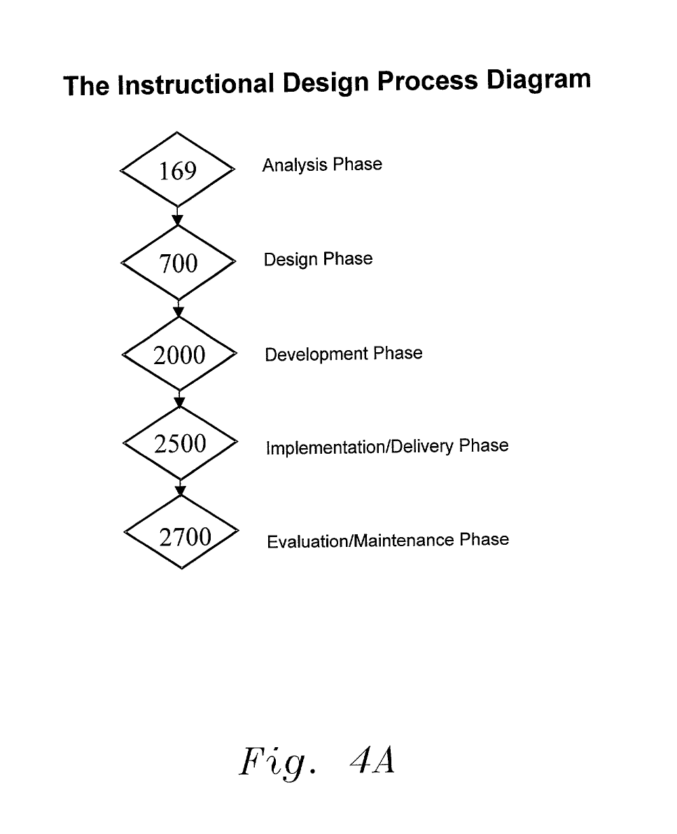

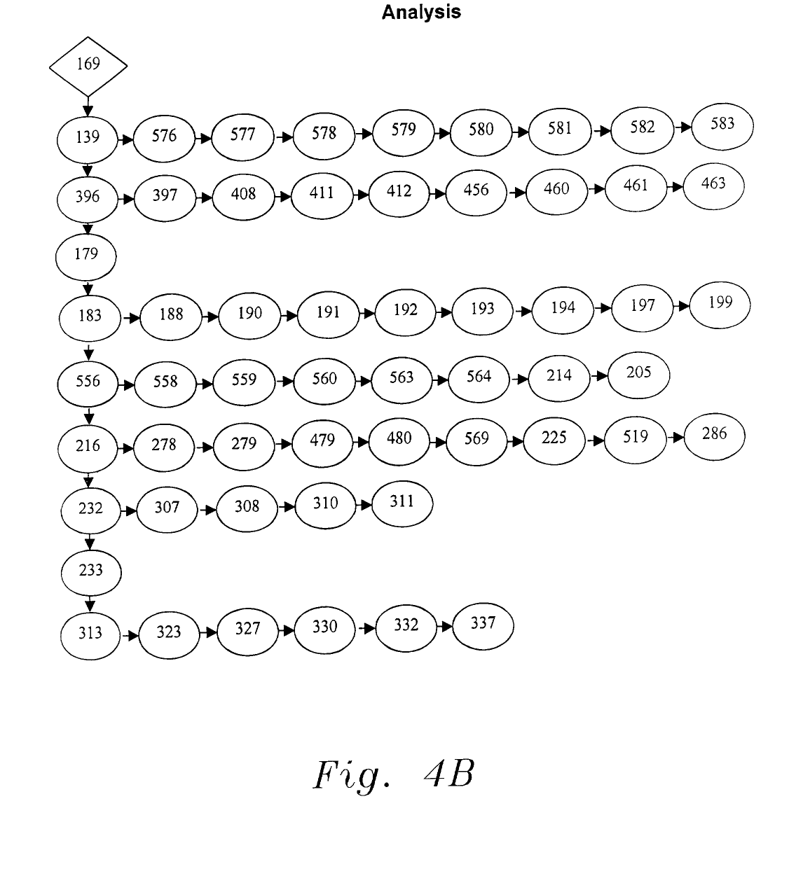

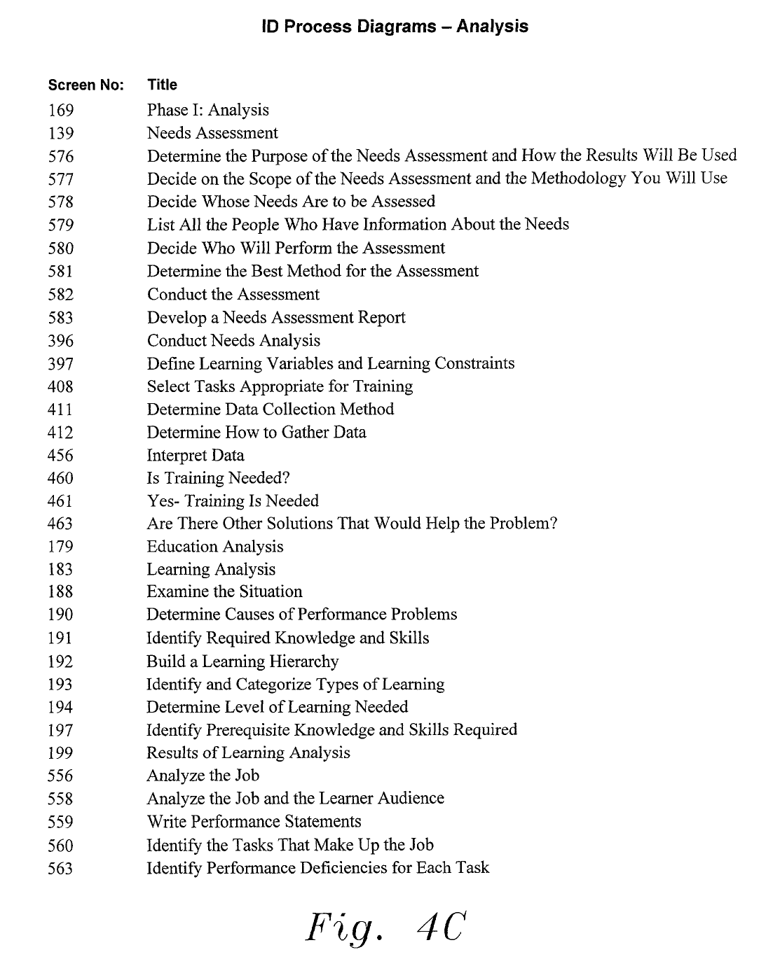

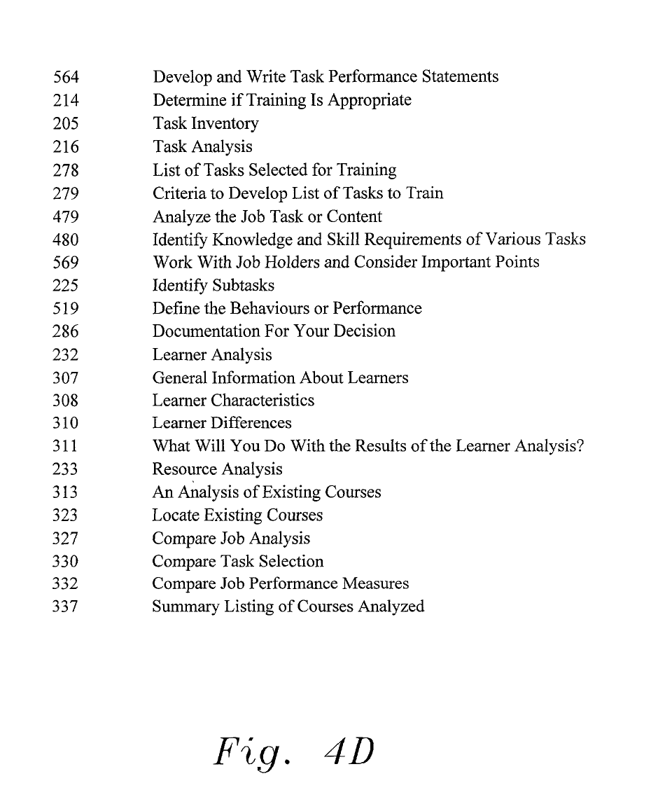

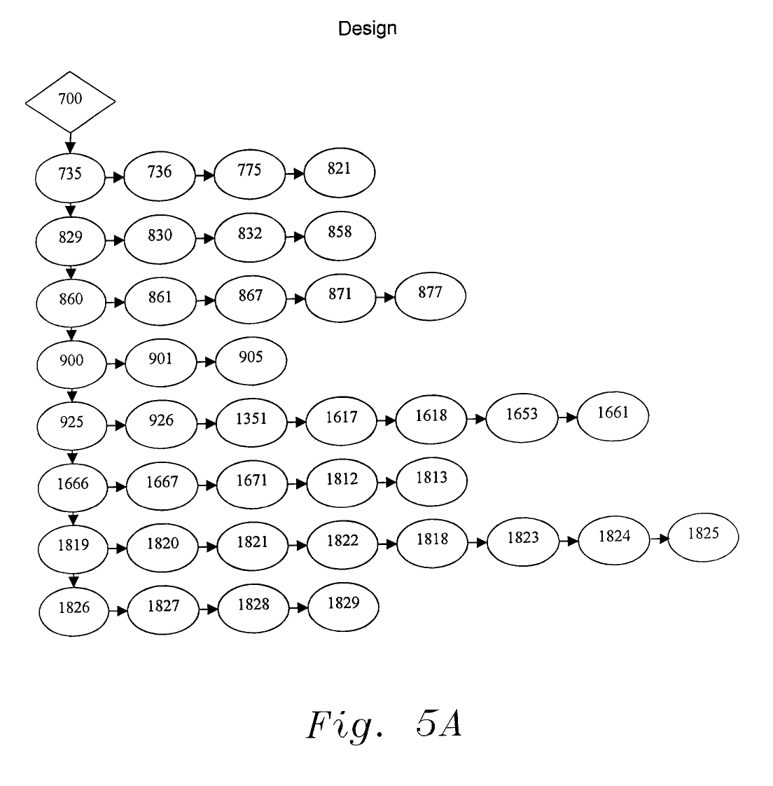

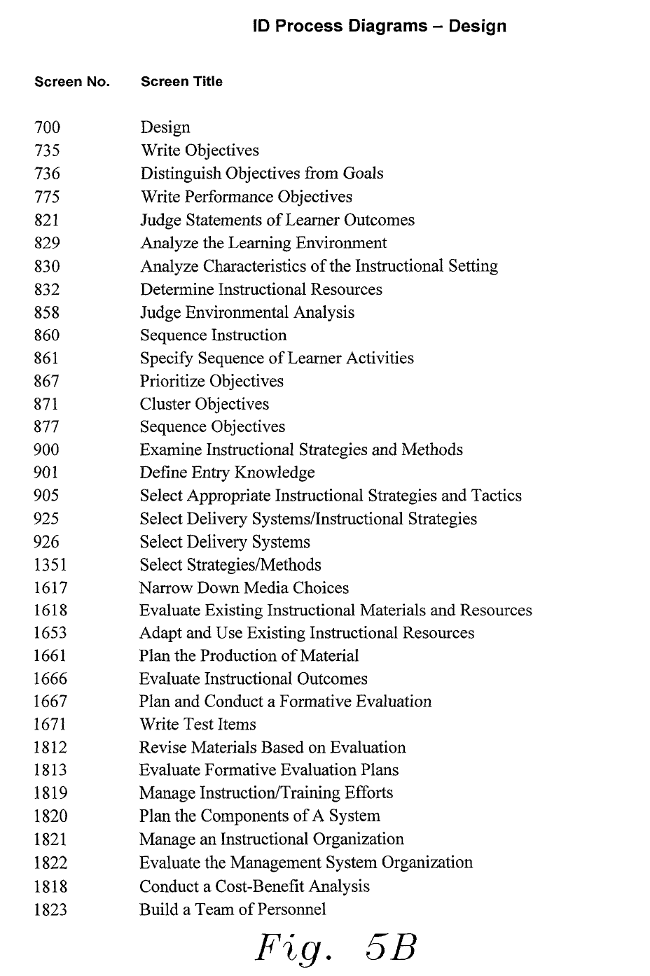

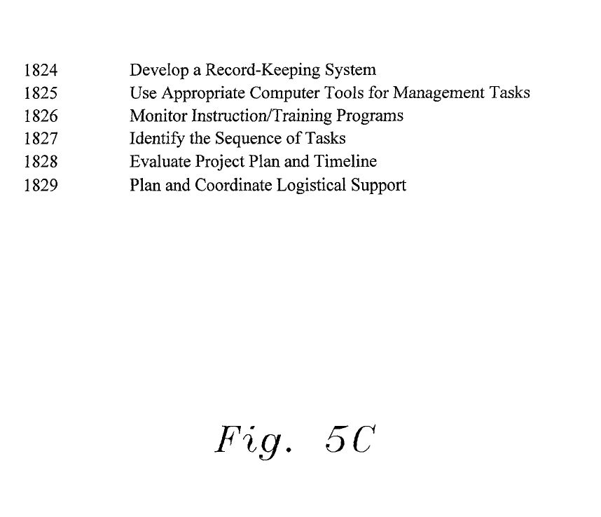

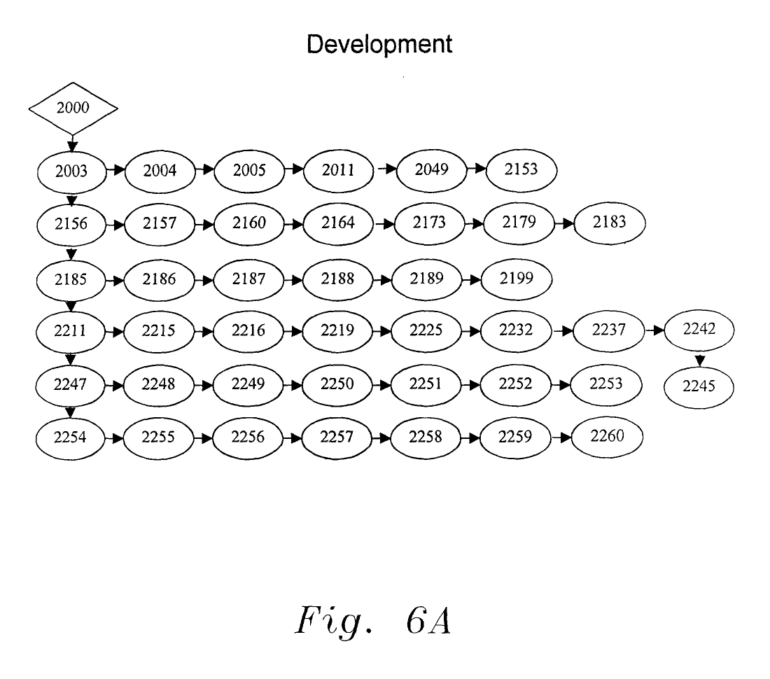

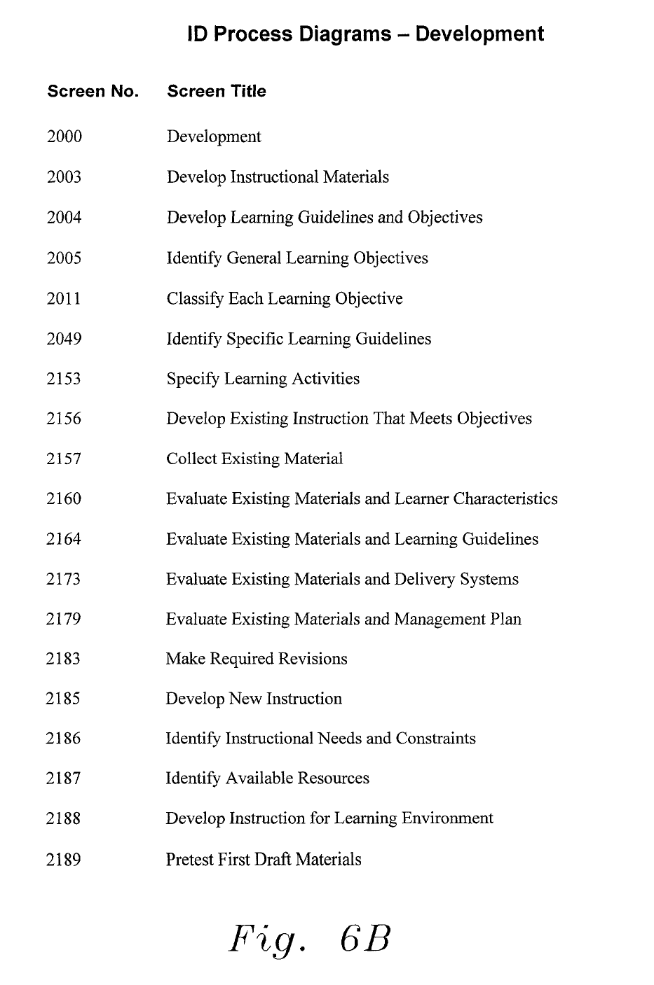

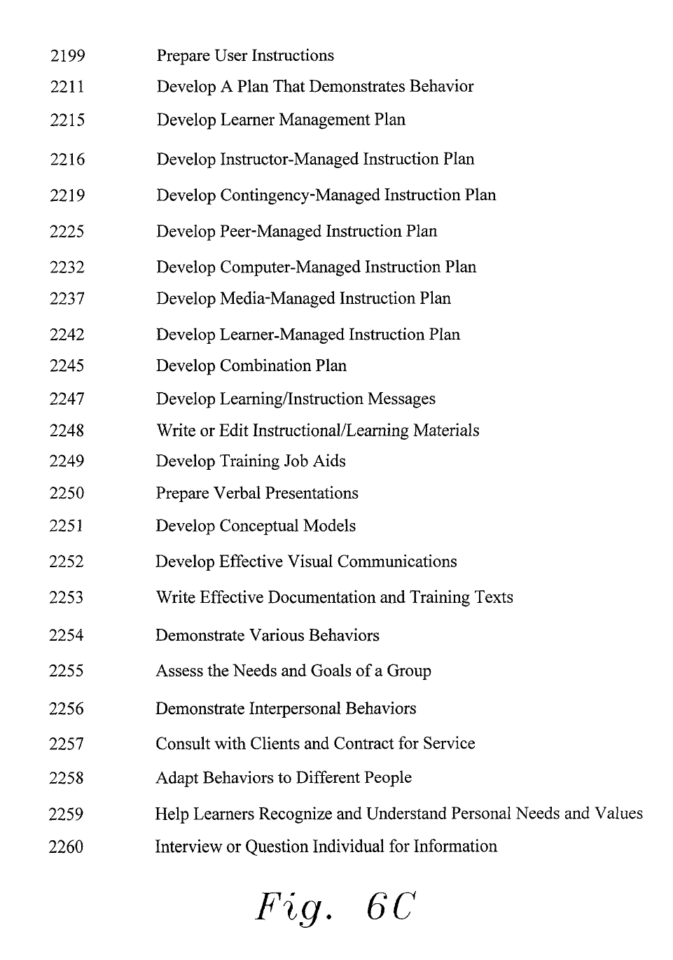

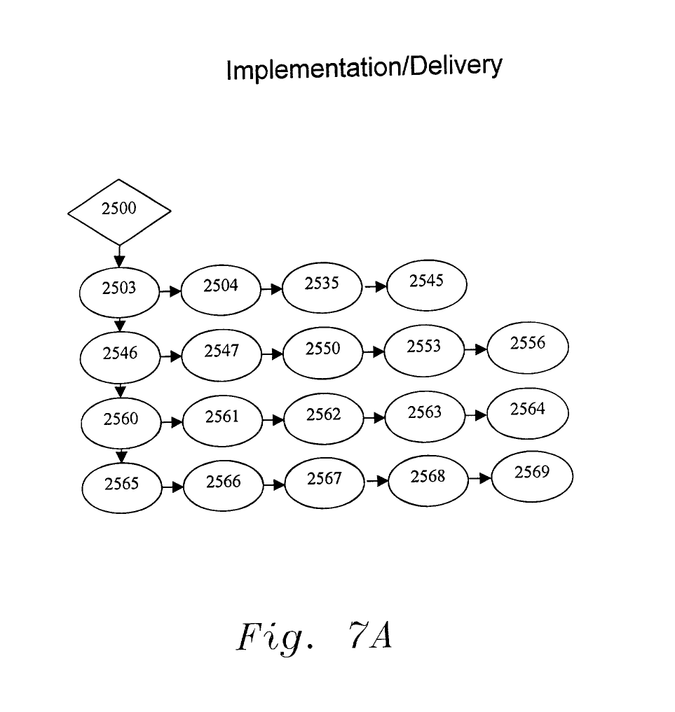

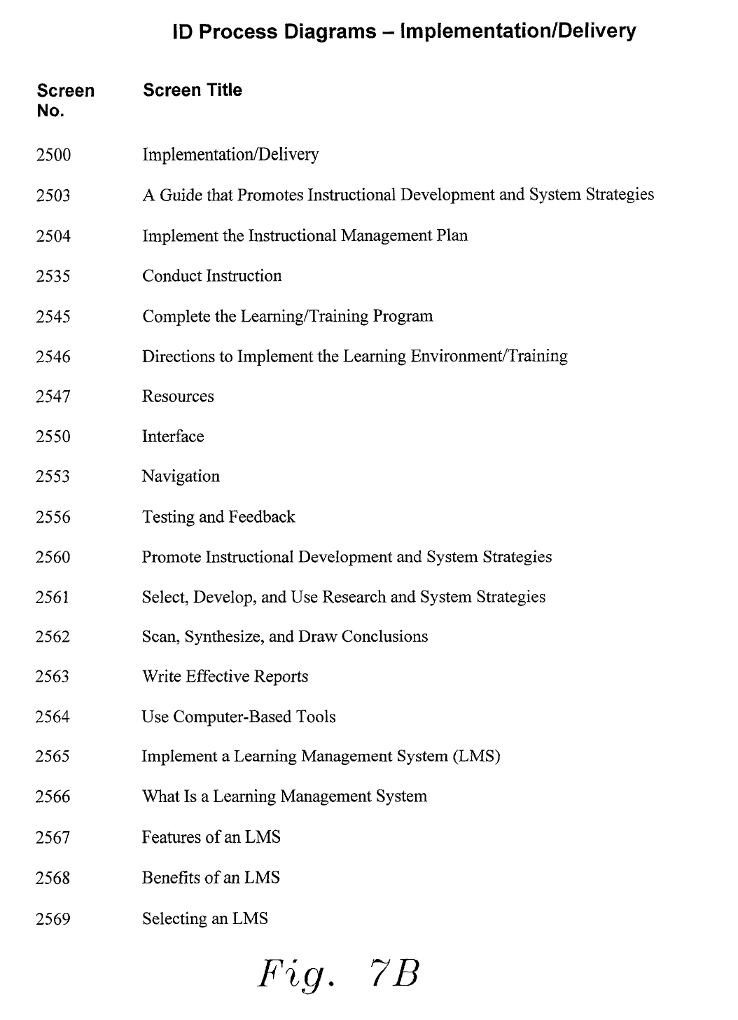

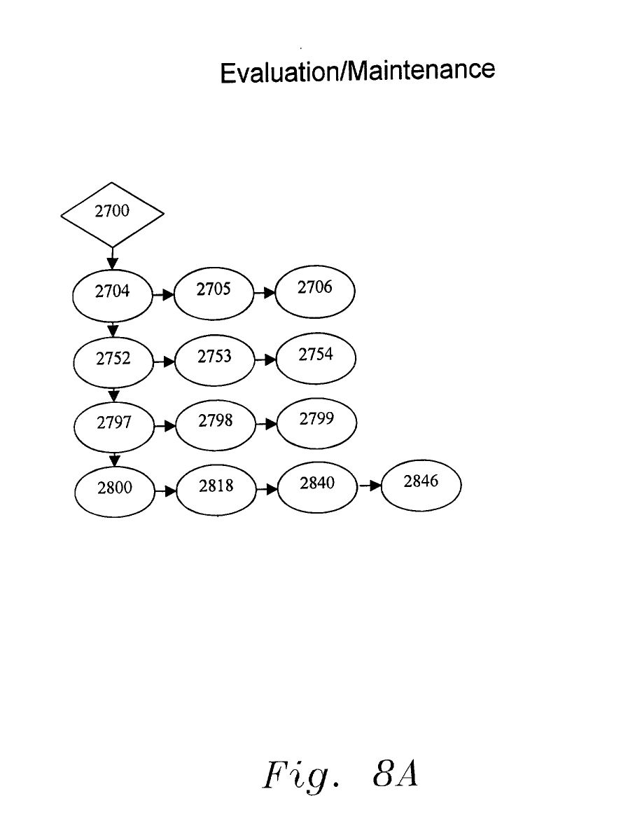

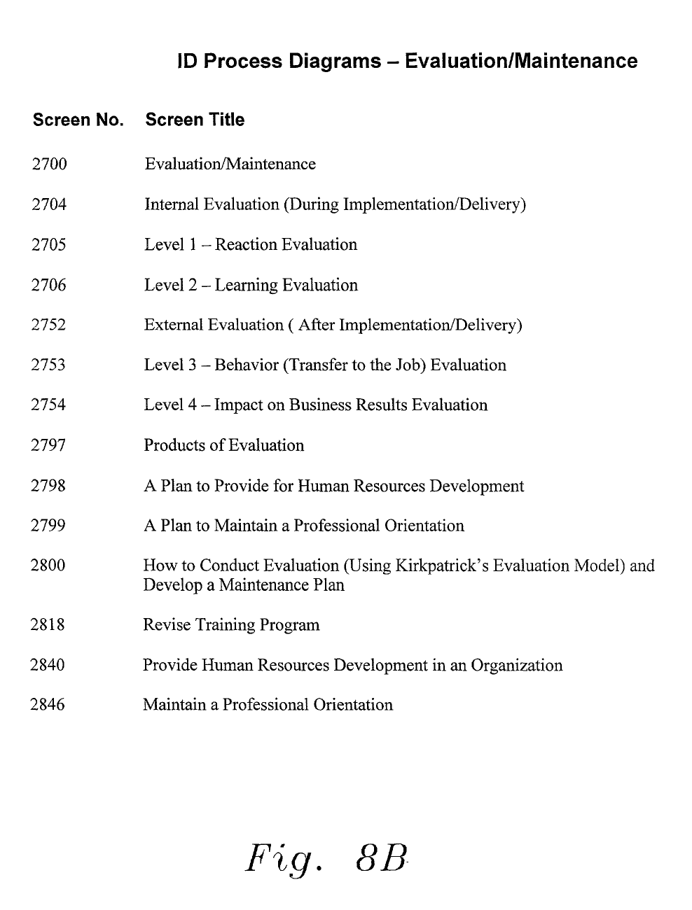

FIG. 4A is a diagram which indicates the major phases in the instructional design process according to the guidelines 40. The phases include, in sequence, an analysis phase, a design phase, a development phase, an implementation/delivery phase, and an evaluation/maintenance phase. As shown in FIGS. 13C and 13D, each of these major sections of the guidelines may be accessed through the bulleted links at the top of the guidelines screens. FIGS. 4B, 4C and 4D; 5A, 5B and 5C; 6A, 6B, and 6C; 7A and 7B; and 8A and 8B show the flow of information screens through the guidelines for the analysis, design, development, implementation/delivery and evaluation/maintenance phases, respectively. As the guidelines 40 generally follow the same order as the templates 42, the subject matter of the guidelines 40 will not be discussed separately, but will be understood to correspond to information concerning the respective templates 42 as follows. As shown in FIG. 13N, the guidelines also include links to the templates 42, as well as information and examples on how to use the templates 42.

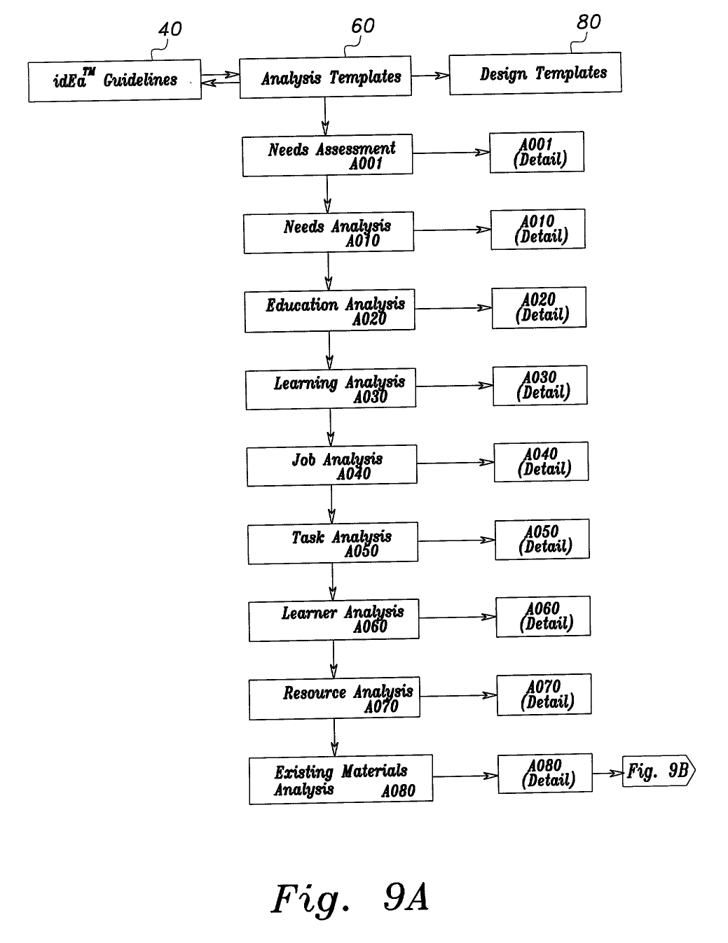

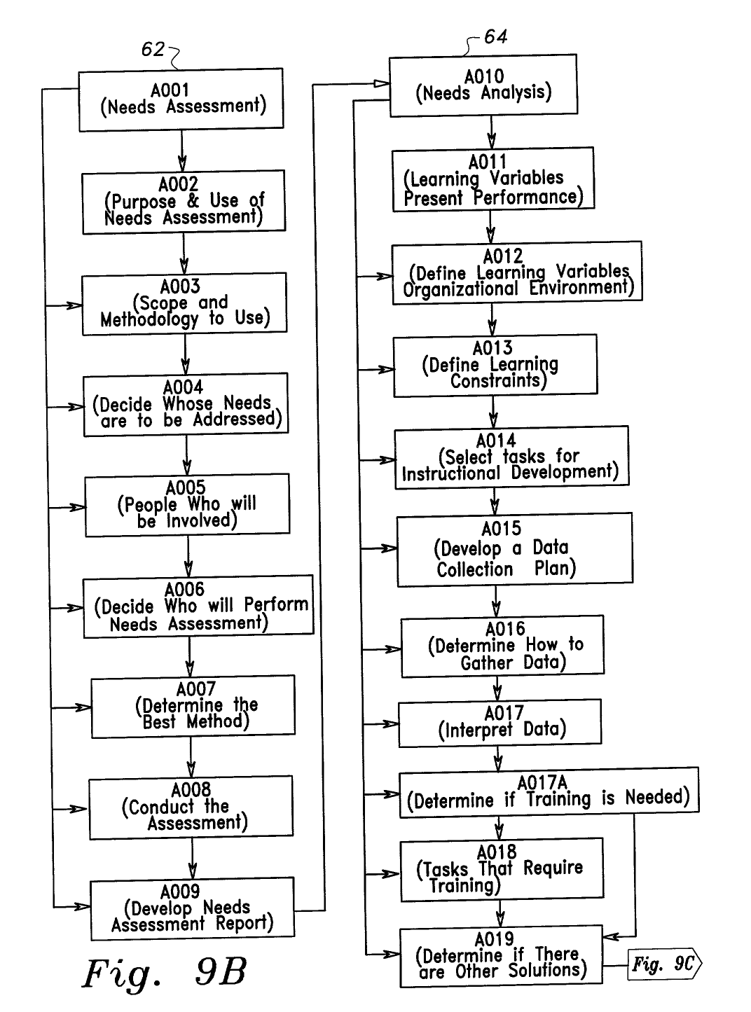

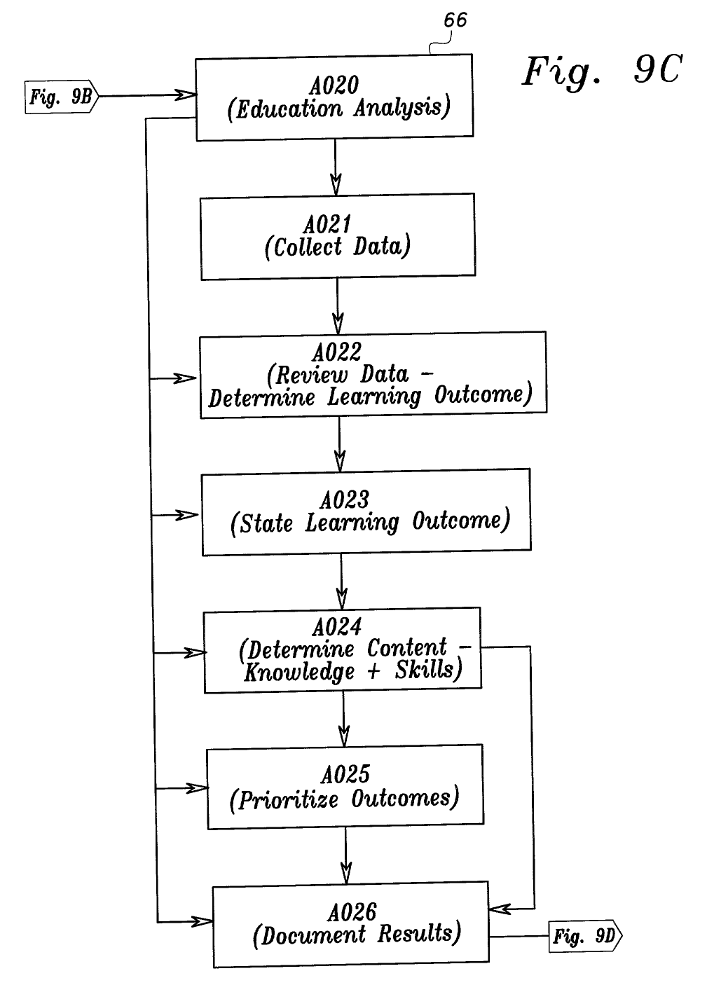

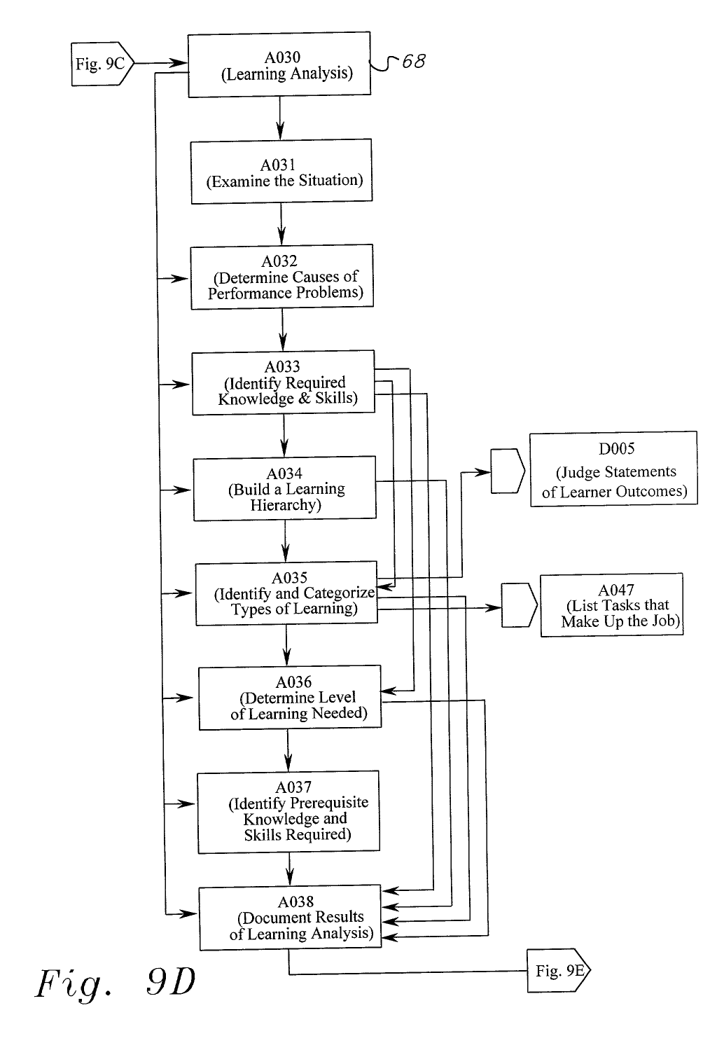

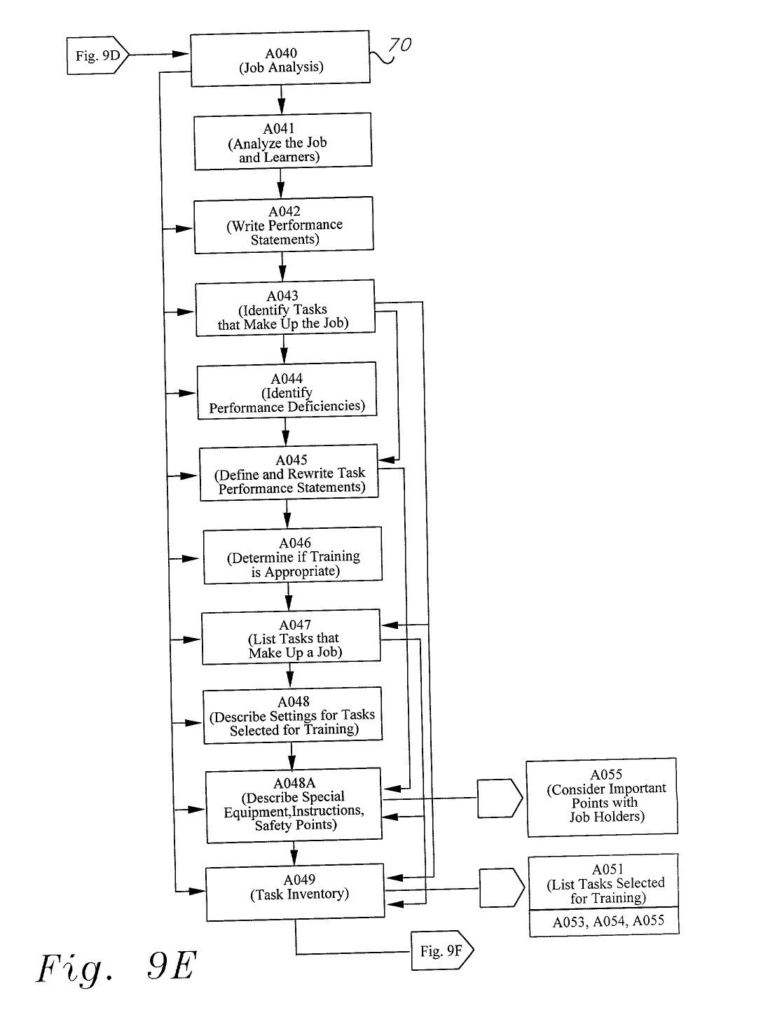

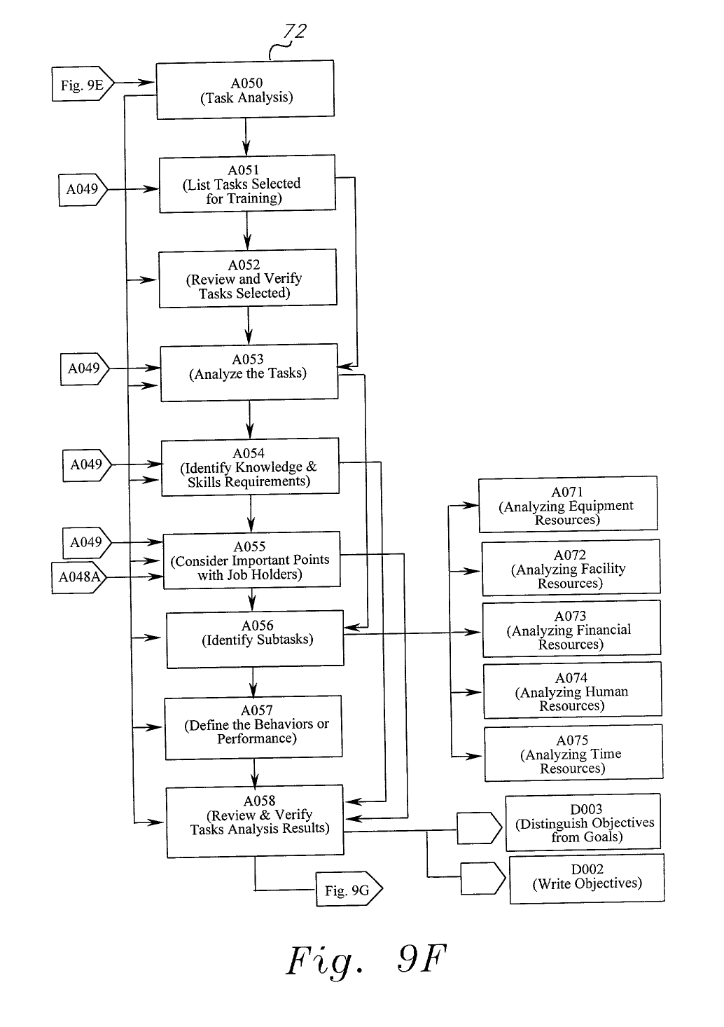

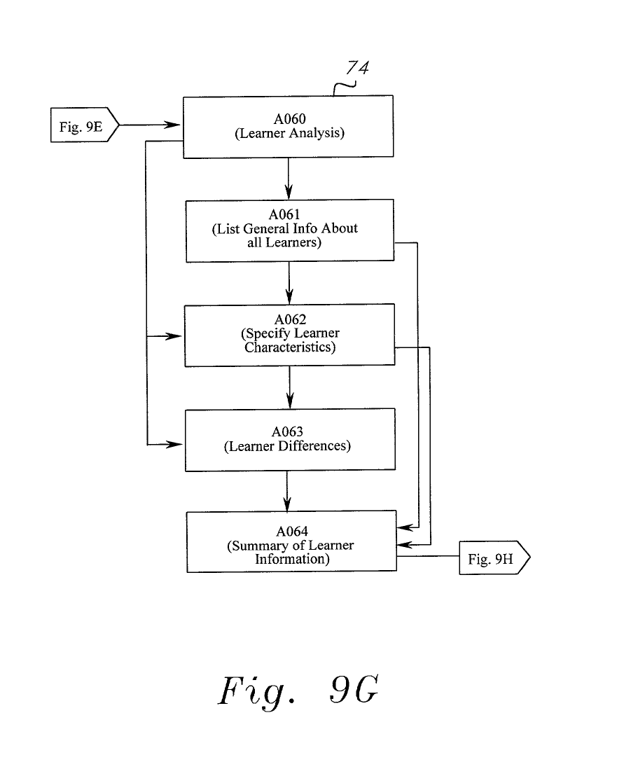

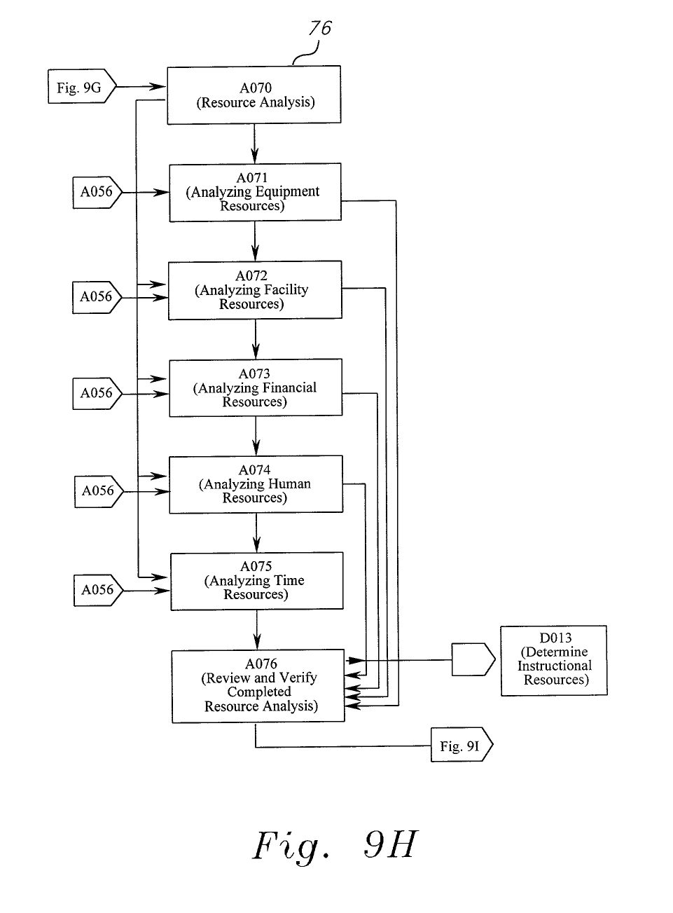

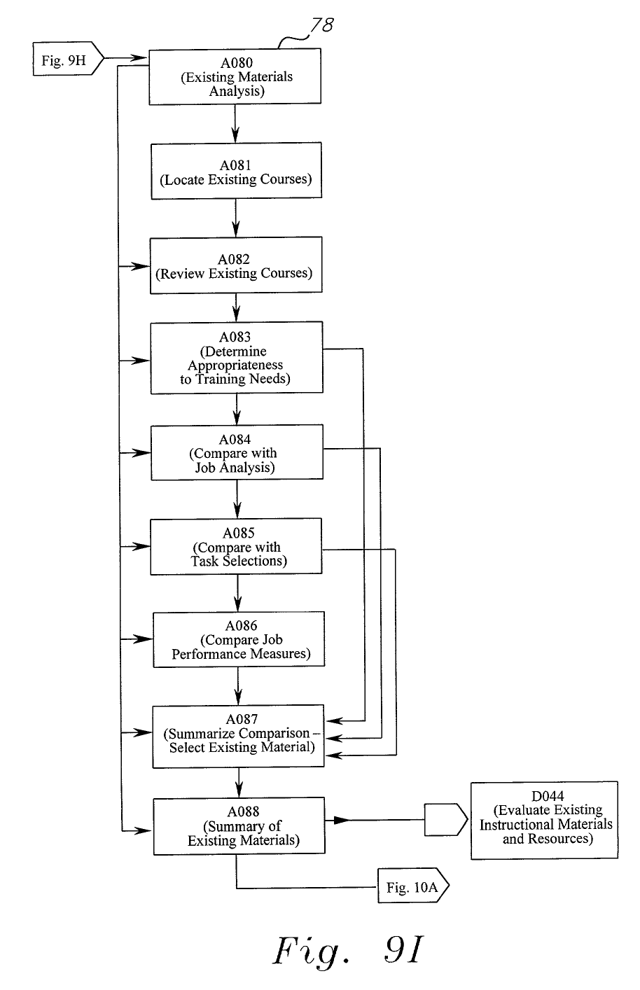

FIGS. 9A, 9B, 9C, 9D, 9E, 9F, 9G, 9H and 9I combine to form a flow chart of the analysis phase of the idEa templates 42. The analysis templates 60, in their aggregate, combine to perform a complete front end analysis. The analysis templates comprise nine different categories as follows: (1) Needs Assessment 62, with specific templates designated A001 through A009 in column 1 of FIG. 9B; (2) Needs Analysis 64, with specific templates designated A010 through A019 in column 2 of FIG. 9B; (3) Education Analysis 66, with specific templates designated A020 through A026 in FIG. 9C; (4) Learning Analysis 68, with specific templates designated A030 through A038 in FIG. 9D; (5) Job Analysis 70, with specific templates designated A040 through A049 in FIG. 9E; (6) Task Analysis 72, with specific templates designated A050 through A058 in FIG. 9F; (7) Learner Analysis 74, with specific templates designated A060 through A064 in FIG. 9G; (8) Resource Analysis 76, with specific templates designated A070 through A076 in FIG. 9H; and (9) Existing Materials Analysis 78, with specific templates designated A080 through A088 in FIG. 9I.

As shown in FIG. 14A, the user interface includes a menu of radio buttons for selecting the desired category. For example, selecting Needs Assessment 62 and clicking the Next button leads to the screen in FIG. 14B, which is a list of subtasks useful for Needs Assessment. Clicking on the radio button for the subtask “Decide on the scope of needs assessment and methodology” and clicking the Next button leads the user to the screen shown in FIGS. 14C and 14D, which contains a template form using a variety of devices for soliciting information from the user, e.g., radio buttons, check boxes, text windows, etc. Each template form is an object, and each subtask is an object. The user's responses are saved as serialized objects in Java or as HTML pages when the user exits the template section, using the standard pull down menu bars at the top of each screen. In the same manner, users may open a saved file for further editing either from a file system or from the Web using version control technology such as Webdav explorer.

The output is recommendations as objects, resulting from information that users input into the analysis templates 60, and carry forward from one template to another, and, as appropriate into the design templates. If users have not completed any analysis activities in the analysis phase, they can begin with the design phase. If the user has completed the analysis templates, the output recommendations will be carried down to the appropriate design templates. Users can edit, modify, add and delete information in the design templates as appropriate.

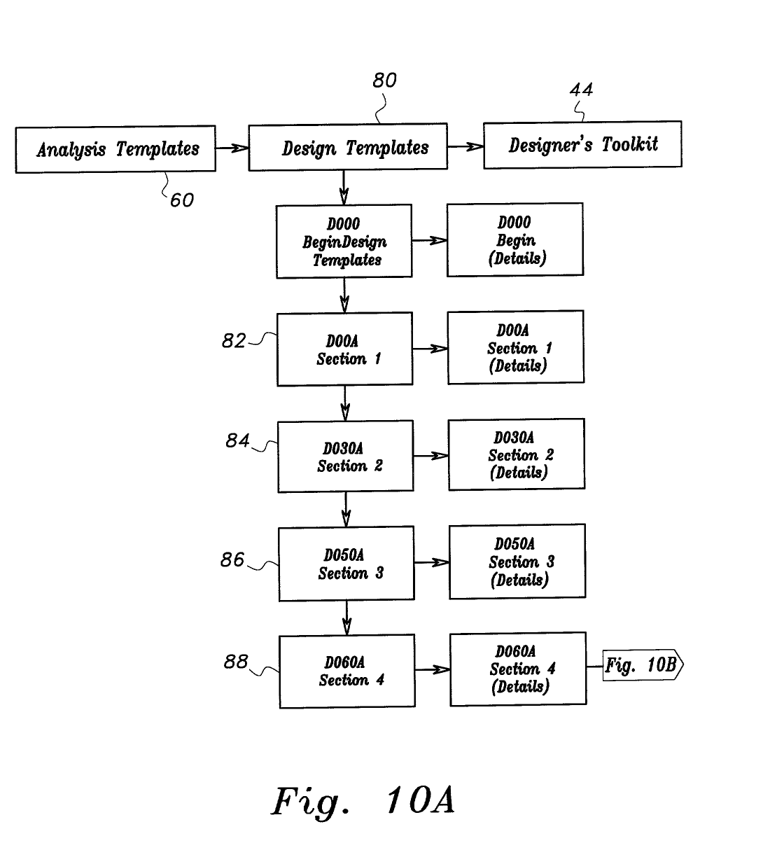

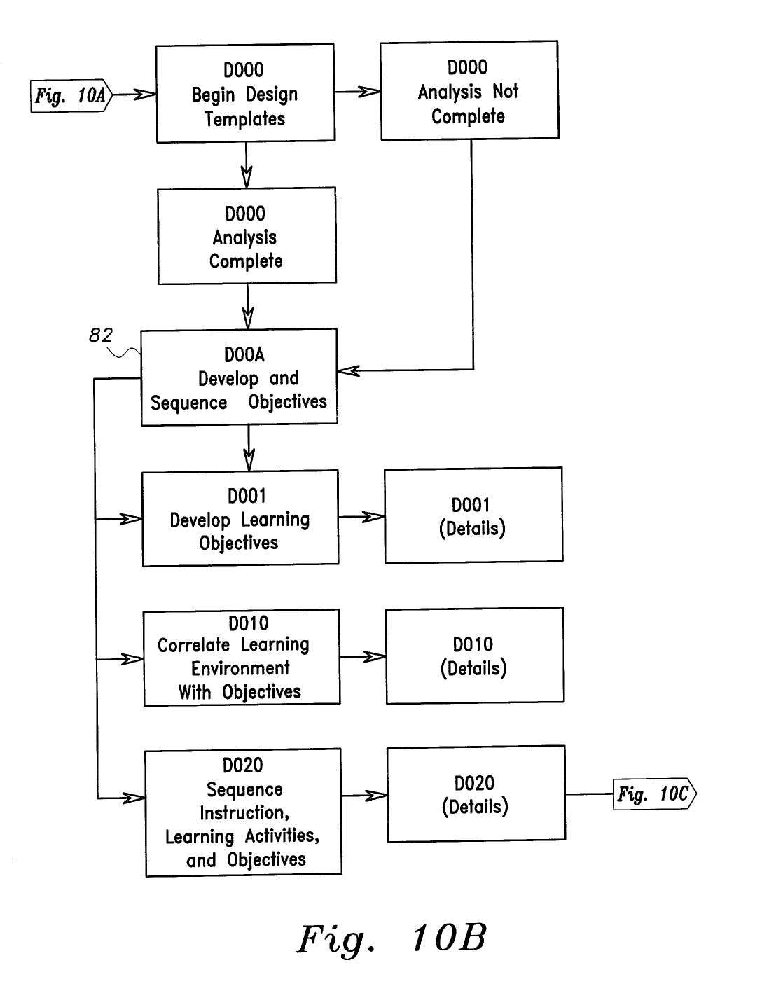

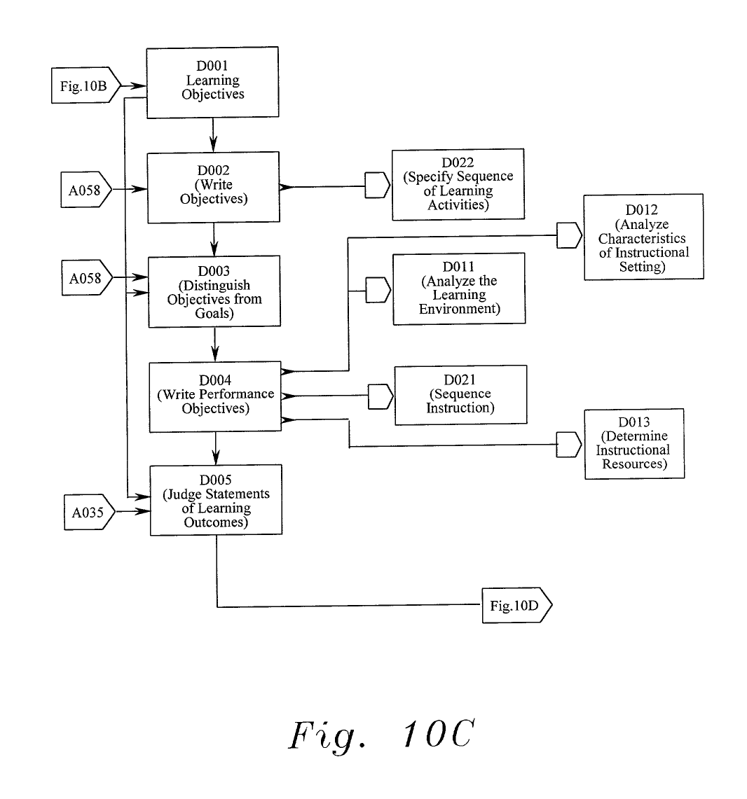

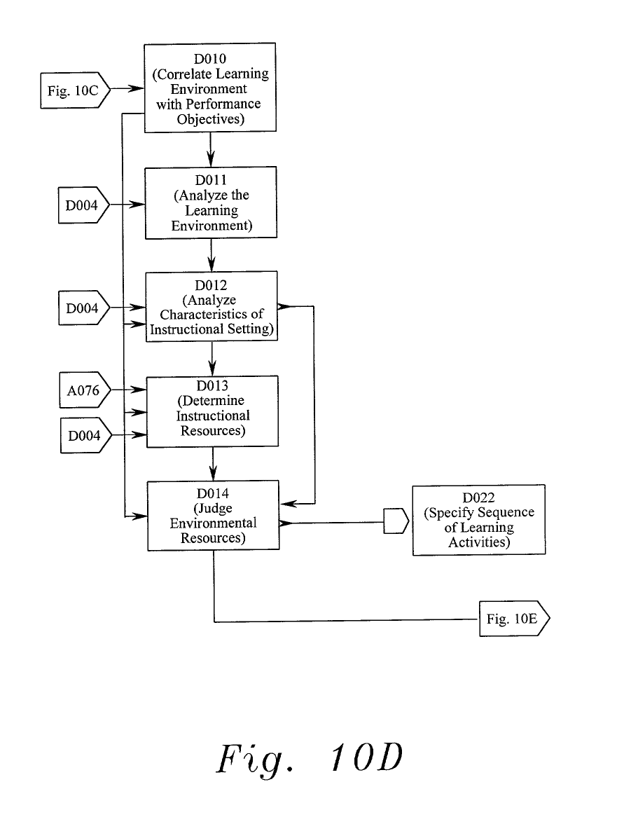

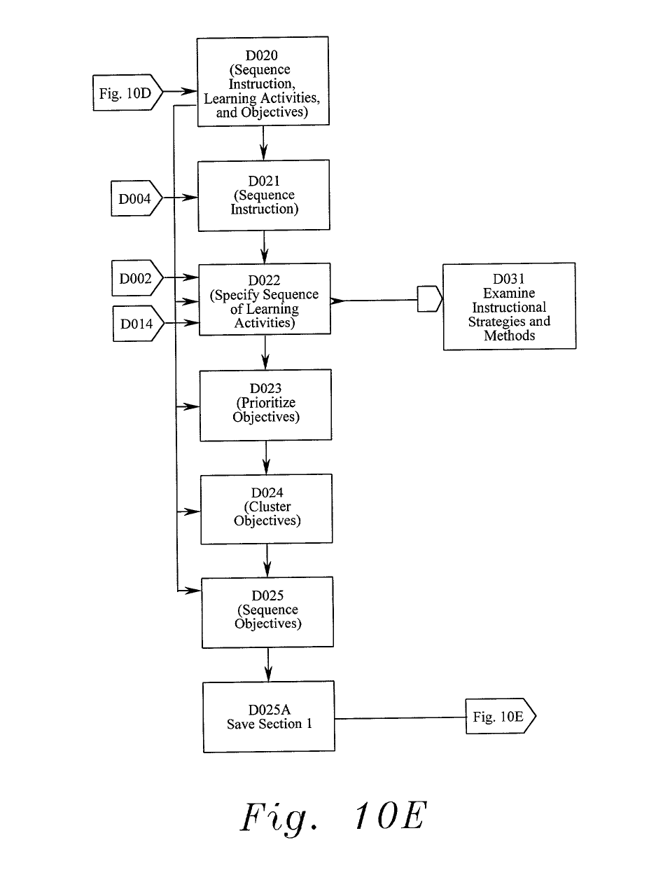

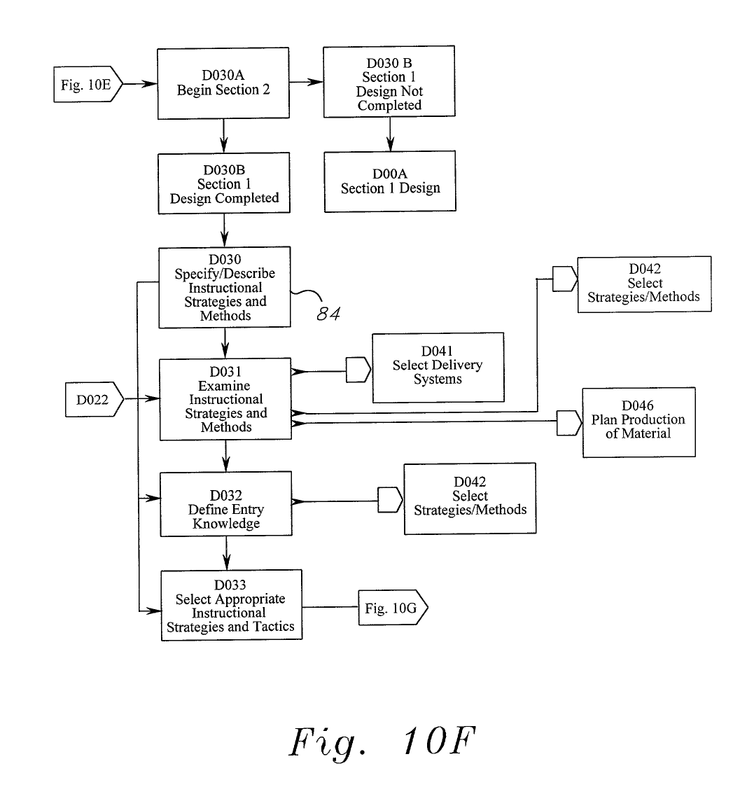

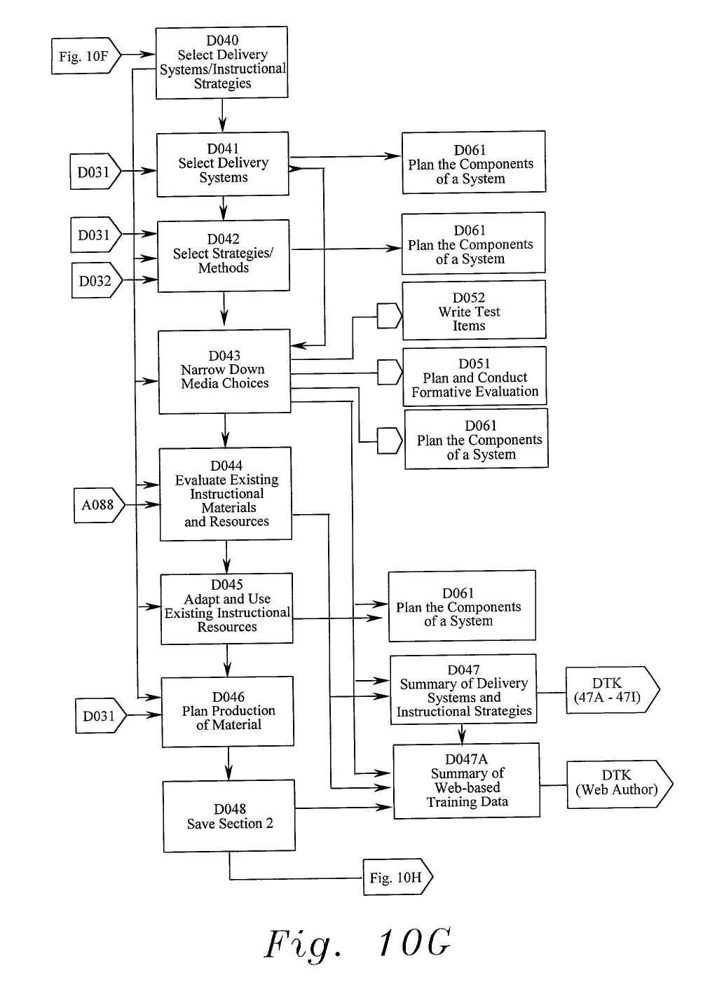

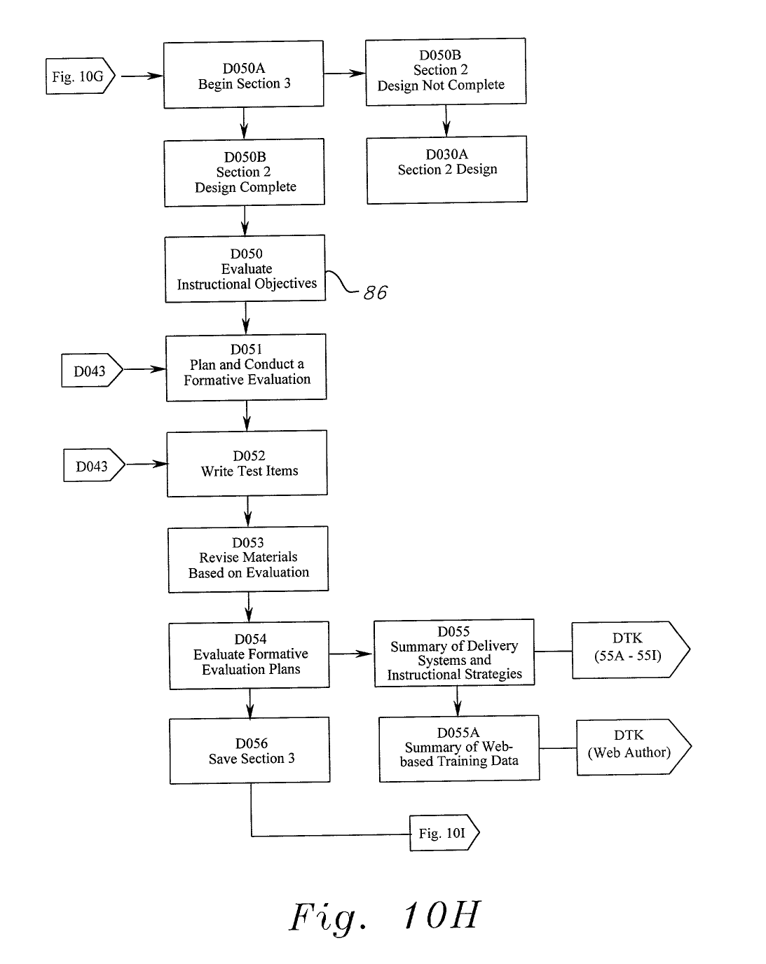

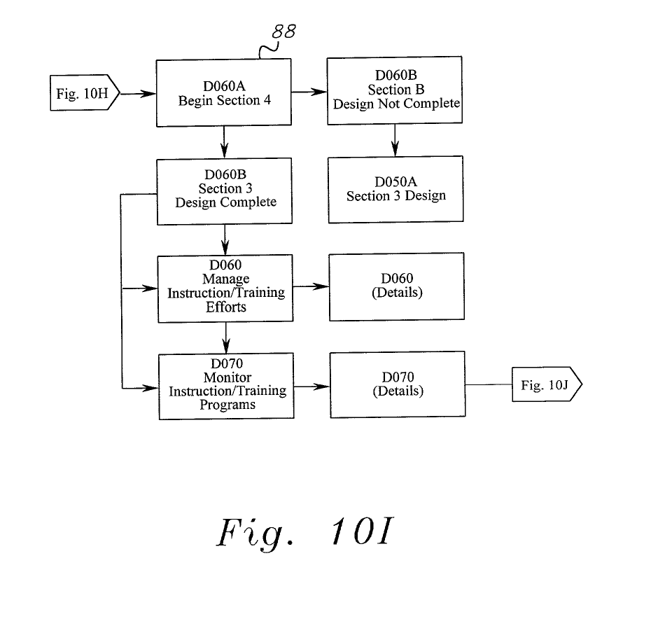

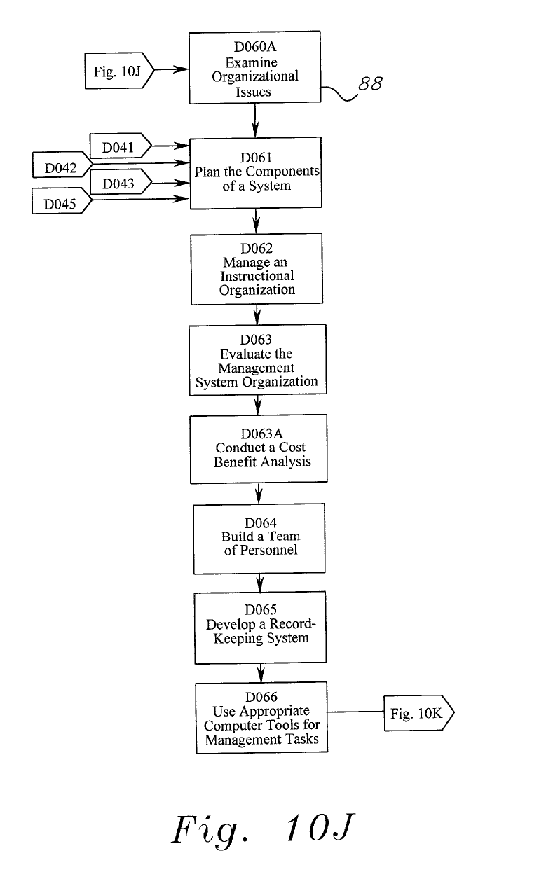

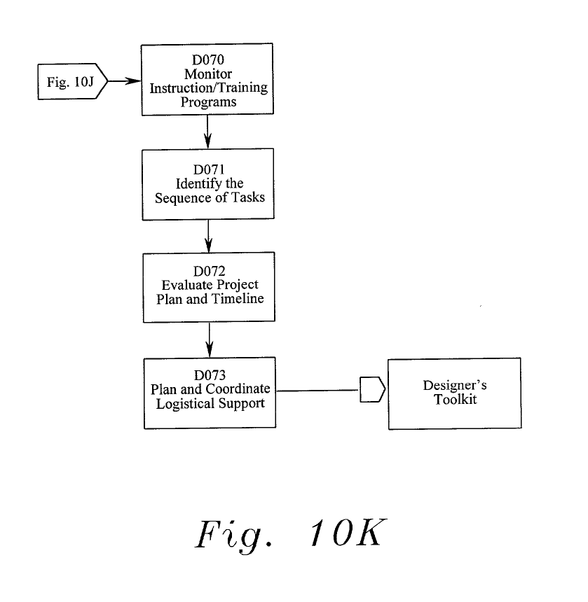

FIGS. 10A, 10B, 10C, 10D, 10E, 10F, 10G, 10H, 10I, 10J, and 10K combine to form a flow chart of the design phase of the idEa templates 42. The design templates 80, in their aggregate, combine to reflect a complete design process that is extensive and inclusive of most (if not all) existing delivery platforms/systems as well as instructional strategies and methods. There are four main sections in the design templates 80: (1) Develop and Sequence Objectives 82, comprising a number of templates, as shown in FIGS. 10B, 10C, 10D, and 10E; (2) Specify Instructional Strategies and Methods 84, comprising a number of templates, as shown in FIGS. 10F and 10G; (3) Evaluate Instructional Objectives 86, comprising a number of templates, as shown in FIG. 10H; and (4) Examine Organizational Issues 88, comprising a number of templates, as shown in FIGS. 10I, 10J and 10K. The user interface offering the user the opportunity to select the desired section for editing is shown in FIG. 15A. If users have completed analysis templates 60, the information is carried over into the design templates 80. If users have not completed analysis templates 60, users may still start with the design templates 80, supplying whatever missing information that would have been gathered in the analysis templates 60 and compiled, weighted, calculated, filtered and sorted by processor 52. An entry screen for selecting the appropriate option is shown in FIG. 15B. Like the analysis templates, in the design templates the user is presented with a series of screens which progressively narrow the scope of the task (FIGS. 15C-15D) until presented with a template form (FIGS. 15E-15F) for user input. Help is available at each step (e.g., FIG. 15G), and the user is prompted to save the information input before proceeding with the next section of the design templates (FIGS. 15H-15I) Input provided in the design templates 80 is compiled, weighted, calculated, filtered and sorted throughout the process and distributed appropriately within the design templates 80. The results of the design templates 80 are carried over as input into the designer's toolkit 44.

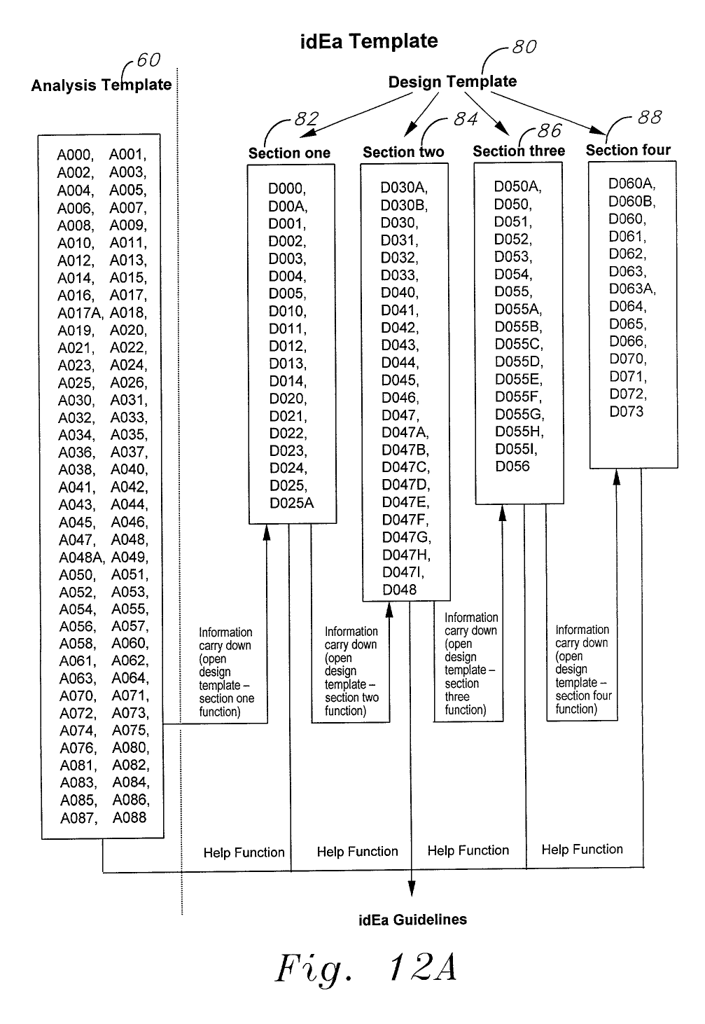

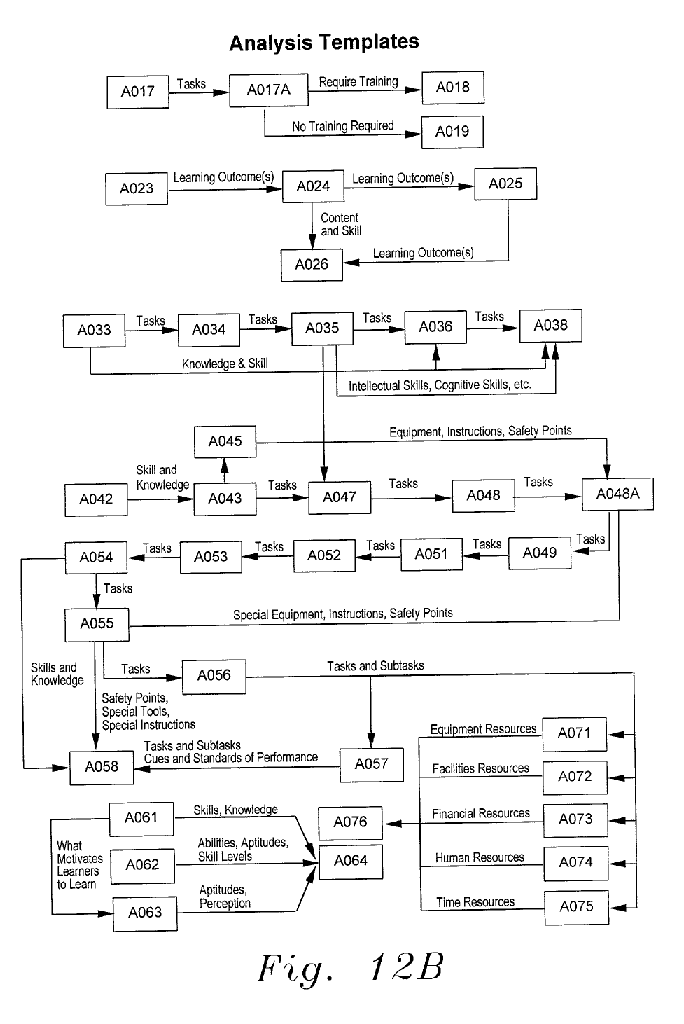

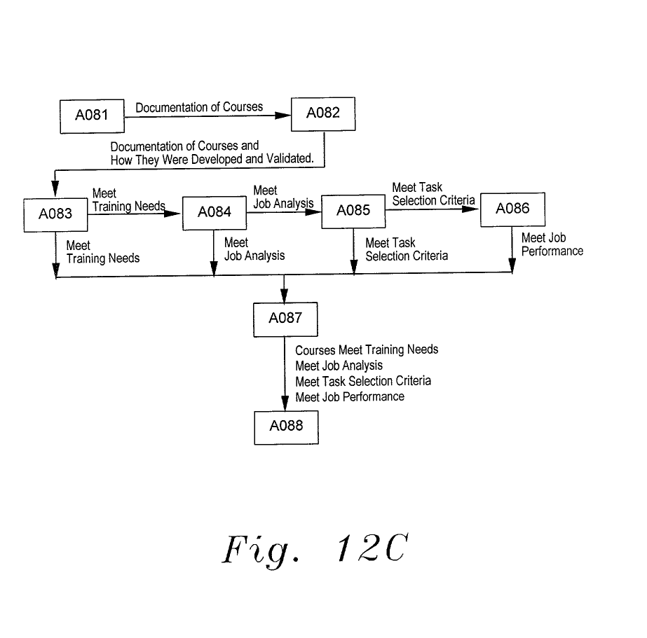

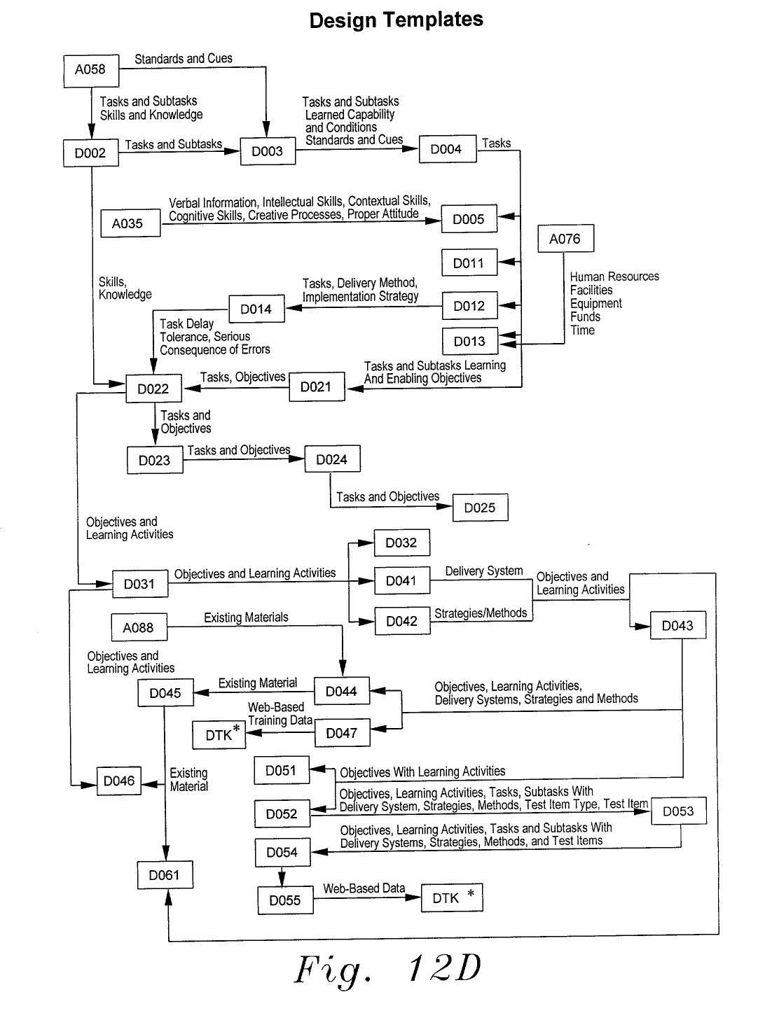

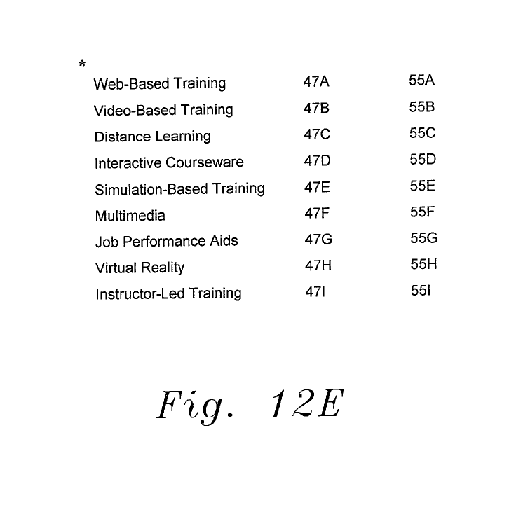

FIGS. 12A-12E further show the detailed interrelationship between the analysis and design templates.

As shown in FIG. 11, the output of the design templates 80 serves as input data for an appropriate designer's toolkit 44, e.g., the Web Author. The automated job training and performance tool of the present invention is capable of producing different types of training materials with appropriate programming in a user selected designer toolkit 44. These different types might include Web-based training, video-based training, traditional distance learning, interactive courseware, simulation-based training, multimedia job performance aids, virtual reality, and instructor-led training.

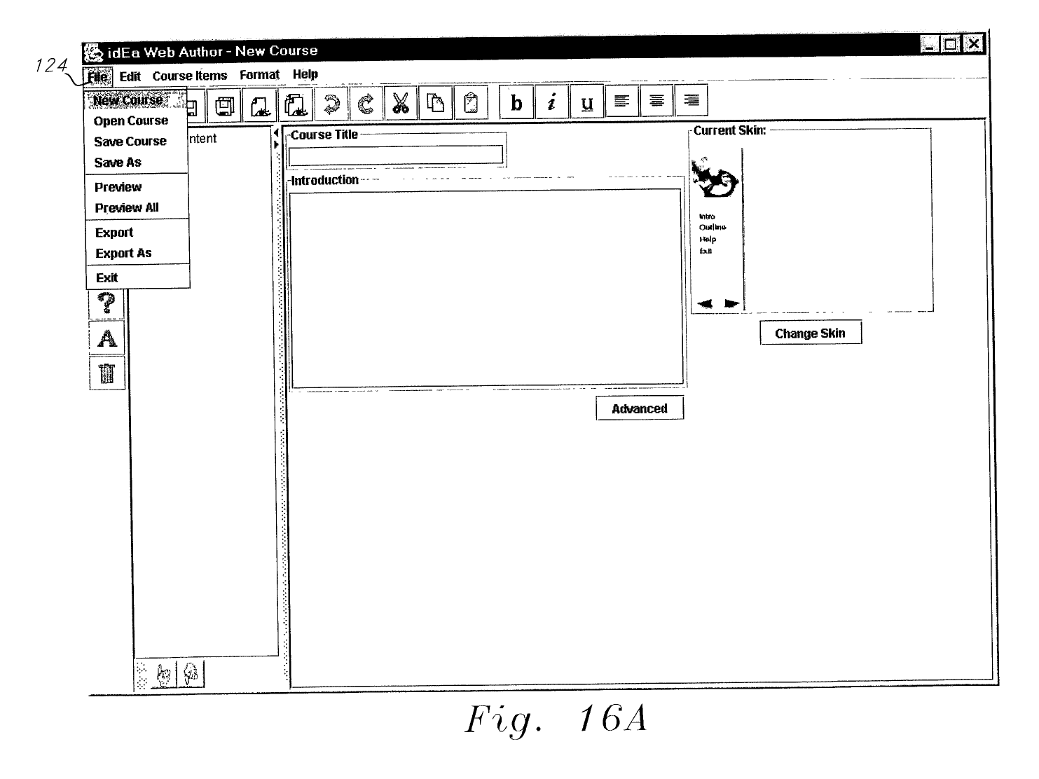

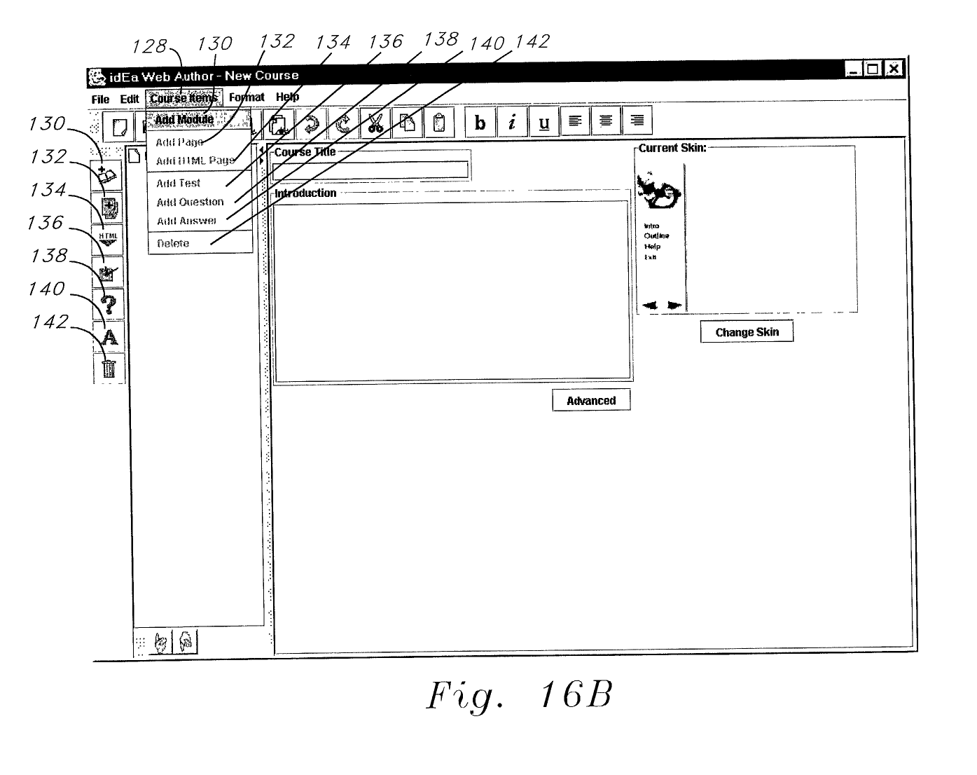

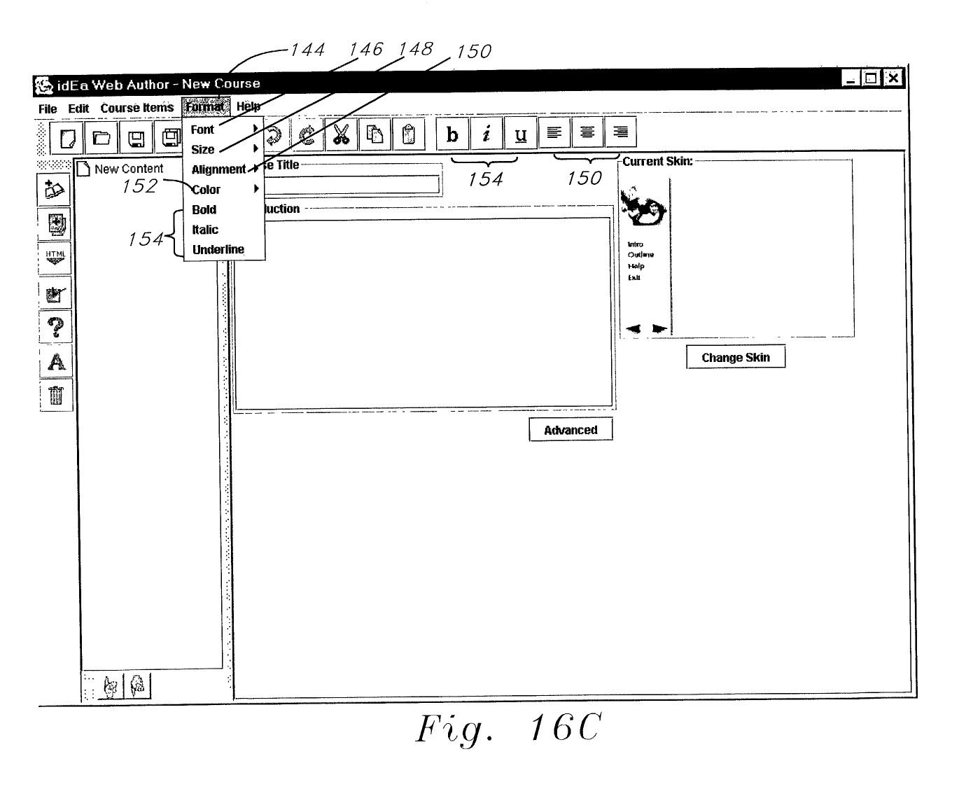

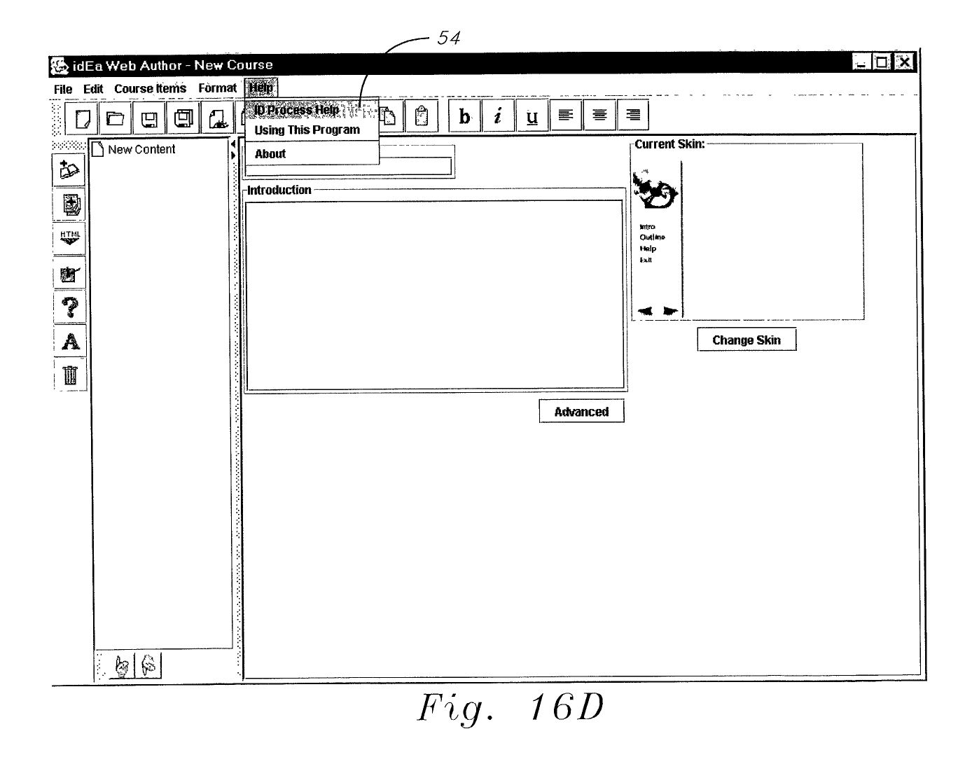

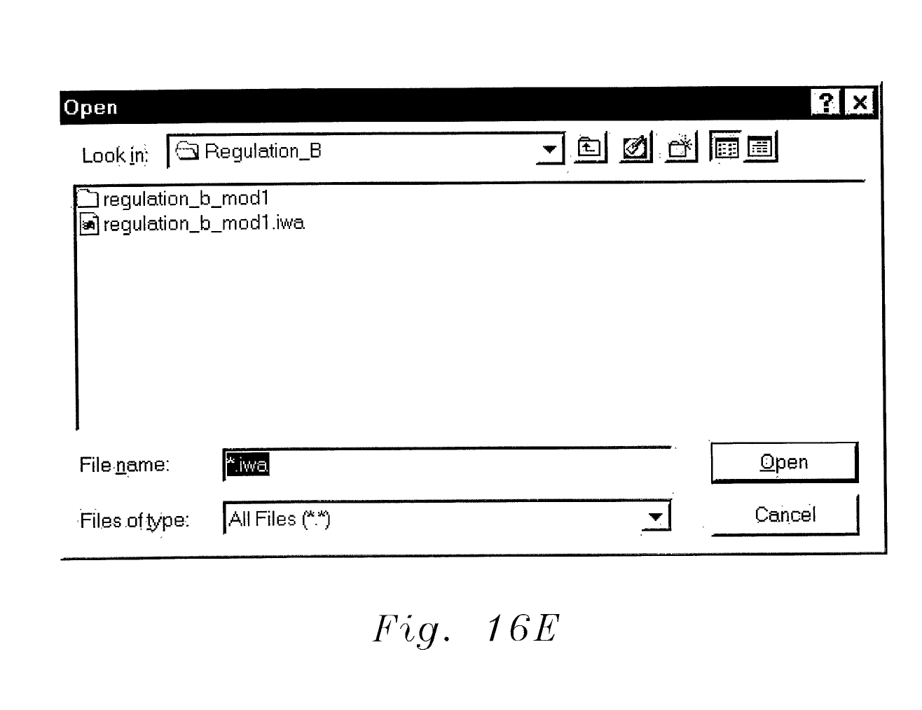

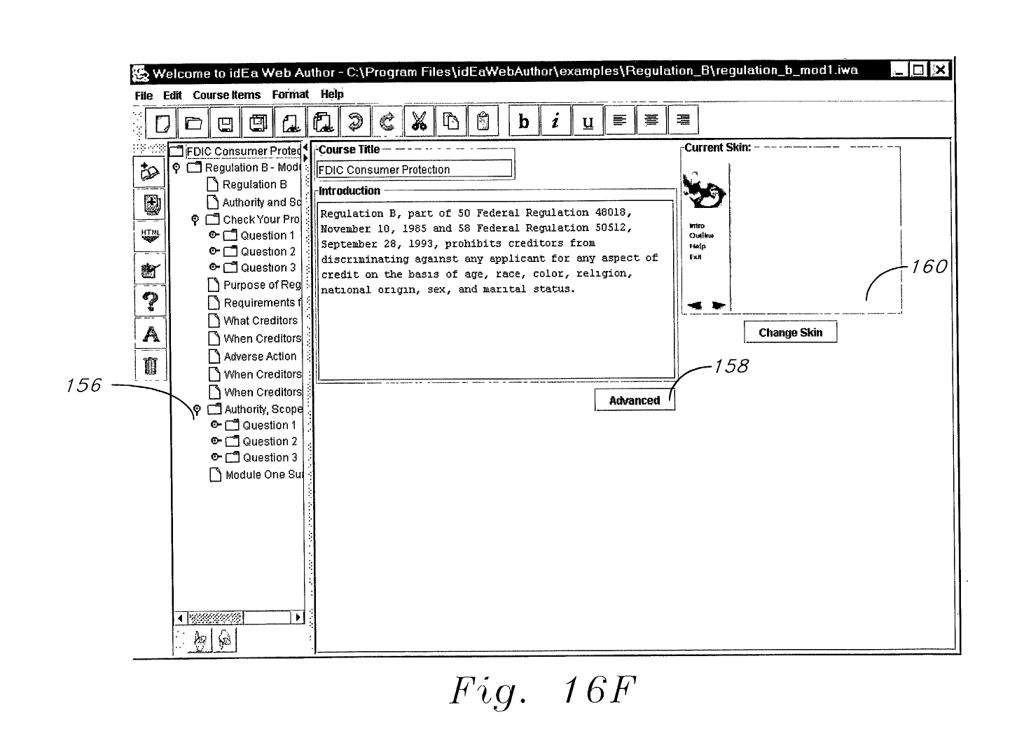

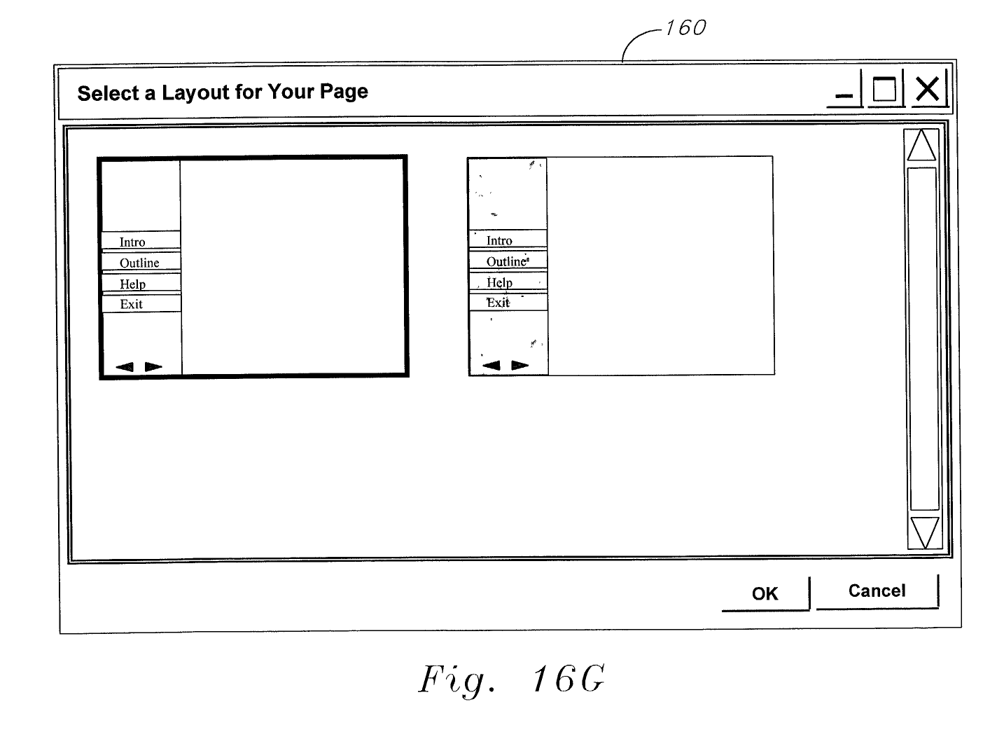

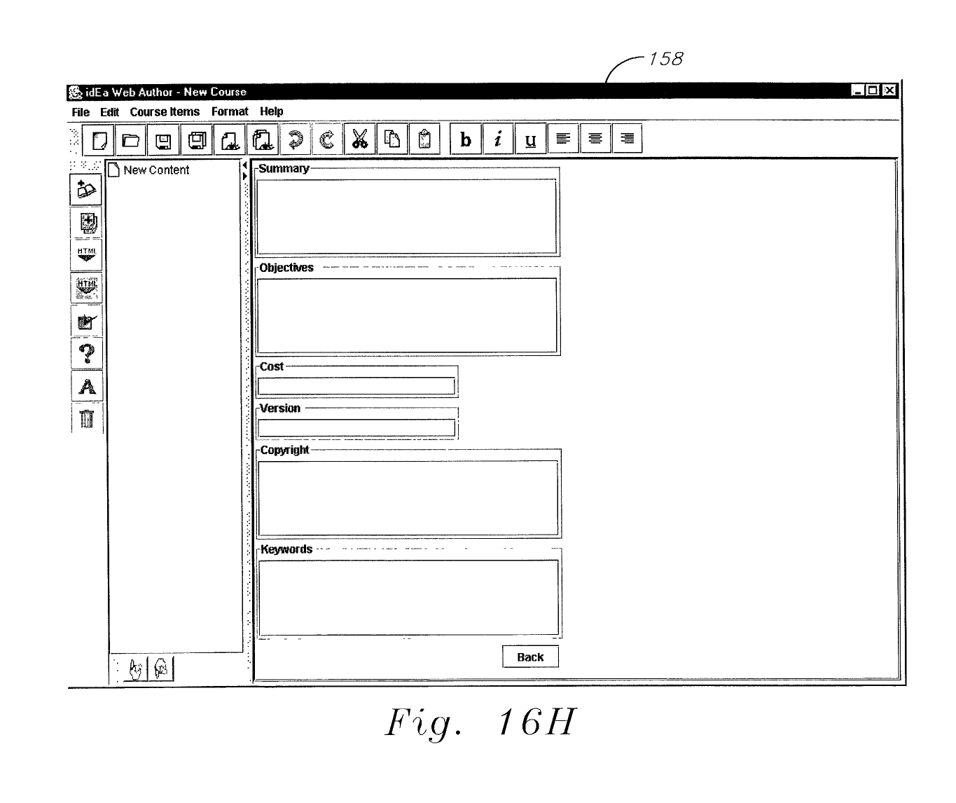

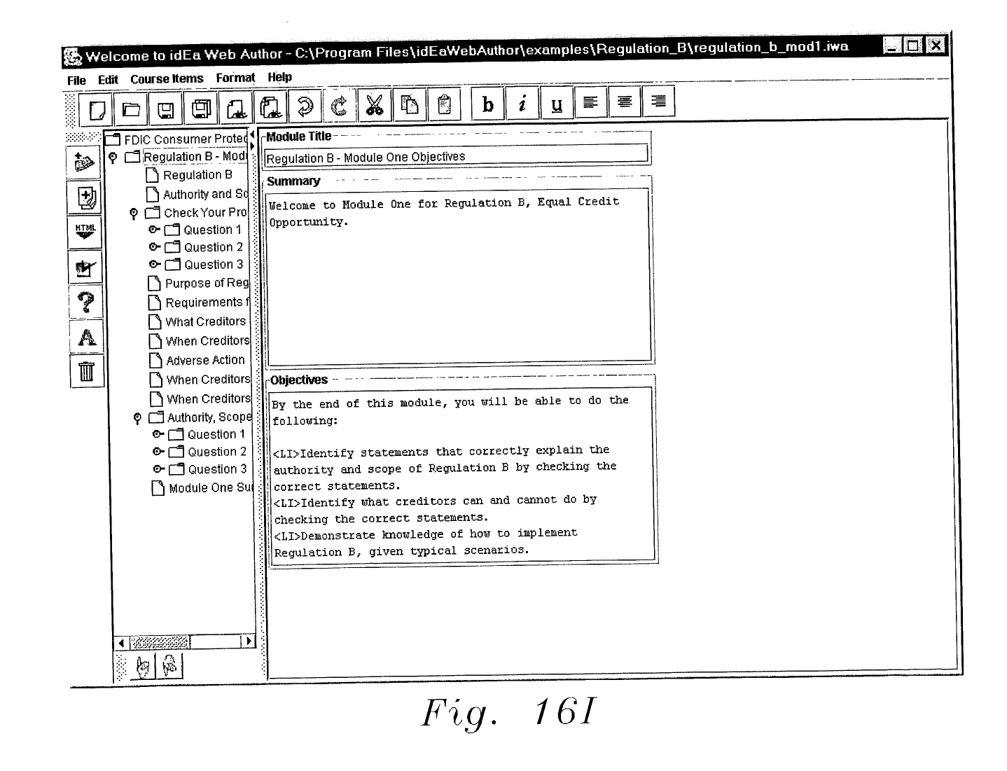

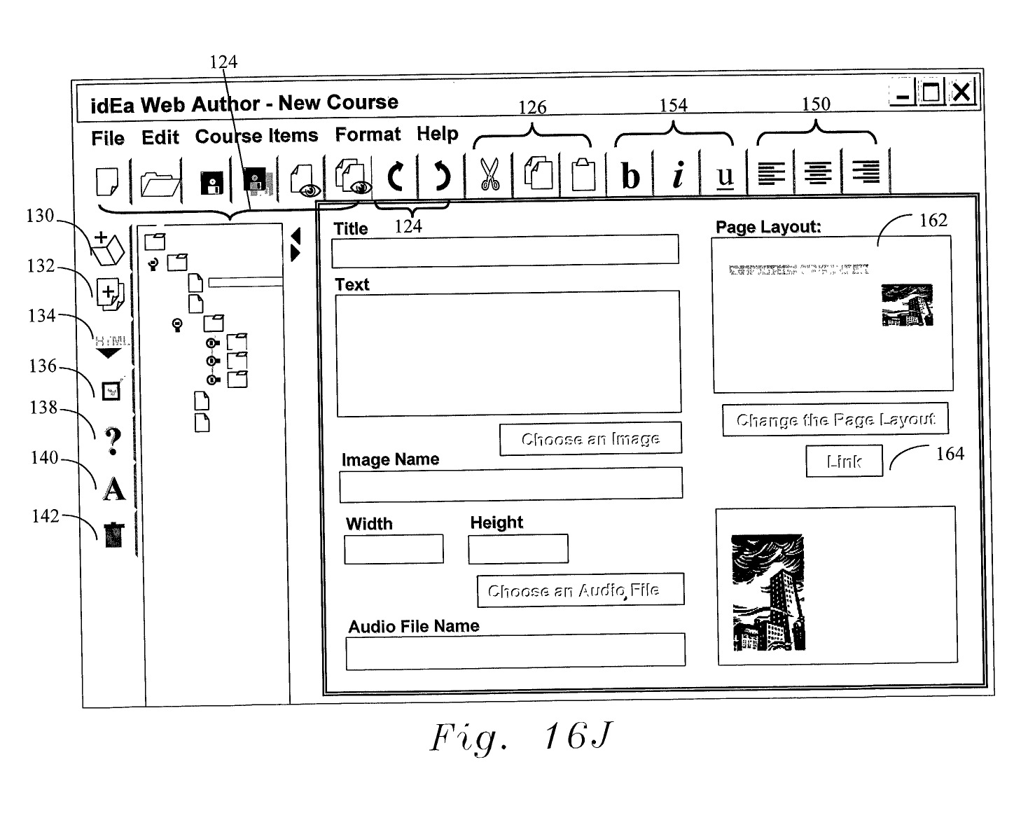

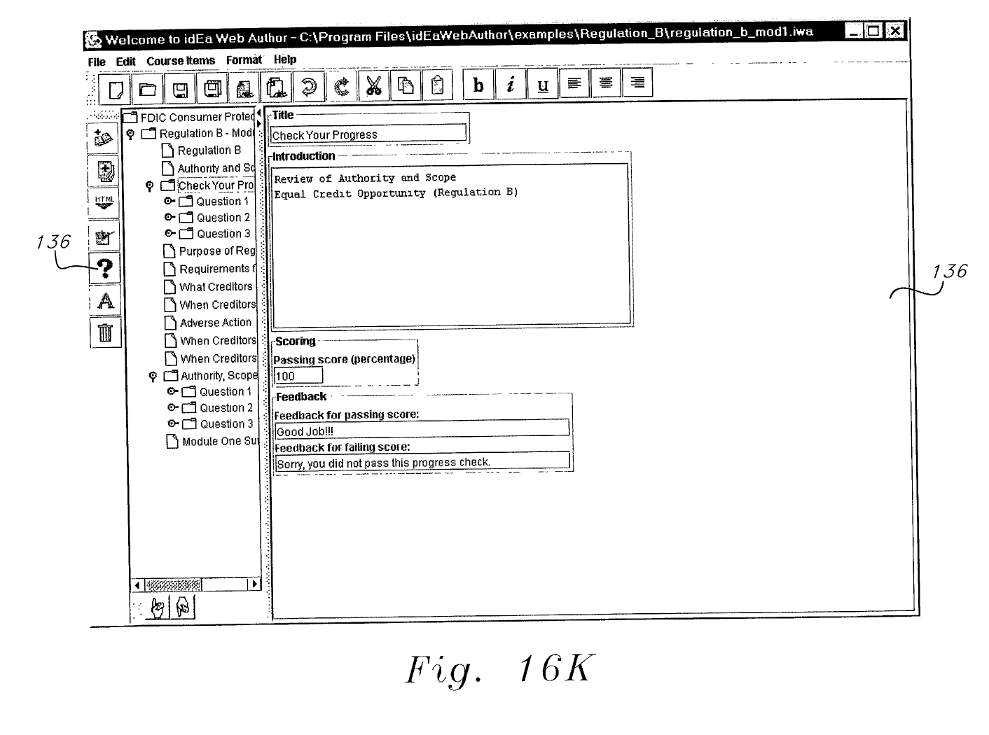

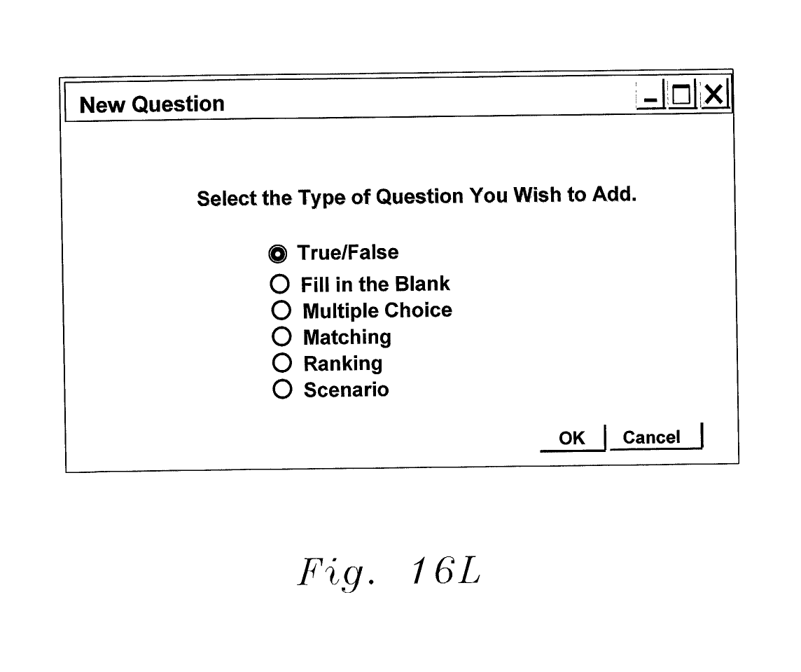

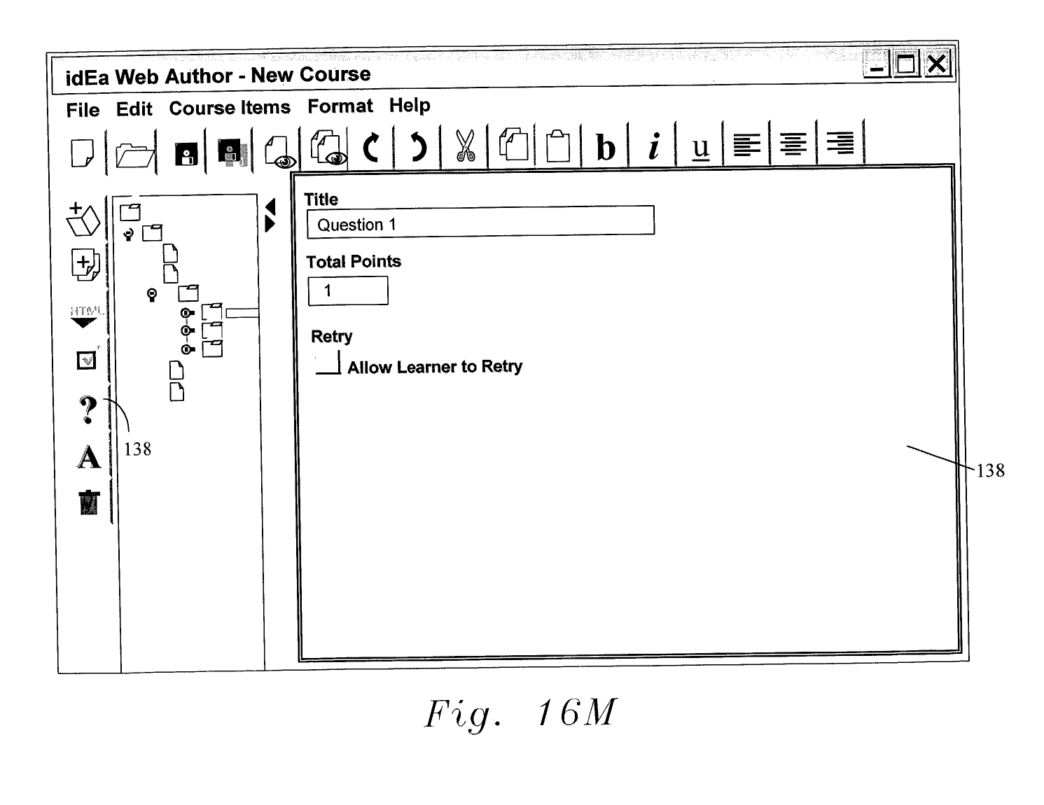

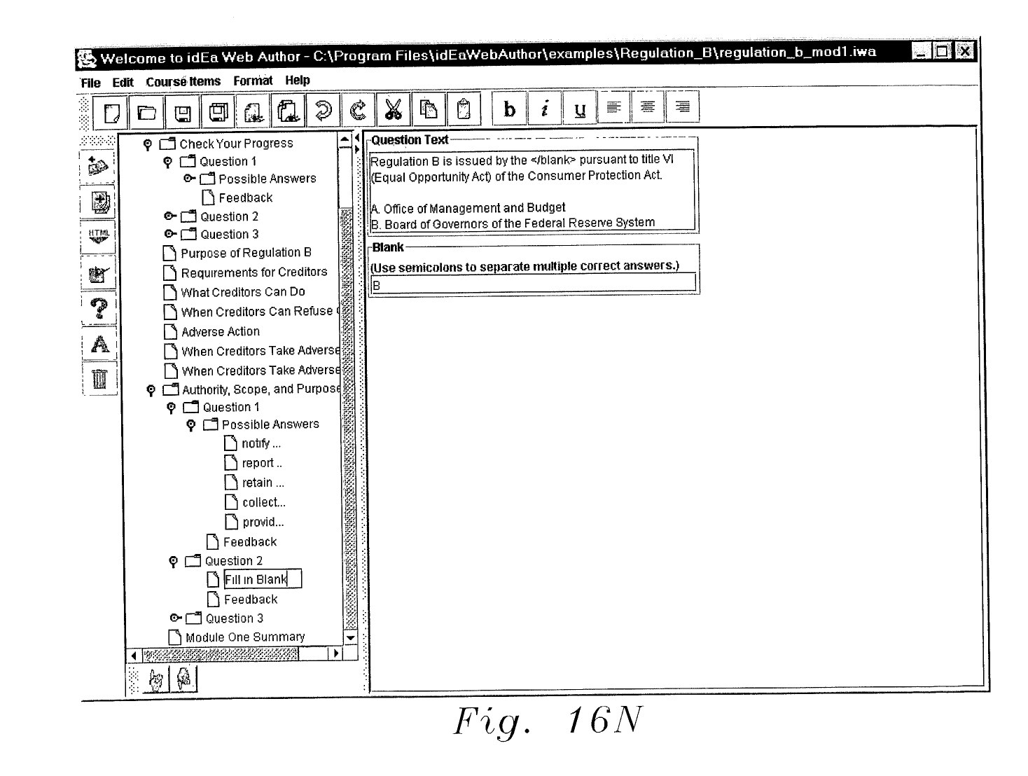

The Web Author application of the present invention is best described with reference to the screen shots or user interface shown in FIGS. 16A-16N. While the guidelines application and the designer/developer application are Java based applications, the Web Author application is also Java-based and XML driven. The Web Author can be used as a stand alone application, but is preferably used in conjunction with the guidelines and designer/developer templates.

Courses developed by Web Author are AICC compliant, IMS compliant, and SCORM conformant. The Aviation Industry CBT Committee (AICC) is an international association of technology-based training professionals that develops training guidelines for the aviation industry. Most technology-based courses used by organizations in the private and public sector are required to be AICC compliant. The Instructional Management Systems (IMS) is a set of technical specifications defining how learning materials will be exchanged over the Internet and how organizations and individual learners will use these materials. The goal of these specifications, initiated by Educom and developed through a partnership of academic, commercial and government organizations, is the adoption of a set of open standards for Internet-based education. The Sharable Courseware Object Reference Model (SCORM) is a set of standards that, when applied to course content, produces small, reusable learning objects. A result of the Department of Defense Advanced Distributed Learning (ADL) initiative, SCORM-conformant courseware elements can be easily merged with other compliant and conformant elements to produce a highly modular repository of training materials.

Web Author is versatile with respect to the type of courses it can produce. It creates courses that use standard HTML and JavaScript, making them easy to use with the technology the organization already has, unlike products that require proprietary plug-ins. It can create courses that incorporate exciting multimedia elements. It can handle a wide range of file types including HTML, JPG, GIF, Windows Media Player ASF/WMV/MPG, Real Video/Audio, Flash, Shockwave, and AU/Wav Audio. It can also import material created using Microsoft PowerPoint. It can create tests and quizzes that reinforce learning and indicate whether learners have mastered course content. Learners' results on tests and quizzes can be transferred to any SCORM compatible learning management system (LMS), allowing an organization to keep track of everyone's learning progress. It automatically generates help files and course outlines.

FIGS. 16A-16D show Web Author's default screen, together with selected menu options that a user may select from pull down menus, including a File menu 124, Course Items menu 128, Format menu 144, and Help menu which includes a link to the guidelines application through ID Process Help 54. The Format menu 144 provides standard formatting options, including options for fonts 146, font size 148, alignment of text 150, color of text 152, and font style 154. Users can also use the corresponding icons in the toolbar on the top of the screen. The screen has two panels, including a tree structure panel to the left and a content panel to the right. When the user has completed the designer/developer templates, the user is given the option to export the plan for use in Web Author. The designer/developer file is saved as an XML file with an .iwa extension, so that the user may select Open Course from the File Menu 124, and is then presented with a screen similar to FIG. 16E. When the user opens the .iwa file, Web Author parses the XML file and displays the design plan as a course outline or tree structure 156, as shown in FIG. 16F. The tree structure contains two basic types of icons: folders and pages. Folders represent objects that contain other objects; pages represent objects that do not contain any other objects. Objects that initially appear as pages can become folders when other objects are created within them. If all the objects within a folder are deleted, it will become a page. The other properties of an object do not change when its icon changes from a page to a folder or vice versa. The different icons only indicate whether or not an object contains other objects. To the left of every folder except the folder representing the entire course, a switch appears. Switches always point either down or to the right. When a switch points down, the objects contained in its folder are visible. When a switch points to the right, the folder's contents are hidden. To change the position of a switch, the user clicks on it once. Double-clicking on a folder icon has the same effect as clicking once on a switch. Since the folder representing the entire course has no switch, it can only be opened by double-clicking. To select an object, the user clicks on its icon in the tree structure once. Once the user has selected an object, the user can enter information about it in the input area.

In the example shown in FIG. 16F, the text appearing in the text boxes labeled “Course Title” and “Introduction” in the content panel is information which has automatically been carried over from the designer/developer templates, and may be further edited by the user if desired. The content panel also contains an advanced feature button 158, and a display of the current skin 160 together with a “Change Skin” button. The skin 160 shows the external frame of the user interface in which the course will be displayed. When the “Change Skin” button is selected, a screen similar to that depicted in FIG. 16G appears, which allows the user to selected the desired skin by clicking on one of the selections displayed. When the advanced feature button 158 is selected, a screen similar to that shown in FIG. 16H appears, which permits the user to enter metadata in the text boxes in the content panel, including the course Summary, Objectives, Cost, Version number, Copyright information, and Keywords.

The user has the option to add modules by selecting the “Add Module” 130 item from the “Course Items” 128 pull down menu as seen in FIG. 16B, or by clicking the icon 130 from the toolbar on the left side of the screen. FIG. 16I shows a sample start of a module in Web Author, including such objects as the Module Title, Summary and module Objectives. FIG. 16J illustrates the options available to the user when creating a new module, including adding a Page Title, Text, choosing, naming, and sizing an Image, choosing and naming an Audio File, adding HTML links 164 and choosing Page Layout 162. The toolbar along the left side of the screen offers easy access to additional Course Items 128 selections through clickable icons for adding modules 130, pages 132, HTML pages 134, tests 136, questions 138, answers 140, and deleting 142 items. When the “Change the Page Layout” button is selected, the user is presented with a screen similar to FIG. 16G which allows the user to select the page layout from a group of layouts which feature text with a graphics file or a multimedia in a selected position on the screen, a text only layout, or a multimedia file only layout.

When the user wants to include a test to determine the learner's understanding of the material in the course module, the user selects menu item 136 from the Course Item 128 menu or toolbar, and is presented with the screen shown in FIG. 16K, which allows the user to enter a test Title, an Introduction with comments or instructions for the learner, a passing grade for Scoring, and Feedback comments in text boxes in the content panel. The user enters questions by selecting menu item 138, shown in FIG. 16J, which presents the user with the screen shown in FIG. 16L, which presents the user with the option to select the type of question. The user may then be presented with the screen in FIG. 16M for indicating a question Title, Total Points, and whether to permit a Retry, and with an appropriate screen for entry of the question and answer, such as the screen illustrated in FIG. 16N for a fill-in the-blank question, in which the instructor is presented with a Question text box for entry of the question and a Blank text box for entry of the answer(s) in the content panel.

When the new course option is selected from the File menu 124, this signifies that the user is employing Web Author as a stand alone application, and the tree structure is blank, except for the entry “New Content”, as shown, e.g., in FIG. 16D. The user then creates a new course from scratch, using the Course Item 128 menu selections to create new modules and pages as desired. During this process, the user may select ID Process Help 54 to access the process, the user may select ID Process Help 54 to access the guidelines application for help in structuring the course.

After editing the course materials, the user can save the file as an XML file with an .iwa file extension for further editing by selecting the “Save Course” or “Save As” items from the File menu 124 or toolbar, preview either the current page or module by selecting “Preview” or the entire course by selecting “Preview All”, or the user may create the course file by selecting “Export” or “Export All”. This causes the .iwa file to be compiled by the Java compiler to create an HTML course file, which may be saved to a designated location. The course may be put on the user's hard drive, saved to a CD, Zip disk, or other storage medium, put on a corporate intranet, or uploaded to a learning management system (LMS).

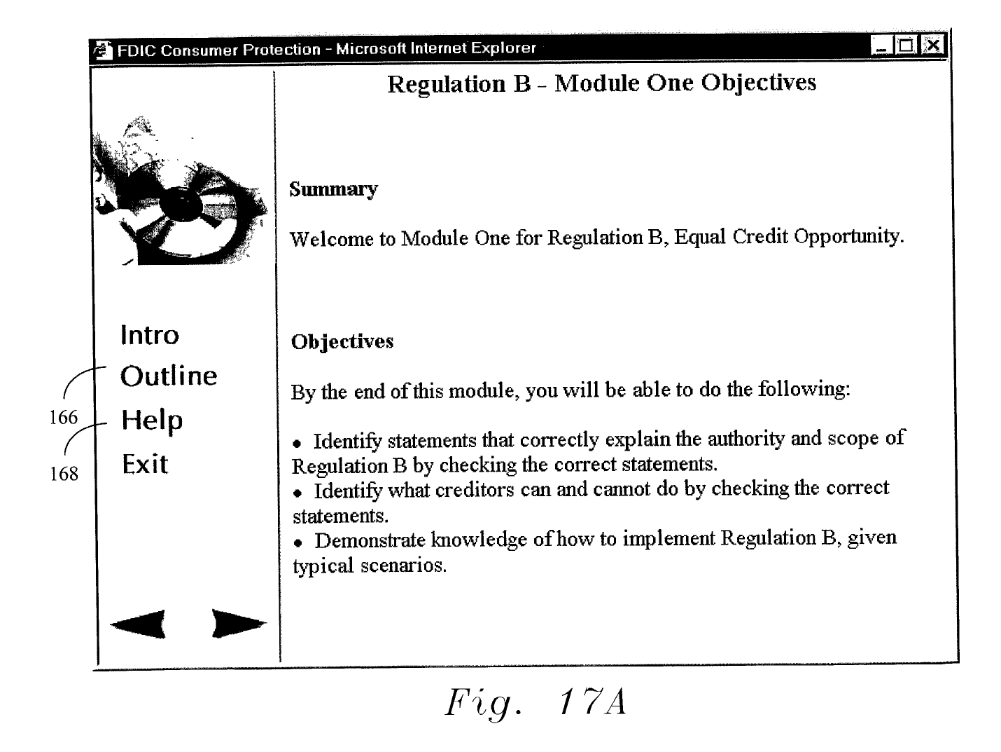

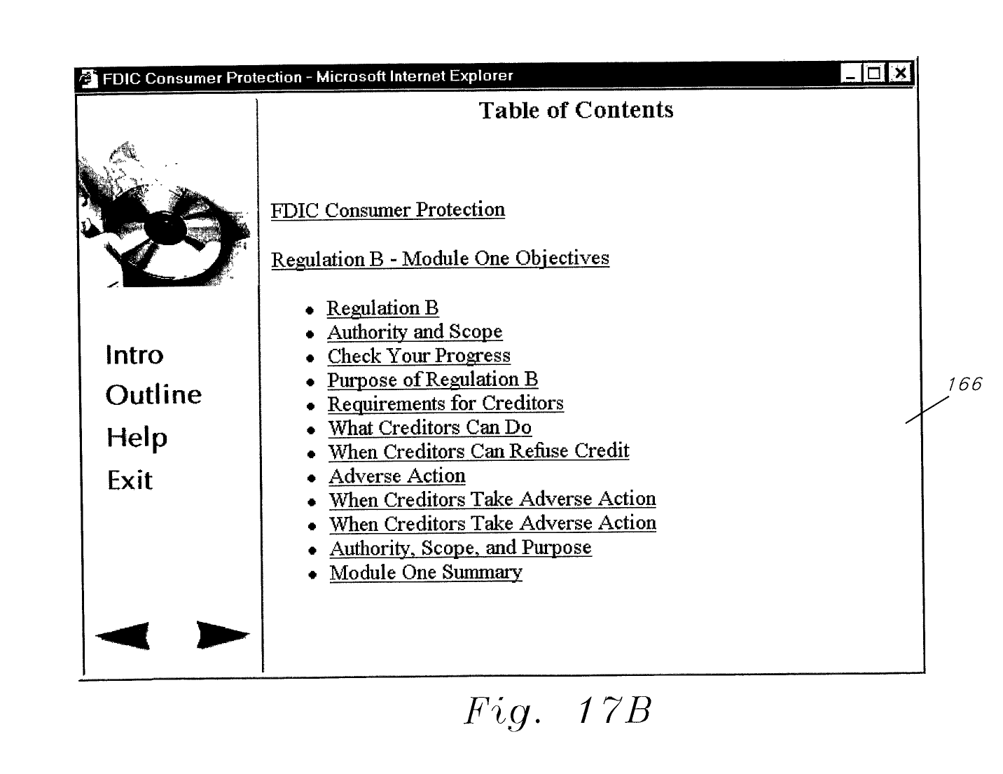

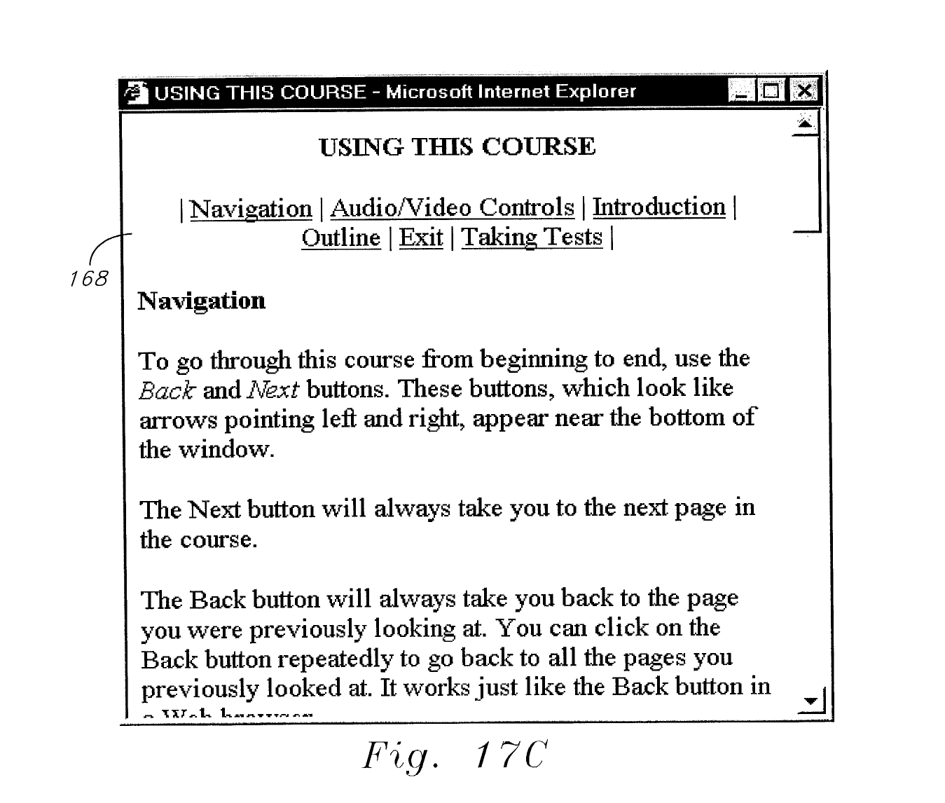

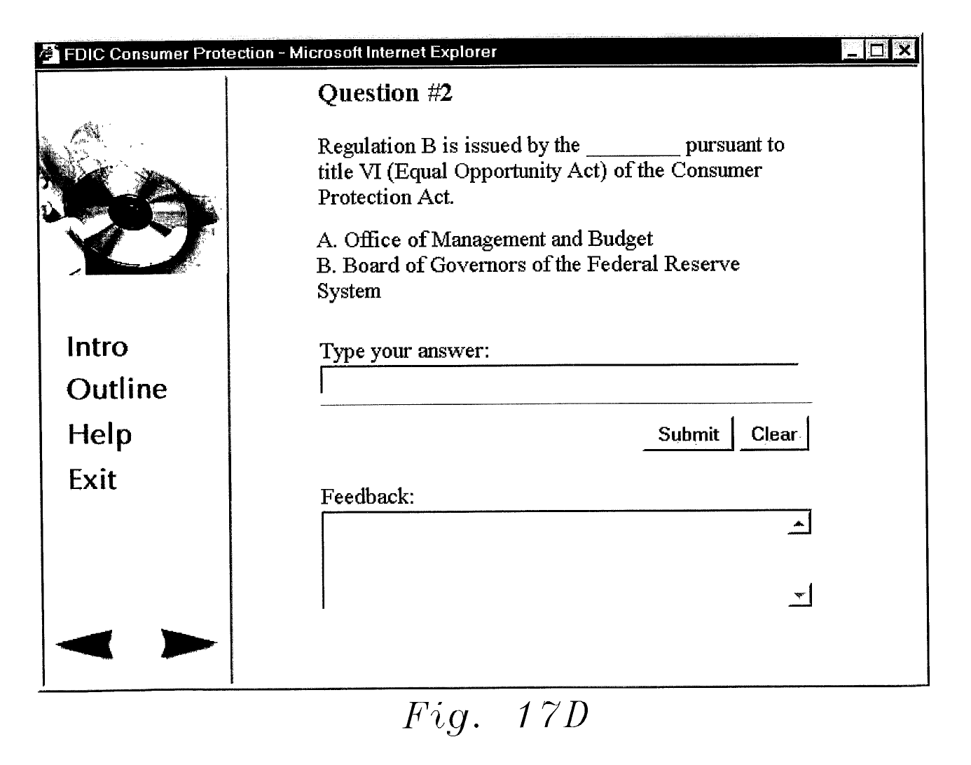

FIGS. 17A-17D illustrate exemplary course pages produced by Web Author. Web Author produces appropriate content material pages, such as the module introduction page shown in FIG. 17A. The content pages include appropriate navigation buttons for moving forward and backward, as well as keys to a course outline page 166 (shown in FIG. 17B) with links to the appropriate sections of the course, and to a course help section 168, e.g., the help screen shown in FIG. 17C. An exemplary test question page generated by Web Author is shown in FIG. 17D.

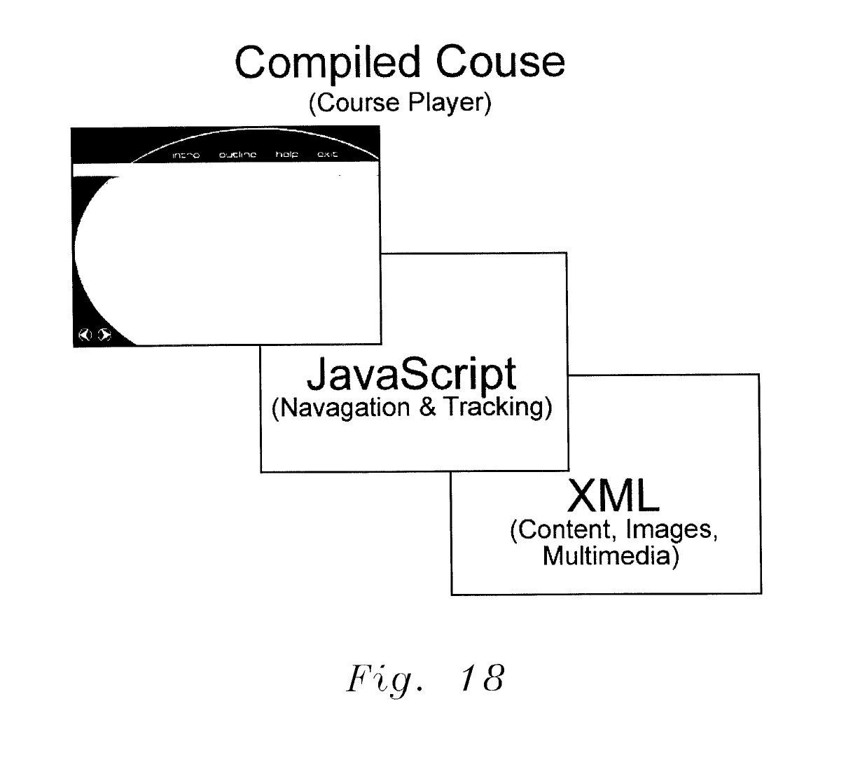

FIG. 18 shows a diagrammatic view of the Web Author Course Player. The Web Author Courseplayer is a shell that offers navigation and tracking to a complete Web-based training course. Web Author generates HTML pages from information added by the user. Then the application inserts the files into an HTML directory. Web Author then adds the Courseplayer to this directory.

The Courseplayer is made up of layers. The top layer is the skin or the graphic layer. This layer provides the course with the overall look and feel, along with navigation buttons. The middle layer is the control layer, providing navigation and tracking of the students progress. Buttons on the skin layer make calls to Javascript functions located on the control layer. This in turn calls the last layer, content. This is the HTML pages generated by Web Author. The control layer ensures that the correct HTML page is displayed.

The control layer also tracks students' test scores as they navigate through the course. These scores are then sent to the SCORM API Adapter (described below). The scores are sent to the API (Application Program Interface) by calling the LMSSetValue function located in the SCORM API (the SCORM API is a published Launch and Communications API that provides common interface functions between a course and a Learning Management System (LMS) and was developed by AICC members in collaboration with the Department of Defense's Advanced Distributed Learning (ADL) initiative, and represents a series of functions well known to those skilled in the art).

The control layer makes two more calls to the SCORM API adapter, LMSInitialize and LMSFinish. These two functions tell the API that the student has started and has finished the course. The API in turn contacts the LMS for storage in the LMS Database.

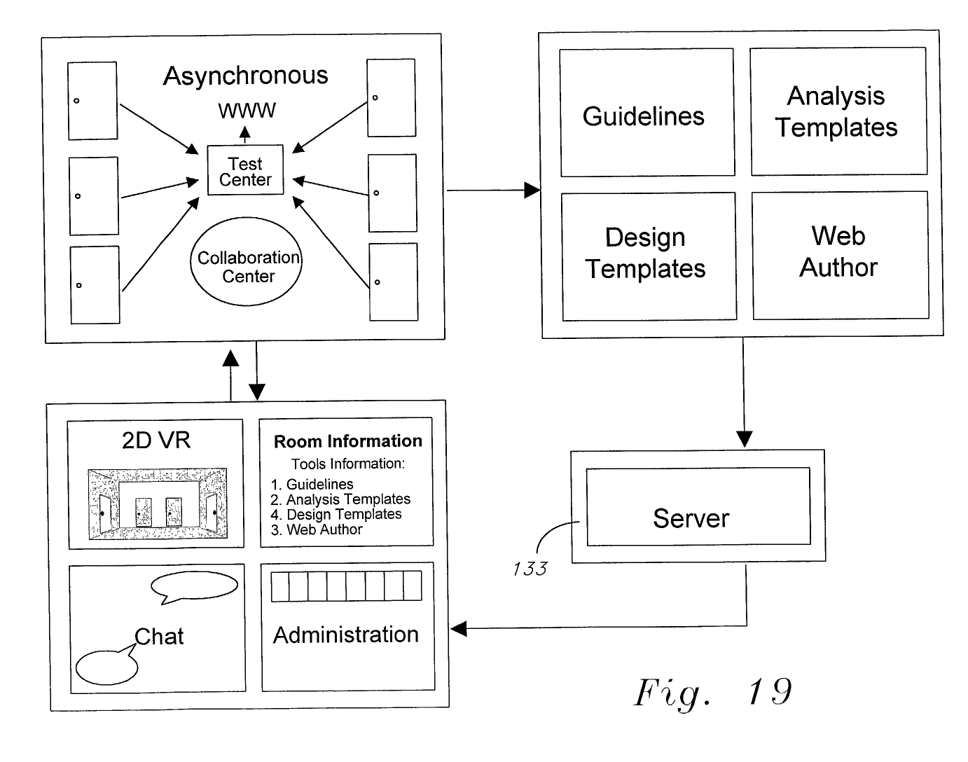

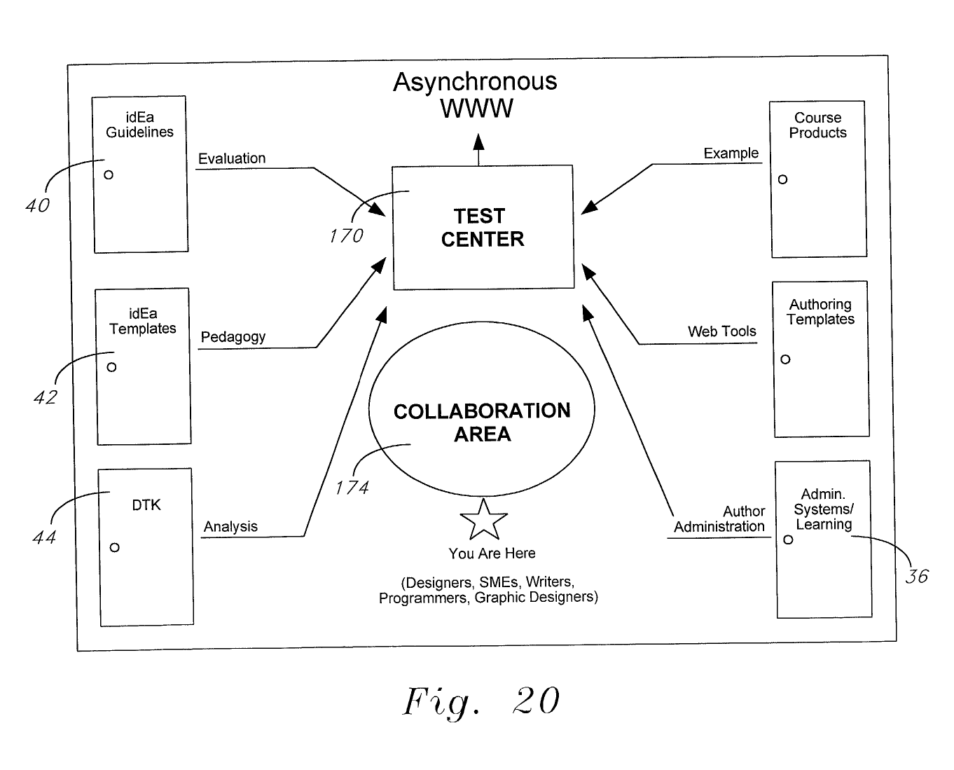

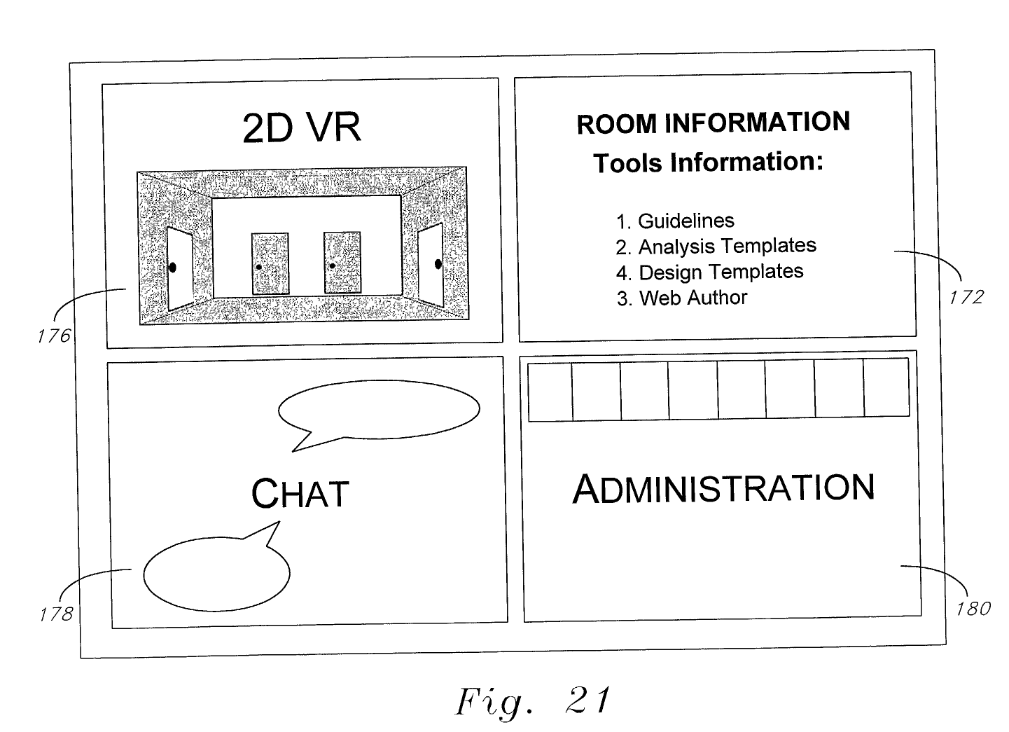

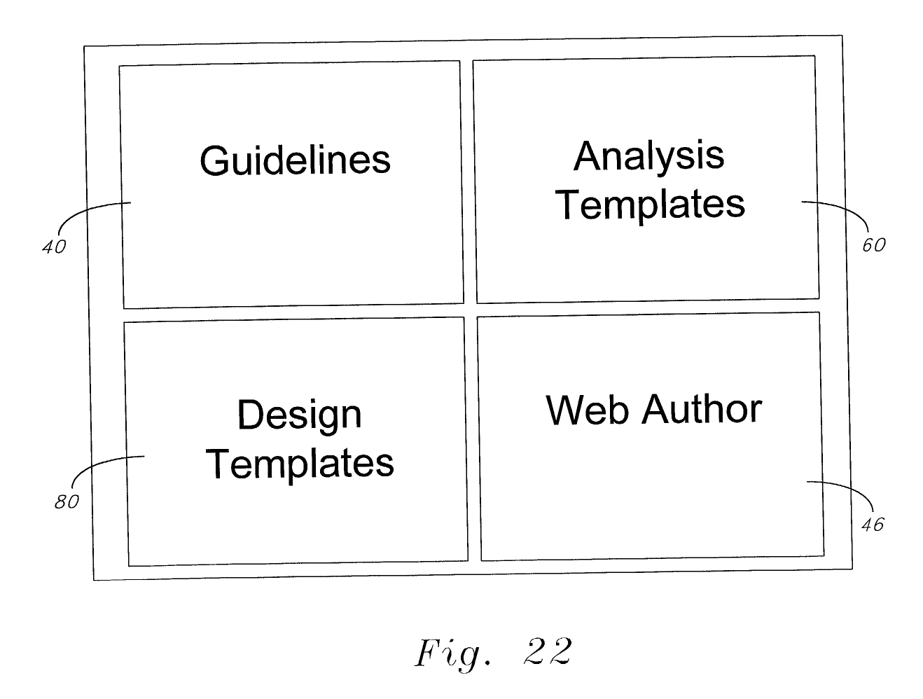

FIG. 19 illustrates the interworking of the collaboration and presentation areas where users of the automated job training and performance tool and its various systems, tools, applications, and components work and learn. The Figure shows the integration of all the components and how it appears to users. The block in the upper left quadrant of FIG. 19 is further illustrated and described in FIG. 20. The block in the lower left quadrant of FIG. 19 is further illustrated and described in FIG. 21. The block in the upper right quadrant of FIG. 19 is further illustrated and described in FIG. 22. The server 133 illustrated in the lower right quadrant contains all the components shown in FIG. 21. The server 133, and particularly the functions in the Administration Area 180 (described below in connection with FIG. 21) of the server 133, is responsible for organizing, implementing, deploying, and maintaining all the components of the automated job training and performance tool.

FIG. 20 schematically illustrates both the synchronous and asynchronous work areas provided by the automated job training and performance tool with the tools, applications and components that users work with in both collaboration areas. This is where the preparation for the learning or work occurs. This may be done individually or in a team mode. Designers/developers, subject matter experts, writers, programmers, graphic designers, and others work in this area using designer/developer tools 32 and some learner/worker tools in preparation for, and as a follow on to, synchronous meetings and test/lab sessions. This area can have any number of sub-areas or rooms, each area offering a specific tool or related set of tools, a process, a resource, etc. It will allow events to occur and the output of those events to feed into a test center 170. It will output to new objects created and placed in the Room Information and Objects Area 172 (discussed below in connection with FIG. 21). The output or results of the synchronous work area (collaboration center 174) will flow back into here. Once the work is completed, it goes to the test center 170 that is delivered over the Web. Asynchronous collaboration tools can be by question and/or message boards, e-mail, listservs, files, etc. Users can work on areas of a task independently and save their work to a Web server 28. Other users can access files, add their part, and continue the process. Files can be accessed in synchronous sessions also.

FIG. 21 shows the key items in the successful implementation of the synchronous collaboration areas of the automated job training and performance tool from the users' point of view. The Figure illustrates the interface and interaction modes available. It features discussion rooms and areas for viewing user input such as forms and templates. It involves speech (or audio), mouse pointing, clicking and dragging, touch sensitive screens, joystick, data gloves, keyboards, etc. The user interface includes all the appropriate hardware (e.g. graphical elements and the structural or architectural elements as well as the organization of the program) Navigation is also determined by the hardware and software elements of the architecture. In addition the tools within the architecture may have idiosyncratic requirements or interactive capabilities. This is important with regard to the tools because, particularly in learning modes, the learning tools can use one or more methods and the method used affects how users perceive the information. The system's navigation strategy also influences knowledge acquisition.

FIG. 21 represents the area where all members of the learning and/or working teams come together at the same time. This area has four main components.

The first component is the 2D Virtual Environment 176, complete with avatars (an image you select or create to represent yourself in a 3-D chat site on the Web) (not shown). This can be presented as “heads” around a table; and the names of visitors to the room may appear with the heads as visitors log in. When a visitor speaks, the name and the head become highlighted. When a visitor exits the room, the head and name vanishes. Indirect visual feedback is in the form of the “highlighted head,” as well as typed conversation, or pointing to an object or a direction to view something in the work area.

FIG. 21 also shows a Chat Room 178. This is presented as a discussion room. It can be used in several ways, e.g., (1) visitors type their conversations; (2) Internet telephony can be employed so visitors can converse; (3) a combination of 1 and 2; or (4) desktop video. This can also be use in combination with the 2D Virtual Environment.

FIG. 21 has a Room Information and Objects Area 172. This room may be used in combination with either or both the 2D Virtual Environment 176 and Chat Room 178 separately or together.

FIG. 21 has an Administration Area 180 controlled by the system administrator, the registrar, and/or the Learning Management System (LMS) of Computer Managed Instruction (CMI) functions of an organization.

FIG. 22 illustrates the Room Information Area 172. This is where Guidelines, Analysis and Design Templates, and Web Author (Web-based Designer Toolkit) and its objects, such as learning objects, images, new templates, and tools, can be created and introduced in both the asynchronous work area and the synchronous work area. This area may be used in combination with either or both the 2D Virtual Environment 176 and Chat Room 178 separately or together. This area may contain items that collaborators (learners or workers) may want to access, such as Guidelines, Analysis and Design Templates, Web-based Designer Toolkit, etc. Specific items that may be available here include e.g., instant messaging; shared whiteboard; and shared viewing.

As noted previously, a course may be developed by an organization with the Analysis and Design Templates as well as the Web Author tool collaboratively, either through the Internet, or through a company Intranet, or an Extranet. In order to facilitate this process, the Web Author tool may be deployed using Java's new Web Start technology. The Java Web Start technology is an innovative technology for deploying applications based on the Java 2 platform, which enables the user to launch full-featured applications via any browser, on any platform, from anywhere on the Web, in a secure fashion. It provides the best of both worlds: the ease of deployment and use of HTML, as well as the power and flexibility of a full-fledged application.

With Java Web Start technology, which works with virtually all Web servers, the application service providers (ASP), either internally to the company or externally on the Web, can easily supply a full-featured application to users. Initially, using the application version is slower, since it needs to be downloaded. This will typically take time in the order of minutes, which is high compared to the order of seconds for HTML. However, this is only a “first-time activation” cost. For subsequent uses, the application is cached locally and launches as quickly as any other local application. Consequently, users need only to save updated data files to the server.

It is to be understood that the present invention is not limited to the sole embodiments described above, but encompasses any and all embodiments within the scope of the following claims.

We claim:

1. A computer software product that includes a medium readable by a processor, the medium having stored thereon a set of instructions for creating and implementing an architecture for designing a job training program for an organization, comprising:
a) a first sequence of instructions which, when executed by the processor, causes said processor to provide a set of analysis templates prompting a user for information for assessing the organization's needs, capacities, and resources, and for saving the user's responses to said templates in serialized objects;
b) a second sequence of instructions which, when executed by the processor, causes said processor to provide a set of design templates based upon a rule-based system analysis of the user's responses to said analysis templates which prompt the user for information tailored to a web-based instructional course for the organization, and causes said processor to receive the user's responses to said templates, and to store the user's responses in serialized objects; and
c) a third sequence of instructions which, when executed by the processor, causes said processor to parse the serialized objects, provide the user with an outline tree of a web-based instructional course and with nodes having content supplied by the serialized objects, accept user editing of the outline tree and natural language editing of the nodes, and generate a web application implementing a job training course from the edited outline tree and nodes.

2. The computer software product according to claim 1, further comprising a fourth sequence of instructions which, when executed by the processor, causes said processor to provide a set of guidelines for carrying out an analysis phase, a design phase, a development phase, an implementation/delivery phase, and an evaluation/maintenance phase for assessing the organization's job training and performance needs, the guidelines being accessible by said first, second and third sets of instructions.

3. The computer software product according to claim 1, wherein said first, second, and third sets of instructions are capable of being deployed on a computer network and of being edited by multiple users in both synchronous and asynchronous modes in order to produce a web application for job training and performance by collaborative effort.

4. The computer software product according to claim 1, wherein said second set of instructions further includes instructions for:
(a) developing and sequencing objectives;
(b) specifying instructional strategies and methods;
(c) evaluating instructional objectives; and
(d) examine organizational issues.

5. The computer software product according to claim 1, wherein said third set of instructions further includes a set of instructions for permitting a user to supplement textual material with graphics files, audio files, video files and multimedia files.

6. The computer software product according to claim 1, wherein said third set of instructions further includes a set of instructions for permitting a user to supplement course material with tests, including user supplied questions and designations of correct answers, points assignments to the questions, standards for acceptable course progress, and feedback for learners.

7. The computer software product according to claim 1, wherein said third set of instructions further includes at least one application program interface function for integrating a course produced by said third set of instructions with a learning management system.

8. The computer software product according to claim 1, wherein said first set of instructions further includes instructions for:
(a) needs assessment;
(b) needs analysis;
(c) education analysis;
(d) learning analysis;
(e) job analysis;
(f) task analysis;
(g) learner analysis;
(h) resource analysis; and
(i) existing materials analysis.

9. The computer software product according to claim 1, wherein said third set of instructions further includes a set of instructions capable of producing a web application job training course permitting multiple learners to access the course synchronously and asynchronously for collaborative job training.

10. An automated job training and performance tool for designing a job training program for an organization, comprising:
a) a computer having a microprocessor, an area of main memory for executing program code under the direction of the microprocessor, and a disk storage device for storing data and program code;
b) data input means for entering data input cognizable by said microprocessor;
c) a software program code stored in said disk storage device and executing in main memory under the direction of said microprocessor, the software program including:
i) analysis template means for providing a set of analysis templates prompting a user for information for assessing the organization's needs, capacities, and resources, and for saving the user's responses to said templates in serialized objects;
ii) design template means for providing a set of design templates based upon a rule-based system analysis of the user's responses to said analysis templates which prompt the user for information tailored to a web-based instructional course for the organization, and causes said processor to receive the user's responses to said templates, and to store the user's responses in serialized objects; and
iii) web author means for parsing the serialized objects, providing the user with an outline tree of a web-based instructional course and with nodes having content supplied by the serialized objects, accepting user editing of the outline tree and natural language editing of the nodes, and generating a web application implementing a job training course from the edited outline tree and nodes.

11. The automated job training and performance tool according to claim 10, wherein said software program code further comprises means for providing a set of guidelines for carrying out an analysis phase, a design phase, a development phase, an implementation/delivery phase, and an evaluation/maintenance phase for assessing the organization's job training and performance needs, the guidelines being accessible by said analysis template means, said design template means and said web author means.

12. The automated job training and performance tool according to claim 10, wherein said analysis template means, said design template means, and said web author means are capable of being deployed on a computer network and of being edited by multiple users in both synchronous and asynchronous modes in order to produce a web application for job training and performance by collaborative effort.

13. The automated job training and performance tool according to claim 10, wherein said design template means further includes means for:
(a) developing and sequencing objectives;
(b) specifying instructional strategies and methods;
(c) evaluating instructional objectives; and
(d) examine organizational issues.

14. The automated job training and performance tool according to claim 10, wherein said web author means further includes means for permitting a user to supplement textual material with graphics files, audio files, video files and multimedia files.

15. The automated job training and performance tool according to claim 10, wherein said web author means further includes means for permitting a user to supplement course material with tests, including user supplied questions and designations of correct answers, points assignments to the questions, standards for acceptable course progress, and feedback for learners.

16. The automated job training and performance tool according to claim 10, wherein said web author means further includes at least one application program interface function for integrating a course produced by said web author means with a learning management system.

17. The automated job training and performance tool according to claim 10, wherein said analysis template means further includes means for:
(a) assessing needs;
(b) analyzing needs;
(c) analyzing education;
(d) analyzing learning;
(e) analyzing jobs;
(f) analyzing tasks;
(g) analyzing learners;
(h) analyzing resources; and
(i) analyzing existing materials.

18. The automated job training and performance tool according to claim 10, wherein said web author means further includes means capable of producing a web application job training course permitting multiple learners to access the course synchronously and asynchronously for collaborative job training.

19. A computer software product that includes a medium readable by a processor, the medium having stored thereon a set of instructions for creating and implementing an architecture for designing a job training program for an organization, comprising:
a) a first sequence of instructions which, when executed by the processor, causes said processor to provide a set of analysis templates based upon rules-based systems prompting a user for information for assessing the organization's needs, capacities, and resources, and causes said processor to receive the user's responses to said templates in serialized objects, and compiles, weights, calculates, filters/sorts the user's responses;
b) a second sequence of instructions which, when executed by the processor, causes said processor to provide a set of design templates based upon a rule-based systems for the user's responses to said analysis templates and to said design templates which prompt the user for information tailored to delivery systems and instructional strategies for courses for the organization, and causes said processor to receive the user's responses to said templates in serialized objects and compiles, weights, calculates, filters/sorts the user's responses in order to produce a design plan for courses; and
c) a third sequence of instructions which, when executed by the processor, causes said processor to parse the serialized objects, provide the user with an outline tree of a web-based instructional course and with nodes having content supplied by the serialized objects, accept user editing of the outline tree and natural language editing of the nodes, and generate a web application implementing a job training course from the edited outline tree and nodes.
